(19) United States
(12) Patent Application Publication
(10) Pub. No.: US 2026/0256242 A1
(43) Pub. Date: Sep. 3, 2026

(54) Textile Components and/or Other Articles Including Printed Structures, Methods of Making These Articles, and Products Including Such Articles

(71) Applicant: NIKE, Inc., Beaverton, OR (US)

(72) Inventors: Bryant G. Chu, Portland, OR (US); Kassio Figur, Portland, OR (US); Anand P. Kanchagar, Portland, OR (US); Colin M. Runkle, Portland, OR (US)

(21) Appl. No.: 19/555,275

(22) Filed: Mar. 3, 2026

Related U.S. Application Data
(60) Provisional application No. 63/766,300, filed on Mar. 3, 2025.
(60) Provisional application No. 63/808,363, filed on May 19, 2025.
(60) Provisional application No. 63/868,896, filed on Aug. 22, 2025.

(51) Int. Cl. A43B 23/02; C09D 11/037; C09D 11/102; C09D 11/322; C09D 11/38; C09D 11/54; D06P 1/52; D06P 1/54; D06P 1/673; D06P 5/00; D06P 5/30

(52) U.S. Cl. CPC A43B 23/0235; C09D 11/037; C09D 11/102; C09D 11/322; C09D 11/38; C09D 11/54; D06P 1/525; D06P 1/5285; D06P 1/5292; D06P 1/54; D06P 1/67383; D06P 5/002; D06P 5/30

(57) ABSTRACT

A printing method includes: (A) placing a substrate including at least a base textile layer on a screen printing bed; and (B) screen printing a topcoat layer over a surface of the substrate by moving a mixture including at least a polyurethane material, water, a cross-linker material, and a rheological modifier through a screen to form the topcoat layer over at least a portion of the substrate surface. The substrate further may include at least one of (i) a graphics layer over at least a portion of the base textile layer and/or (ii) a skin layer (e.g., a weatherizing layer) over at least a portion of the base textile layer and/or between at least a portion of the graphics layer (if present) and the base textile layer. The method further may include forming one or more printed elements on the topcoat layer, e.g., using a jetting device and process.

### RELATED APPLICATION DATA

This application is a U.S. Non-Provisional application and claims priority benefits based on: (a) U.S. Provisional Patent Application No. 63/766,300 filed Mar. 3, 2025 and entitled “Textile Components and/or Other Articles Including Printed Structures, Methods of Making These Articles, and Footwear Products Including such Articles,” (b) U.S. Provisional Patent Application No. 63/808,363 filed May 19, 2025 and entitled “Textile Components and/or Other Articles Including Printed Structures, Methods of Making These Articles, and Footwear Products Including such Articles,” and (c) U.S. Provisional Patent Application No. 63/868,896 filed Aug. 22, 2025 and entitled “Textile Components and/or Other Articles Including Printed Structures, Methods of Making These Articles, and Footwear Products Including such Articles.” Each of U.S. Provisional Patent Application No. 63/766,300, U.S. Provisional Patent Application No. 63/808,363, and U.S. Provisional Patent Application No. 63/868,896 is entirely incorporated herein by reference.

### FIELD OF THE INVENTION

This technology relates to articles (e.g., textile components) that have printed structures provided on a surface thereof. Additional aspects of this technology relate to methods of making such articles and to products, such as articles of apparel, footwear uppers, and/or articles of footwear, that include such articles.

At least some aspects of this technology may be used together with and/or include features of the technology described in one or more (i) U.S. Pat. No. 11,957,216 B2 entitled “Sole Structure for Article of Footwear” granted Apr. 16, 2024; (ii) U.S. Pat. No. 12,178,293 B2 entitled “Cleat Structure for Article of Footwear” granted Dec. 31, 2024; (iii) U.S. patent application Ser. No. 18/166,422 entitled “Cleat Structure for Article of Footwear” filed Feb. 8, 2023; (iv) U.S. patent application Ser. No. 18/650,750 entitled “Sole Structure for Article of Footwear” filed Apr. 30, 2024; (v) U.S. patent application Ser. No. 18/743,472 entitled “Sole Structure for Article of Footwear” filed Jun. 14, 2024; (vi) U.S. Provisional Patent Appln. No. 63/077,208 filed Sep. 11, 2020; (vii) U.S. Provisional Patent Appln. No. 63/251,447 filed Oct. 1, 2021; (viii) U.S. Provisional Patent Appln. No. 63/308,139 filed Feb. 9, 2022; (ix) U.S. Provisional Patent Appln. No. 63/499,896 filed May 3, 2023; (x) U.S. Provisional Patent Appln. No. 63/508,464 filed Jun. 15, 2023; and/or (xi) U.S. Provisional Patent Appln. No. 63/808,367 filed May 19, 2025 and entitled “Sole Structure for Article of Footwear.” Each of (i) U.S. Pat. No. 11,957,216 B2, (ii) U.S. Pat. No. 12,178,293 B2, (iii) U.S. patent application Ser. No. 18/166,422, (iv) U.S. patent application Ser. No. 18/650,750, (v) U.S. patent application Ser. No. 18/743,472, (vi) U.S. Provisional Patent Appln. No. 63/077,208, (vii) U.S. Provisional Patent Appln. No. 63/251,447, (viii) U.S. Provisional Patent Appln. No. 63/308,139, (ix) U.S. Provisional Patent Appln. No. 63/499,896, (x) U.S. Provisional Patent Appln. No. 63/508,464, and (xi) U.S. Provisional Patent Appln. No. 63/808,367 is entirely incorporated herein by reference.

### BACKGROUND

Conventional articles of athletic footwear include two primary elements, an upper and a sole structure. The upper may provide a covering for the foot that securely receives and positions the foot with respect to the sole structure. In addition, the upper may have a configuration that protects the foot and provides ventilation, thereby cooling the foot and removing perspiration. The sole structure may be secured to a lower surface of the upper and generally is positioned between the foot and any contact surface. In addition to attenuating ground reaction forces and absorbing energy, the sole structure may provide traction and control potentially harmful foot motion, such as over-pronation.

The upper forms a void on the interior of the footwear for receiving the foot. The void has the general shape of the foot, and access to the void is provided at an ankle opening. Accordingly, the upper extends over the instep and toe areas of the foot, along the medial and lateral sides of the foot, and around the heel area of the foot. A lacing system often is incorporated into the upper to allow users to selectively change the size of the ankle opening and to permit the user to modify certain dimensions of the upper, particularly girth, to accommodate feet with varying proportions. In addition, the upper may include a tongue that extends under the lacing system to enhance the comfort of the footwear (e.g., to moderate pressure applied to the foot by the laces). The upper also may include a heel counter to limit or control movement of the heel.

### SUMMARY

The following presents a simplified summary of various aspects of this technology. This summary is not an extensive overview, and it is not intended to identify key or critical elements or to delineate the scope of the claims. The following summary merely presents some concepts in a simplified form as an introductory prelude to the more detailed description provided below.

As noted above, this technology generally relates to articles (e.g., textile components) that have printed structures provided on a surface thereof. Additional aspects of this technology generally relate to methods of making such articles and to products (e.g., articles of apparel, footwear uppers, and/or articles of footwear) that include such articles.

Articles in accordance with at least some examples of this technology, such as substrates with raised elements (e.g., printed elements) thereon (e.g., textiles, articles of apparel, articles of footwear, footwear uppers, and/or footwear upper components), may have enhanced coefficient of friction and/or “grip” properties, e.g., as compared to the base substrate with no raised elements formed thereon.

Some examples of this technology relate to textiles, such as textiles for articles of apparel, footwear uppers, and/or footwear upper components, that have raised structures (e.g., printed structures) provided thereon. In at least some examples, the raised structures (e.g., printed structures) may be structured and arranged on a footwear upper surface such that the footwear upper includes: (a) a game ball receiving region (e.g., in the medial midfoot and/or medial heel region(s), and in some examples, extending to an underfoot region (e.g., in the medial midfoot and/or medial heel region(s)) and/or (b) a game ball propelling region (e.g., in one or more of the medial midfoot, medial forefoot, and/or medial heel region(s)). When both a game ball receiving region and a game ball propelling region are provided on a single upper, the game ball propelling region may be located higher on the footwear upper (e.g., closer to the instep region) and/or extend further forward (e.g., toward the forward toe region) than the game ball receiving region.

Additionally or alternatively, at least some examples of this technology relate to methods that include: (A) loading material into a jetting device, the material forming a print media mixture including at least: a polyurethane material, water, a cross-linker material, a rheological modifier, and an alcohol, wherein the print media mixture forms a non-Newtonian fluid; (B) applying shear force to the print media mixture and ejecting a series of discrete volumes (small volumes) of the print media mixture from a nozzle of the jetting device as a series of separated print media material dots, wherein the shear force causes a reduction in viscosity of the print media mixture to facilitate movement of the print media material dots through the nozzle; and (C) placing a surface of a substrate at a location to receive the series of separated print media material dots ejected from the nozzle, wherein the print media material dots adhere to mechanically fix with and/or to bond with at least one of the surface of the substrate and/or previously deposited print media material on the surface to form an overlay material located on the surface of the substrate.

Additionally or alternatively, aspects of this technology relate to methods of forming components (e.g., wearable components, such as articles of apparel, footwear uppers, etc.) that include: (A) screen printing a first print media material onto a substrate, the first print media material including at least: a polyurethane material, water, a cross-linker material, and a rheological modifier, wherein the first print media material has a viscosity within a range of 85,000 to 500,000 centipoise (“cp”); (B) thereafter, screen printing a second print media material onto at least a portion of an exposed surface of the first print media material, the second print media material including at least: a polyurethane material, water, a cross-linker material, and a rheological modifier, wherein the second print media material has a viscosity within a range of 40,000 to 80,000 centipoise; and (C) thereafter, screen printing a third print media material onto at least a portion of an exposed surface of the second print media material, the third print media material including at least: a polyurethane material, water, and a cross-linker material, wherein the third print media material has a viscosity within a range of 3500 to 10,000 centipoise. Still additionally or alternatively, aspects of this technology relate to products (e.g., wearable components, such as articles of apparel, footwear uppers, etc.) made by the processes described above.

Additionally or alternatively, aspects of this technology relate to methods of forming components (e.g., wearable components, such as articles of apparel, footwear uppers, etc.) that include: (A) screen printing a first print media material onto a substrate, the first print media material including at least: a polyurethane material, water, a cross-linker material, and a rheological modifier, wherein the first print media material has a viscosity within a range of 40,000 to 80,000 centipoise; and (B) thereafter, screen printing a second print media material onto at least a portion of an exposed surface of the first print media material, the second print media material including at least: a polyurethane material, water, and a cross-linker material, wherein the second print media material has a viscosity within a range of 3500 to 10,000 centipoise. Still additionally or alternatively, aspects of this technology relate to products (e.g., wearable components, such as articles of apparel, footwear uppers, etc.) made by the processes described above.

Additionally or alternatively, aspects of this technology relate to components (e.g., wearable components, such as articles of apparel, footwear uppers, etc.) and methods of making them that include one or more printed elements formed by jetting processes of the types described above (and described in more detail below) and one or more printed elements formed by screen printing processes of the types described above (and described in more detail below).

### BRIEF DESCRIPTION OF THE DRAWINGS

The present disclosure is illustrated by way of example and not limited by the accompanying figures, in which like reference numerals indicate similar elements, and in which:

FIGS. 1A and 1B illustrate features of jetting systems and methods in accordance with at least some aspects of this technology;

FIGS. 2A-2M provide various views depicting footwear, footwear upper components, and example printed structures provided thereon in accordance with examples of this technology;

FIGS. 3A-3C2 provide various views of example footwear uppers including printed web structures;

FIGS. 4A-4C provide various views of additional example footwear uppers including printed web structures;

FIGS. 5A-5C provide various views of additional example footwear uppers including printed web structures;

FIG. 6 provides a view of an example footwear upper including discrete printed structures;

FIGS. 7A-7B provide various views of additional example footwear uppers including discrete printed structures;

FIGS. 8A and 8B provide views showing additional or alternative features of footwear, footwear upper components, and printed structures in accordance with some examples of this technology;

FIGS. 9A and 9B provide views showing additional or alternative features of footwear, footwear upper components, and printed structures in accordance with some examples of this technology;

FIG. 10 depicts additional or alternative features of footwear, footwear upper components, and printed structures in accordance with some examples of this technology;

FIGS. 11A and 11B are cross-sectional views through printed elements and substrates in accordance with some additional examples of this technology;

FIGS. 12A-12F provide various views showing additional features of articles of footwear and footwear uppers in accordance with some examples of this technology;

FIGS. 13A and 13B illustrate example features of screen printed elements in accordance with some examples of this technology;

FIG. 14 illustrates example features of screen printed elements in accordance with some examples of this technology; and

FIG. 15 illustrates features of combination jetted printed elements and screen printed elements in accordance with some examples of this technology.

### DETAILED DESCRIPTION

In the following description of the various embodiments, reference is made to the accompanying drawings, which form a part hereof, and in which are shown by way of illustration various embodiments in which aspects of the disclosure may be practiced. It is to be understood that other embodiments may be utilized and structural and/or functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

“Footwear,” as that term is used herein, means any type of wearing apparel for the feet, and this term includes, but is not limited to: all types of shoes, boots, sneakers, sandals, thongs, flip-flops, mules, scuffs, slippers, sport-specific shoes (such as golf shoes, tennis shoes, baseball cleats, soccer or football cleats, ski boots, basketball shoes, cross training shoes, dance shoes, urban dance shoes, etc.), and the like.

Various aspects of this technology may be used for making footwear and footwear components, such as footwear upper structures. The term “rearward” as used herein in the context of footwear and footwear component structures means at or toward the heel region of the article of footwear (or component thereof), and the term “forward” as used herein in the context of footwear and footwear component structures means at or toward a forefoot or forward toe region of the article of footwear (or component thereof). Unless otherwise defined, the terms “heel” or “heel region” (or derivatives thereof) refer to the rearward one-third of the footwear or footwear component structure; the terms “midfoot” or “arch” (or derivatives thereof) refer to the middle one-third of the footwear or footwear component structure; and the term “forefoot” refers to the front or forward one-third of the footwear or footwear component structure. Also, the term “lateral” as used herein in the context of footwear and footwear component structures means the “little toe” side or outside of an article of footwear or component thereof (e.g., an upper, a sole structure, etc.), and the term “medial” as used herein in the context of footwear and footwear component structures means the “big toe” side or inside of an article of footwear or component thereof (e.g., an upper, a sole structure, etc.).

The term “non-woven” as used herein means a fabric or fabric-like material made from staple fibers (e.g., short fibers) and/or long fiber (e.g., continuous long fibers) bonded together by chemical, mechanical, heat, and/or solvent treatment (e.g., spunbond, meltblown, etc.). Non-woven materials are neither knitted nor woven. Some examples include felts.

As used herein, the terms “increased,” “greater,” “improved,” and/or “enhanced” coefficient of friction, “grip,” and/or “grippiness,” will mean that the one component (e.g., Component A) has at least 10% higher coefficient of friction than the component (e.g., Component B) to which it is being compared (e.g., a component without the feature(s) that provide the increase, improvement, or enhancement described above). In at least some examples of this technology, a component having “increased,” “greater,” “improved,” and/or “enhanced” coefficient of friction, “grip,” and/or “grippiness” (e.g., Component A) may have a coefficient of friction at least 25% higher, at least 50% higher, at least 75% higher, at least two times higher, at least three times higher, at least four times higher, at least five times higher, at least six times higher, from 1 to 12 times higher, from 2 to 7 times higher, and/or 6 to 12 times higher than the other component (Component B). A component having a “decreased,” “lower,” or “reduced” coefficient of friction refers to the other “component” in the comparison mentioned above.

In material compositions described herein, unless otherwise noted, all percentages are percentages by weight based on the total weight of the composition.

This application and/or its claims use the adjectives, e.g., “first,” “second,” “third,” and the like, to identify certain components and/or features relating to this technology. These adjectives are used merely for convenience, e.g., to assist in maintaining a distinction between components and/or features of a specific structure. Use of these adjectives should not be construed as requiring a specific order or arrangement of the components and/or features being discussed. Also, use of these specific adjectives in the specification for a specific structure does not require that the same adjective be used in the claims to refer to the same part (e.g., a component or feature referred to as the “third” in the specification may correspond to any numerical adjective used for that component or feature in the claims).

This application describes components (e.g., upper base members or other substrates and printed elements) that are “fixed” together. The term “fixed” (and derivatives thereof) is used generically herein to mean that the components are joined securely to one another. The term “fixed,” as used herein, encompasses: chemical bonding (e.g., via cross-linking agents or other chemical reactions); adhering bonds (e.g., due to print media material adhering to a surface a substrate member and/or threads of a textile or other substrate structure); embedded bonds (e.g., due to print media material at least partially wrapping one or more threads or fibers of a textile or other substrate structure); etc.

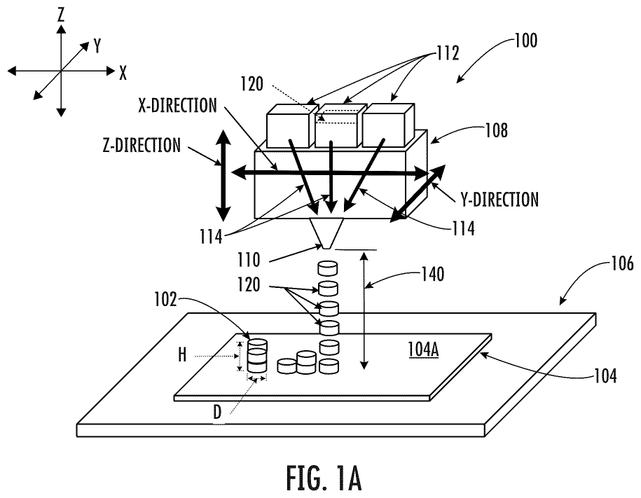

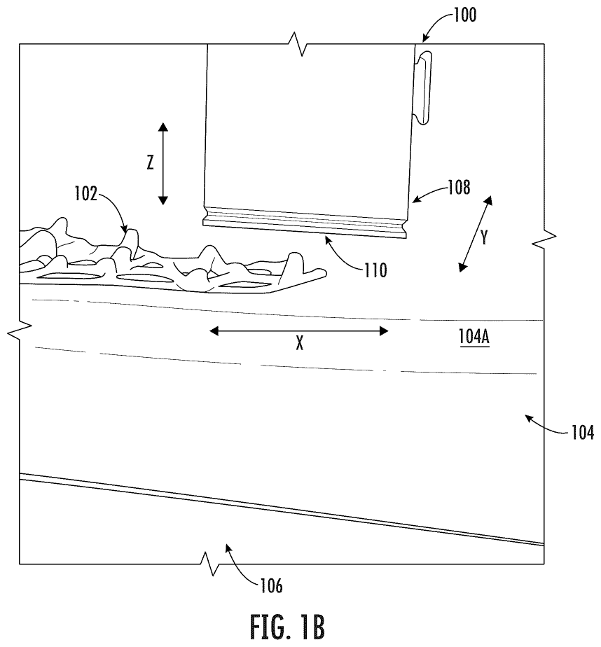

FIGS. 1A and 1B illustrate features of systems 100 and methods for forming printed structures 102 (also referred to as “elements” or “printed elements” herein) on a substrate 104, such as a textile component (e.g., for a footwear upper and/or other articles of apparel). The illustrated example system 100 of FIGS. 1A and 1B includes a print bed 106 on which the substrate 104 is placed with a major surface 104A thereof facing the print head 108 of the system 100. The print head 108 includes at least one nozzle 110 for dispensing print media material 120 onto the surface 104A of the substrate 104 to form the printed structures 102 thereon. A substrate 104 may comprise two or more component parts that are fixed together (e.g., by sewing, by adhesive, by other bonding techniques, etc.), and in such structures, the print media material 120 may be applied onto multiple component parts of the substrate 104 and/or the print media material 120 may span continuously from one component part to one or more other component parts.

The print head 108 is movable with respect to the print bed 106 in one or more of the X, Y, and/or Z directions shown in FIG. 1A. Movement of the print head 108 with respect to the print bed 106 in at least the X and Y directions over the time that print media material 120 is being dispensed enables formation of printed structures 102 on the substrate 104 in any desired shape, such as in one or more of: discrete printed elements that are separated from one another on the substrate 104 (e.g., cylinders, domes, etc.); printed element segments (e.g., elongated printed structures that are straight and/or curved); printed web structures (e.g., with two or more printed element segments extending outward from a printed element node); enclosed areas “filled in” with print media material 120; etc.

The example system 100 of FIGS. 1A and 1B is a jetting device (also called a “jetting system” herein) that dispenses print media material 120 as a series of small, separated, and discrete “droplets” or “dots” (the individual “droplet” size is exaggerated in FIG. 1A). Print media material 120 is loaded into a reservoir 112 of the system 100 (e.g., associated with the print head 108), and the system 100 includes appropriate equipment 114 (e.g., extruding equipment, flow lines, etc., shown schematically in FIG. 1A) to move the print media material 120 through the print head 108, e.g., from the reservoir 112 to the nozzle 110. While any number of reservoirs 112 may be included with (or connected with) the print head 108 (e.g., one or more), the example of FIG. 1A shows three reservoirs 112, e.g., with each potentially containing a different print media material 120 composition and/or color.

A piezoelectric actuator operates to eject print media material 120 from the nozzle 110 in a direction toward (and to) the surface 104A of the substrate 104 as a series of small, separated, and discrete “droplets” or “dots” (with one “droplet” or “dot” ejected from the nozzle with each activation of the piezoelectric actuator and/or each “droplet” or “dot” comprising a volume (also called a “small volume” herein) of less than 1 ml, and in some examples, less than 0.5 ml, less than 0.25 ml, or less than 0.1 ml). Jetting devices and jetting systems 100 of this type are generally known and commercially available, e.g., such as PICO Pμlse® systems available from Nordson Corporation of Westlake, Ohio or S-Jet systems available from Marco Systems of Dachau, Germany. Jetting processes in accordance with at least some examples of this technology do not require melting of the print media material 120.

The sizes of individual “droplets” ejected from the nozzle 110 may be controlled in various ways. For example, the sizes of the droplets may be altered by changing one or more of: the nozzle 110 opening speed, the nozzle 110 closing speed, and/or the opening duration of the nozzle 110 during droplet ejection; the viscosity of the print media material 120; air (or other gas) pressure forcing the print media material 120 out of the nozzle 110; and/or piezoelectric actuator vibrational frequency. Additionally or alternatively, altering the frequency may be used to control the number of droplets ejected from the nozzle per second, in at least some examples of this technology.

As shown in FIGS. 1A and 1B, methods of forming printed structures 102 on a substrate 104 (e.g., a textile component, an article of apparel, a component for an article of apparel, an article of footwear, a component for an article of footwear, a footwear upper component, etc.) may include: (a) loading material into a jetting system 100, the material forming a print media mixture; and (b) applying shear force to the print media mixture (e.g., by a piezoelectric actuator of jetting system 100 as described above) and ejecting a series of discrete volumes (e.g., small volumes) of the print media mixture from the nozzle 110 of the jetting system 100 as a series of separated print media material 120 dots or droplets. The shear force causes a reduction in viscosity of the print media mixture to facilitate movement of the print media material 120 dots through the nozzle 110.

The “material” loaded into the jetting system 100 (e.g., into reservoir(s) 112) may itself constitute the “print media mixture” and/or it may correspond to the composition of the “print media material” 120. Alternatively, the “material” loaded into the jetting device 100 may constitute one or more ingredients of or a precursor to the “print media mixture” and/or “print media material” 120 (which then may be mixed within the jetting system 100). The term “print media mixture” is used herein to refer to the combined ingredients of the print media material 120 in the jetting system 100 before it is ejected from the nozzle 110. The term “print media material” 120 is used herein to refer to the material as it is being moved through and ejected from the nozzle 110 (e.g., the droplets) and after it has been ejected from the nozzle 110 (including on the substrate 104).

As part of this example method, a surface 104A of the substrate 104 (e.g., an upper base member of an article of footwear, a textile component, etc.) is placed at a location (e.g., on a print bed 106 of the jetting system 100) to receive the series of separated print media material 120 dots ejected from the nozzle 110. The print media material 120 dots will impact the surface 104A and adhere to the surface 104A and/or to one another to mechanically fix with and/or bond with (e.g., chemically bond with) at least one of the surface 104A of the substrate 104 and/or with previously deposited print media material 120 on the surface 104A of the substrate to form an overlay material (e.g., a printed element 102) on the surface 104A of the substrate 104.

Methods in accordance with examples of this technology may include one or more additional steps, as well. For example, once deposited, the overlay material (e.g., the print media materials 120 deposited on the surface 104A) may be dried, e.g., to remove at least some of the water included with the print media material 120 when ejected. Any drying method may be used in different examples of this technology. In some examples, drying may take place by open air drying (e.g., for at least 5 minutes, and in some examples, for at least 10 minutes, for 5 minutes to a day, for 5 minutes to two hours, etc.), optionally in the presence of moving air (or other gas), e.g., using a conventional fan, optionally moving air or gas that is heated (e.g., from 40 to 60 degrees C.). As another example, the drying step may include passing the substrate 104 with the overlay material received thereon through a drying tunnel (e.g., conveying the substrate 104 through a heated drying tunnel at 40 degrees C. to 60 degrees C. (that optionally may include moving air or other gas including heated moving air or other gas) over a time period of 30 seconds to 5 minutes). The drying and/or heating step(s) may activate cross-linking of components within the print media material 120, as will be described in more detail below.

Additionally or alternatively, a curing and/or cross-linking step may be provided that is separate from and/or additional to any cross-linking provided during the drying step (if any). Curing and/or cross-linking may be provided in any suitable manner, e.g., by heating, by exposure to radiation or other energy (e.g., ultraviolet radiation, etc.), etc. In some examples, such curing and/or cross-linking may include exposure to heat (e.g., 70 to 90 degrees C. or 75 to 85 degrees C.) for 3 to 40 minutes (and in some examples, from 5 to 10 minutes).

The substrate 104 may comprise or be formed from a wide variety of different materials and/or compositions in accordance with specific aspects of this technology. As some more specific examples, the substrate 104 and/or its print media material receiving surface 104A may include one or more of: a woven textile; a knitted textile; a non-woven textile; a synthetic leather material; a woven textile, a knitted textile, a non-woven textile, or a synthetic leather material, having a “skin” formed on the surface 104A thereof, such as a polyurethane skin; a polyurethane material; a thermoplastic polyurethane material; a polyester material; and/or a polyethylene terephthalate material. In some examples of this technology, the “skin” may comprise one or more of a polyurethane layer and/or a thermoplastic polyurethane layer applied to a base fabric (e.g., a knit fabric layer), e.g., using an adhesive layer (e.g., a hot melt adhesive). In at least some examples, a “skin” may be thin, e.g., in some examples, less than 2 mm, less than 1 mm, less than 0.75 mm, or less than 0.5 mm.

In at least some examples of this technology, the substrate 104 may comprise a multi-layered component. For example, a textile substrate made from threads or fibers (e.g., a knit textile, a woven textile, a non-woven textile, etc.) may have a film or “skin” applied to it, and the print media material 120 may be applied to a surface 104A including this film or skin. The film or skin may comprise one or more of a polyurethane material, a thermoplastic polyurethane material, or other material. The film or skin may be applied to the textile substrate 104 in a variety of different manners, including one or more of: heat pressing; screen printing; spraying; other printing processes; hot melt processes; lamination processes; etc. In some examples, the film or skin may be applied to a textile (e.g., knit), and the film or skin may have a thickness of about 0.1 mm to 0.35 mm (and in some examples, about 0.15 mm to 0.25 mm). In some specific examples, the film or skin may comprise the polymer skin material (e.g., polyurethane) and hot melt adhesive.

Aspects of the print media mixtures and print media materials 120 and printing methods in accordance with some examples of this technology will be described in more detail. In accordance with at least some examples of this technology, the print media mixtures (e.g., loaded into the reservoir(s) 112) and/or the print media material 120 ejected from the nozzle 110 will comprise an aqueous polyurethane dispersion (e.g., such as a polyether polyurethane dispersion). As some more specific examples, the print media mixtures and/or the print media material 120 may include: (a) an aqueous compact resin of polyurethane in water having a high solids content (e.g., at least 40% solids); (b) a cross-linking material (e.g., a carbodiimide, an isocyanate, etc.); (c) an alcohol (e.g., an aminoalkyl alcohol); and (d) a rheological modifier (e.g., a thickening agent, etc.).

Additionally, in at least some examples, the print media mixtures and/or the print media material 120 further may include one or more pigments, e.g., to produce a desired color. Alternatively, in other examples, the print media mixtures and/or the print media material 120 need not include pigments. In such examples, the printed structures 102 may have the resultant color of their remaining ingredients and/or may have a generally translucent, clear, and/or colorless appearance.

In at least some examples of this technology, a print media mixture and/or print media material 120, e.g., including the ingredients above, may have a solids content of at least 40% solids, and in some examples, at least 45% solids, at least 50% solids, at least 55% solids, between 40% and 70% solids, between 45% and 68% solids, between 50% and 68% solids, between 55% and 68% solids, between 55% and 62%, or between 60% and 68% solids.

Additionally or alternatively, the print media mixture and/or print media material 120, e.g., including the ingredients above, may comprise a non-Newtonian fluid, e.g., that displays reduced viscosity when subjected to shear forces (e.g., shear-thinning properties). Additionally or alternatively, the print media mixture and/or print media material 120, e.g., including the ingredients above, may comprise a polyurethane dispersion (e.g., a polyether polyurethane dispersion). Additionally or alternatively, the solid particles (e.g., the polyurethane particles and/or polyether polyurethane particles) in the print media mixture and/or print media material 120, e.g., including the ingredients above, may have an average diameter of 20 to 40 microns (and in some examples, 25 microns to 35 microns and/or an average of about 30 microns).

In at least some examples of this technology, at least when not exposed to shear forces, the print media mixture and/or the print media material 120 (e.g., including the ingredients above and/or located within the jetting system 100) may have a viscosity within a range of 550 centipoise to 190,000 centipoise. As some additional examples, when not exposed to shear forces, the print media mixture and/or the print media material 120 (e.g., including the ingredients above and/or located within the jetting system 100) may have a viscosity of at least 80,000 centipoise, at least 85,000 centipoise, at least 90,000 centipoise, within a range of 80,000 to 190,000 centipoise, within a range of 85,000 to 160,000 centipoise, within a range of 90,000 to 150,000 centipoise, within a range of 95,000 to 140,000 centipoise, or within a range of 100,000 to 135,000 centipoise.

As noted above, the solid particles (e.g., the polyurethane particles and/or polyether polyurethane particles) in the print media mixture and/or print media material 120 in some examples of this technology may have an average diameter of 20 to 40 microns (and in some examples, 25 microns to 35 microns and/or an average of about 30 microns). The nozzle 110 opening size (e.g., diameter N) of jetting systems 100 in at least some examples of this technology may be about 300 microns. In some examples of this technology, the ratio (N/D) of nozzle 110 opening size N to aqueous resin average particle size diameter D may be in a range of 7.5 to 15, and in some examples from 8.5 to 12, or from 9 to 11. Nozzle 110 opening size may have some effect on the printed media material 120 droplet size ejected from the nozzle 110.

In at least some examples of this technology, the print media mixture and/or print media material 120, e.g., including the ingredients above, may be restricted substances list (“RSL”) compliant, contain low amounts of volatile organic compounds (“VOCs”), and/or contain no VOCs.

As noted above, the print media mixture and/or print media material 120 in accordance with at least some examples of this technology includes an aqueous compact resin of polyurethane in water having a high solids content. This aqueous resin may comprise a polyurethane dispersion (e.g., including a polyether polyurethane dispersion) and/or comprise an aliphatic polyurethane. The aqueous resin may be RSL compliant, contain low amounts of VOCs, and/or contain no VOCs. This aqueous resin may be referred to as an “aqueous resin ingredient” herein.

In at least some examples of this technology, the aqueous resin may have a solids content of at least 40% solids, and in some examples, at least 45% solids, at least 50% solids, between 40% and 65% solids, between 45% and 60% solids, between 50% and 60% solids, or between 52% and 58% solids.

In at least some examples of this technology, the aqueous resin ingredient may have a viscosity within a range of 3000 centipoise to 10,000 centipoise (prior to its fabrication into the print media mixture and/or print media material 120). In some examples, this viscosity may be within a range of 3500 centipoise to 9000 centipoise, within a range of 4000 centipoise to 8000 centipoise, or within a range of 4500 centipoise to 8000 centipoise. If necessary or desired, a thickening agent may be included in the final print media mixture and/or print media material 120 to form the print media mixture and/or print media material 120 to the final viscosity for a printing process (as will be discussed in more detail below).

Additionally or alternatively, in at least some examples of this technology, the aqueous resin ingredient may have a pH within a range of 8.5 to 10.5, and in some examples, within a range of 9 to 10.

Additionally or alternatively, in at least some examples of this technology, the aqueous resin ingredient may form from 65% by weight to 95% by weight of the overall print media mixture and/or print media material 120. As some additional ranges, the aqueous resin ingredient content may be within a range of 80% by weight to 95% by weight, within a range of 82% by weight to 92% by weight, or within a range of 84% by weight to 90% by weight (all percentages based on the total weight of the print media mixture and/or print media material 120).

As noted above, the print media mixture and/or print media material 120 in accordance with at least some examples of this technology may include a cross-linking material. Any suitable cross-linking material may be used in different specific examples of this technology. As some more specific examples, the cross-linking material may comprise a carbodiimide (e.g., a polycarbodiimide) or an isocyanate (e.g., a polyisocyanate, such as a blocked aliphatic isocyanate).

As some additional examples, the cross-linking material used may provide a long pot life for the print media mixture and/or print media material 120 (e.g., for better, long-term storage of the print media mixture and/or print media material 120). “Pot life” refers to the length of time it takes for the viscosity of the mixed material to increase to the point that it can no longer be applied by the application method to be used. Some more specific examples of cross-linking materials that may be used in accordance with at least some examples of this technology include polycarbodiimide cross-linking materials, e.g., VOC-free, water-based, polycarbodiimide crosslinkers, such as Permutex® XR-5508 available from Stahl.

As some additional examples, polyisocyanate cross-linking materials useful in at least some examples of this technology may comprise blocked aliphatic polyisocyanate cross-linkers, such as Permutex® XR-22-903 available from Stahl.

Additionally or alternatively, in at least some examples of this technology, the cross-linking material may be present within a range of from 1.5% by weight to 5.5% by weight of the overall print media mixture and/or print media material 120. As some additional ranges, the cross-linking material may be within a range of 1.75% by weight to 5% by weight, within a range of 2% by weight to 4.5% by weight, or within a range of 2.5% by weight to 4.2% by weight (with these percentages based on the total weight of the print media mixture and/or print media material 120). Still additionally or alternatively, in at least some examples of this technology, the cross-linking material may be present within a range of from 2% by weight to 6% by weight based on the weight of the aqueous resin present in the overall print media mixture and/or print media material 120 (and in some examples, within a range of 2.5% by weight to 5.5% by weight, or within a range of 3% by weight to 5% by weight (with these weight percentages based on the weight of the aqueous resin present in the overall print media mixture and/or print media material 120)).

As noted above, the print media mixture and/or print media material 120 in accordance with at least some examples of this technology may include an alcohol. While not wishing to be bound by any specific theory of operation, in at least some examples, the alcohol (when present) may help control and/or tune the water evaporation rate from the print media mixture and/or print media material 120, may help control and/or tune pH, may help with dispersency, etc.

As some specific examples, the alcohol may comprise an aminoalkyl alcohol, such as an aminomethyl propanol (e.g., 2-amino-2-methyl-1-propanol). Such alcohol ingredients are commercially available from various suppliers.

Additionally or alternatively, in at least some examples of this technology, the alcohol (e.g., aminoalkyl alcohol) may be present within a range of from 0.075% by weight to 4.5% by weight of the overall print media mixture and/or print media material 120. As some additional ranges, the alcohol content may be within a range of 0.10% by weight to 4% by weight, within a range of 0.15% by weight to 2% by weight, within a range of 0.2% by weight to 1% by weight, or within a range of 0.25% by weight to 0.65% by weight (with these percentages based on the total weight of the print media mixture and/or print media material 120). Still additionally or alternatively, in at least some examples of this technology, the alcohol may be present within a range of from 0.1% by weight to 5% by weight based on the weight of the aqueous resin present in the overall print media mixture and/or print media material 120 (and in some examples, within a range of 0.15% by weight to 4% by weight, within a range of 0.2% by weight to 2.5% by weight, within a range of 0.25% by weight to 1.5% by weight, or within a range of 0.3% by weight to 0.75% by weight (with these weight percentages based on the weight of the aqueous resin present in the overall print media mixture and/or print media material 120)).

As noted above, the print media mixture and/or print media material 120 in accordance with at least some examples of this technology may include a rheology modifier. The rheological modifier (e.g., a thickening agent), when present, allows one to formulate the final print media mixture and/or print media material 120 to a final viscosity for use in systems and methods in accordance with aspects of this technology. Increasing an amount of thickening agent in the print media mixture and/or in the print media material 120 may increase viscosity and decreasing an amount of thickening agent print media mixture and/or in the print media material 120 may decrease viscosity.

Any type of rheological modifier (e.g., thickening agent) may be used in various different examples of this technology (e.g., provided desired flow and/or jetting functionality is maintained). As some more specific examples, the thickening agent may comprise an acrylic thickener material, e.g., an acid containing acrylic copolymer emulsion (e.g., having a dry solids content of 24-26% and a pH of 4-5). Some specific thickening agents/rheology modifiers that may be used in accordance with at least some examples of this technology comprises the acrylic thickener Permutex® RM-4409 and/or the water-based polyurethane type thickener Permutex® EVO EX-RM-2956, each available from Stahl.

Additionally or alternatively, in at least some examples of this technology, the thickening material/rheology modifier (e.g., an acrylic thickening agent) may be present within a range of from 0.25% by weight to 5% by weight of the overall print media mixture and/or print media material 120. As some additional ranges, the thickening material/rheology modifier content may be within a range of 0.5% by weight to 5% by weight, within a range of 1% by weight to 5% by weight, within a range of 2% by weight to 4.5% by weight, or within a range of 2.5% by weight to 4% by weight (with these percentages based on the total weight of the print media mixture and/or print media material 120). Still additionally or alternatively, in at least some examples of this technology, the thickening material/rheology modifier may be present within a range of from 0.5% by weight to 6% by weight based on the weight of the aqueous resin present in the overall print media mixture and/or print media material 120 (and in some examples, within a range of 0.5% by weight to 5% by weight, within a range of 1% by weight to 4.75% by weight, within a range of 1.5% by weight to 4.5% by weight, or within a range of 2% by weight to 4.25% by weight (with these weight percentages based on the weight of the aqueous resin present in the overall print media mixture and/or print media material 120)).

As noted above, the print media mixture and/or print media material 120 in accordance with at least some examples of this technology may include one or more pigments, e.g., to produce a desired color. The pigment(s) may have any suitable size range, such as a particle size of 2 microns, to 15 microns, and in some examples, 3 microns to 10 microns, or 4 microns to 8 microns. Suitable pigments are conventionally known and commercially available.

Additionally or alternatively, in at least some examples of this technology, the pigment(s) may be present within a range of from 1% by weight to 10% by weight of the overall print media mixture and/or print media material 120. As some additional ranges, the pigment(s) content may be within a range of 1.5% by weight to 9% by weight, within a range of 2% by weight to 8% by weight, or within a range of 2.5% by weight to 7.5% by weight (with these percentages based on the total weight of the print media mixture and/or print media material 120). Still additionally or alternatively, in at least some examples of this technology, the pigment(s) may be present within a range of from 1.25% by weight to 12% by weight based on the weight of the aqueous resin present in the overall print media mixture and/or print media material 120 (and in some examples, within a range of 1.75% by weight to 10% by weight, within a range of 2.5% by weight to 8% by weight, or within a range of 3% by weight to 7% by weight (with these weight percentages based on the weight of the aqueous resin present in the overall print media mixture and/or print media material 120)). The specific pigment used and/or the amounts thereof also may affect the viscosity of the final mixture/dispersion (and/or may be used to alter and/or control the viscosity).

As some additional examples, print media mixture and/or print media material 120 in accordance with at least some examples of this technology may have the following ingredients and/or properties:

| | Range A - (all | Range B - (all |
|---|---|---|
| | Percentages are % By | Percentages are % By |
| | Weight based on Total | Weight Based on Total |
| Component/Property | Weight of Mixture) | Weight of Mixture) |
| Aqueous Resin (e.g., an | 65%-95% | 80%-90% |
| aqueous polyether | | |
| polyurethane dispersion) | | |
| Cross-Linking Material | 2%-5% | 3%-4.5% |
| (e.g., a VOC-free, water- | | |
| based, polycarbodiimide | | |
| crosslinker) | | |
| Alcohol (e.g., 2-amino- | 0.2%-0.6% | 0.3%-0.55% |
| 2-methyl-1-propanol) | | |
| Rheological | 1.5%-5% | 2.5%-4% |
| Modifier/Thickening | | |
| Agent (e.g., an acrylic | | |
| thickener/rheological | | |
| modifying material) | | |
| Pigment | 0%-7% | 3.5%-6% |
| Other Ingredients* | 0%-8% | 0%-5% |
| Water | Balance to 100% | Balance to 100% |
| Viscosity | 80,000 centipoise- | 100,000 centipoise- |
| | 190,000 centipoise | 160,000 centipoise |

*“Other Ingredients” may include, for example, functional fillers (e.g., matting agent(s), coefficient of friction modifying agents, debubbling agents, etc., as discussed herein); inert fillers; etc.

Additional aspects of this technology relate to print media mixtures and/or print media materials 120 having compositions, ingredients, and combinations of ingredients of the types described above, including, but not limited to, print media materials 120 having compositions falling within the scope of the table above.

As described above, the print media mixture and/or print media material 120 may comprise a non-Newtonian fluid that displays reduced viscosity when subjected to shear forces. These features allow the jetting system 100 to form “droplets” of print media material 120 that are “expelled” or “ejected” from the print head 108 (e.g., due to action of the piezoelectric actuator). These droplets return to their “natural” higher viscosity state soon after the droplets exit the nozzle 110.

In at least some examples of this technology, prior to jetting, the print media material 120 may be “degassed” or “debubbled” to remove excess air or other gas from it (e.g., air or other gas entrapped while making the dispersion, packaging the dispersion, and/or combining ingredients to make the final print media material). This may be accomplished in any suitable manner. As one example, a volume of the print media material 120 may be exposed to vacuum conditions for a period of time, e.g., exposing 1 kg of print media material 120 to vacuum (e.g., 300-650 Torr) for 3-5 minutes to remove gas (bubbles) from the print media mixture and/or print media material 120. Additionally or alternatively, filtering the print media mixture and/or print media material 120 may provide at least some degassing and/or debubbling function (e.g., filtering may remove bubbles due to agglomeration of bubbles during the filtering process). Such degassing and/or debubbling can improve the appearance of the printed elements 102, e.g., by reducing or eliminating surface inconsistencies due to the presence of gas bubbles or voids and/or as a result of degassing that may occur after the jetting step.

Because the droplets recover their higher viscosity form when they are no longer subjected to shear forces, as the print media material 120 is incident on the substrate 104, three-dimensional printed structures 102 may be formed on the surface 104A of the substrate 104. Also, because of their increased viscosity (e.g., within the ranges described above), in at least some examples of this technology (e.g., depending on the pattern to be printed), the “droplets” can be combined (e.g., “piled up” on one another) to form printed structures 102 on the substrate 104 with a relatively high aspect ratio and/or to form printed structures 102 having relatively tall but narrow features, such as “fin” shaped structures and/or “bristle” like structures.

As some more specific examples, at least some printed structures 102 in accordance with aspects of this technology may include: (i) a largest base dimension D (e.g., a diameter or diagonal dimension) at the surface 104A of the substrate 104 and (ii) a height dimension H from the surface 104A of the substrate 104 to an outermost free end surface (a most distal point) of the discrete printed protrusion. See FIG. 1A. Each of the base and/or the height may be formed by multiple droplets of print media material 120. In at least some examples of this technology, such printed structures 102 may be formed to have an aspect ratio H/D of at least 1, and in some examples, at least 1.25, at least 1.5, at least 1.75, at least 2, at least 2.5, or at least 3. Formation of high aspect ratio printed structures 102 of at least some of the types described herein (and in more detail below) may be difficult and/or not possible using jetting systems 100 dispensing droplets of print media material if the print media material viscosity is insufficient (e.g., because the print media material would collapse upon impact and/or excessive flatten or spread out of the incident surface).

“Fin” shaped structures in accordance with some examples of this technology will be elongated in one direction (e.g., formed elongated in a manner similar to the “segments” described herein), but with a width dimension (transverse to its elongated direction) that is much less than longitudinal length. In some examples, a “fin” structure will have (a) a width dimension W and (b) a height dimension H (outward from the surface 104A to a free end surface (most distal point) thereof), wherein a ratio H/W will be of at least 1, and in some examples, at least 1.25, at least 1.5, at least 1.75, at least 2, at least 2.5, or at least 3.

As also mentioned above, after the printed structures 102 are formed on the substrate 104, the structures 102 and/or substrate 104 may be dried to lower the water content of the printed structures 102 and/or cross-linked (e.g., by heating the structures 102 and/or substrate 104 (e.g., to at least 80 degrees C. to activate cross-linking)). Once the printed structures 102 are dried and/or cross-linked (e.g., “baked”), a printed structure 102 (e.g., a polyurethane containing structure) remains fixed to the substrate 104. This printed structure 102 may have good elastic properties (e.g., stretchability, force dampening, etc.) and/or a relative high coefficient of friction (e.g., with respect to a game ball, such as a soccer ball).

The print media material 120 may be able to form chemical and/or mechanical bonds with the substrate 104, e.g., depending on the substrate type and the print media material 120 type. For example, if the material of the substrate 104 and the print media material 120 are compatible and/or the deposition, drying, cross-linking, and/or other conditions are suitable, the print media material 120 may chemically bond to (and thus be fixed to) the material of the substrate 104 (e.g., at its surface 104A) to form printed elements 102. This type of chemical bonding may occur, for example, if both the substrate 104 and the print media material 120 include compatible materials (e.g., both polyurethane materials). The substrate surface 104A may include a suitable material for this type of chemical bonding, such as in a film surface 104A formed on an underlying base layer and/or as at least some of the threads and/or fibers of the material of the substrate 104.

Additionally or alternatively, “fixing” may occur more mechanically. For example, for some fixed structures, the “wet” print media material 120 that contacts the substrate 104 may at least partially extend around or “wrap” one or more threads or fibers of the substrate 104 (e.g., at the substrate surface 104A). The print media material 120 may possess sufficient water (e.g., from the aqueous resin) to adequately “wet” the substrate 104 and/or at least partially flow, extend around, or “wrap” one or more threads or fibers of the substrate 104. After drying and/or cross-linking, these wrapped structures may fix the print media material 120 to the substrate 104 to form printed elements 102. In at least some examples of this technology, at least the finally printed, dried, and/or cross-linked printed elements 102 will comprise a thermoset material structure (e.g., having elastomeric properties).

Additionally or alternatively for at least some potential mechanical “fixing” of print media material 120 to a substrate 104, while not wishing to be bound by any particular theory of operation, when droplets of print media material 120 hit the substrate 104, the energy produced by the “impact,” in at least some instances and/or in at least some areas, may be sufficient to induce shear forces on the print media material 120 that may temporarily reduce the viscosity of the non-Newtonian print media material 120, allowing the droplets to temporarily “wet” the surface and/or wrap or become impregnated with the thread(s)/fiber(s) of a textile substrate 104.

In at least some examples of this technology, the printed structures 102 may include air bubbles and/or voids within them. These bubbles and/or voids may be the result of driving water out of the final printed structures 102, e.g., as the print media material 120 dries.

Additionally or alternatively, drying may result in at least some shrinkage of the printed structures 102. In at least some examples of this technology, controlling the speed of the drying step may be used, at least in part, to control the degree of shrinkage of the printed structures 102. In at least some instances and/or for at least some print media materials 120, slower drying (e.g., open air drying) may result in less shrinkage than more rapid drying processes (e.g., using heat and/or moving gas, using a drying tunnel, etc.).

In at least some examples of this technology, the substrate 104 with the dried printed structures 102 thereon may possess and/or retain the same or substantially the same elasticity and/or stretchability of the underlying substrate 104 before the printed structures 102 were applied thereto. In other words, the printed structures 102 may stretch along with substrate 104 and return back to (or toward) their original sizes and/or shapes after the stretching forces are sufficiently relaxed or removed. These elasticity/stretchability features may be present on a substrate 104 formed as a footwear upper component, e.g., of the types described in more detail below, and/or as other article of apparel components.

The elasticity and/or stretchability of a substrate 104 with printed structures 102 formed thereon may, at least in part, depend on the thickness of the printed structures 102. For example, the elasticity and/or stretchability of the final product (or retained elasticity and/or stretchability for the final product as compared to elasticity and/or stretchability of the substrate 104 prior to printing) may be inversely proportional to printed structure 102 thickness. Thus, elastomeric or stretchable substrates 104 with thinner printed structures 102 formed thereon may retain more elasticity and/or stretchability than elastomeric or stretchable substrates 104 with thicker printed structures 102 formed thereon. In at least some examples of this technology, substrates 104 with printed structures 102 formed thereon in which the printed structures 102 have a thickness of no more than 25 microns may retain the same or substantially the same elasticity and/or stretchability of the substrate 104 prior to (or without) the printed structures 102 thereon. The term “substantially the same” as used herein in this context, means that the elasticity and/or stretchability of the substrate 104 after the printed structure(s) 102 is/are applied is at least 95% of the elasticity and/or stretchability of the substrate 104 before the printed structure(s) 102 is/are applied.

Additionally or alternatively, in at least some examples of this technology, different printed media material 120 may be applied to different areas of a single substrate 104. This may be used, for example, to provide different properties in different areas of the substrate 104. For example, for some areas of a substrate 104 (e.g., around the instep region or collar region of a footwear upper, at a ball receiving region of an upper), it may be desirable to provide and/or maintain stretch and/or elasticity properties, but for other areas of the substrate 104 (e.g., lace engaging areas, eyelets, a ball propelling region of an upper, etc.), it may be desirable to provide less stretch, less elasticity, higher strength, higher wear resistance, greater hardness, etc. To do so, in accordance with at least some examples of this technology, the print media material 120 applied to these areas may differ. As some more specific examples, in these different areas, the print media material 120 may differ in one or more of: aqueous resin material used; aqueous resin material properties; amount of thickening agent present in the print media material 120; overall composition of the print media material 120; etc.

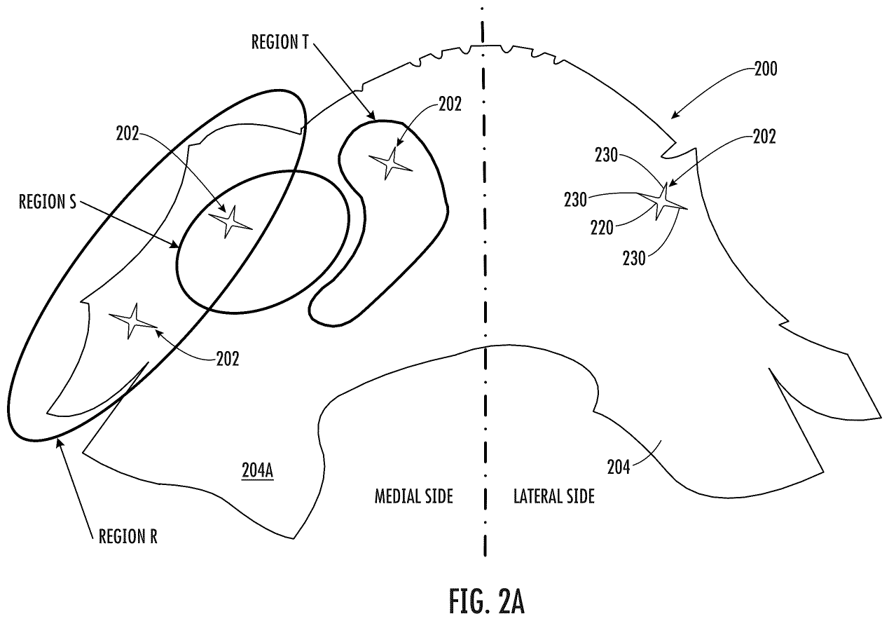

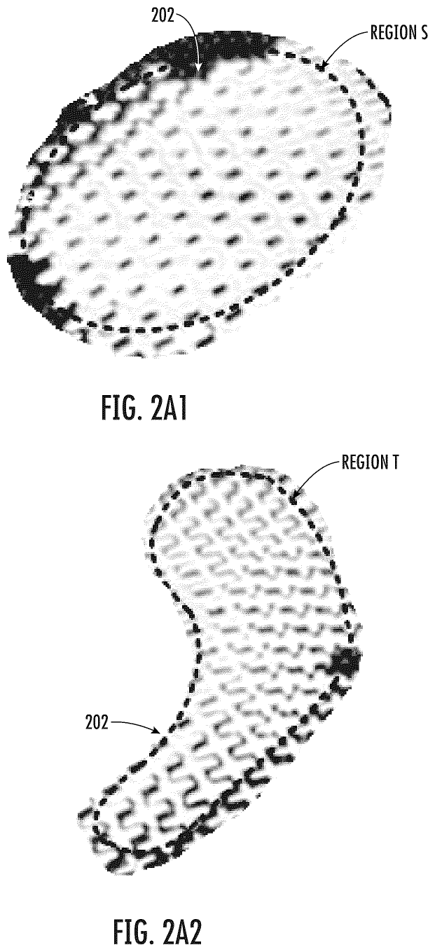

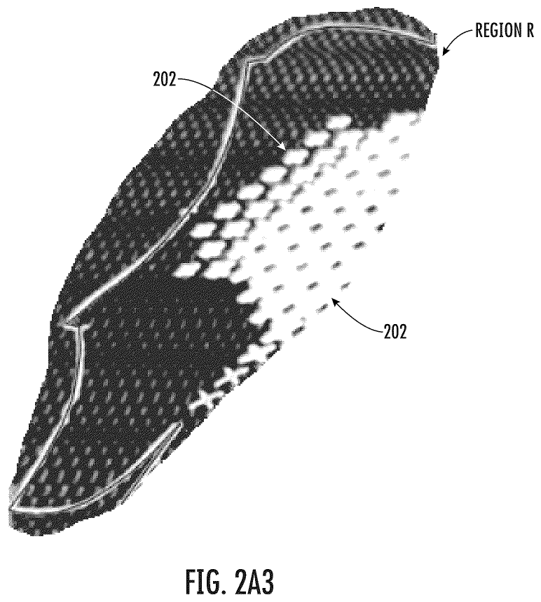

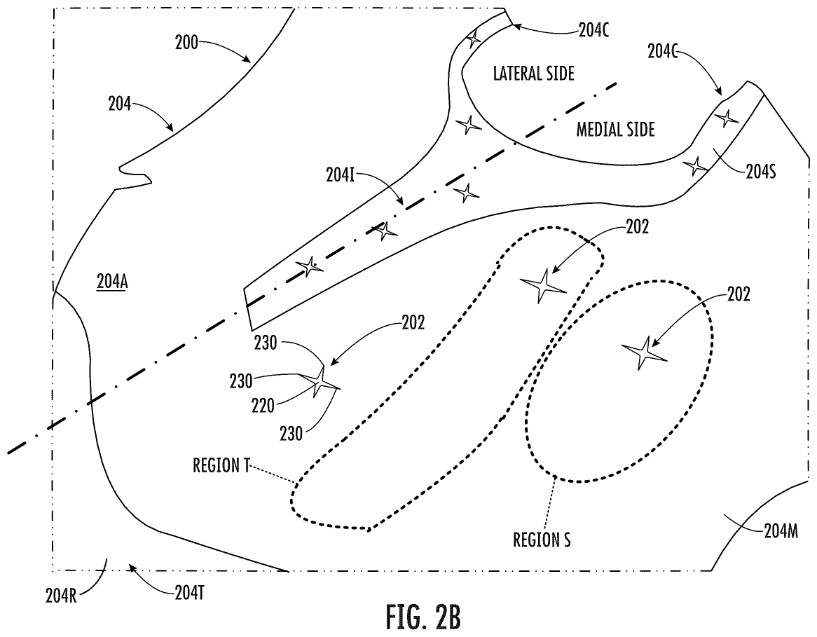

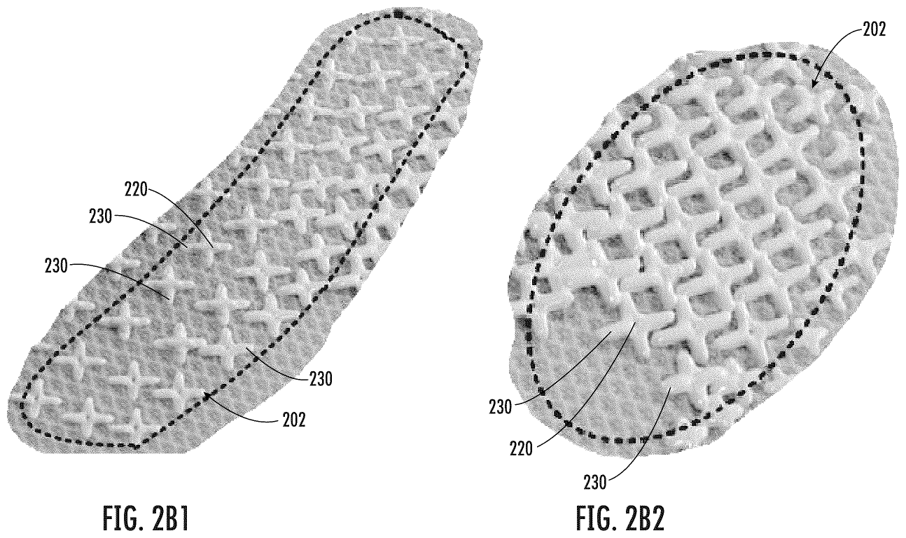

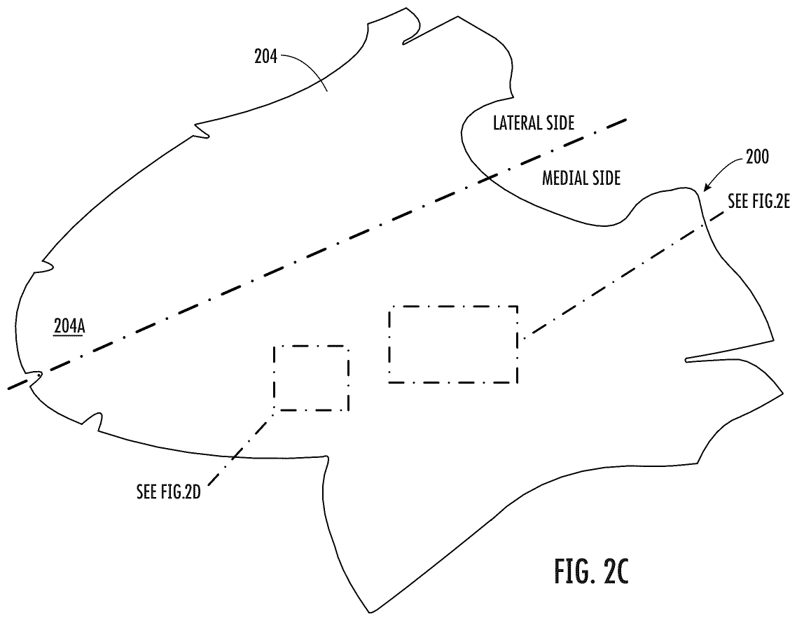

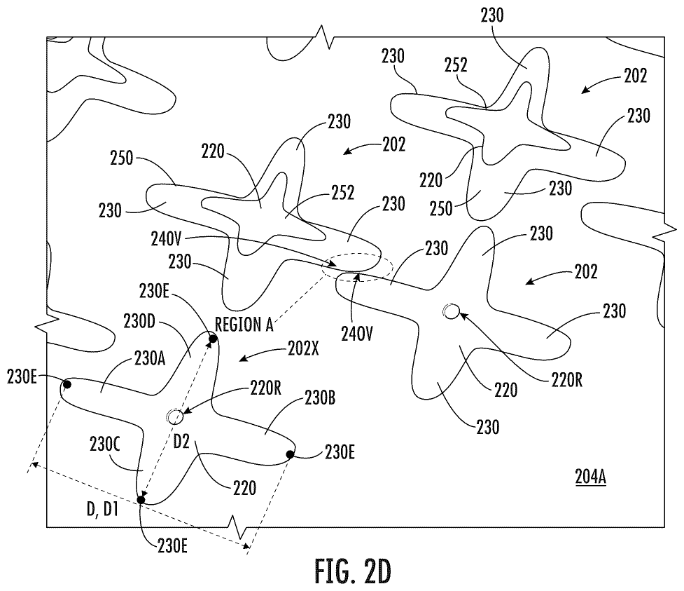

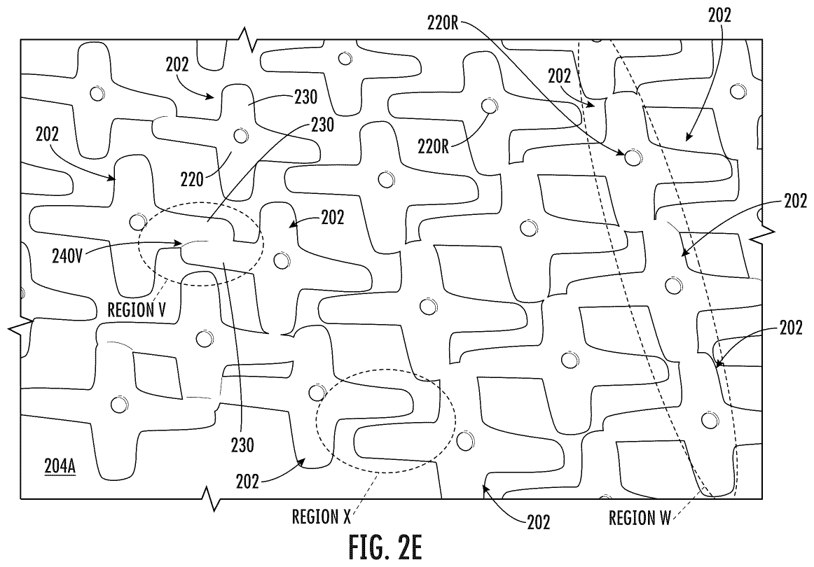

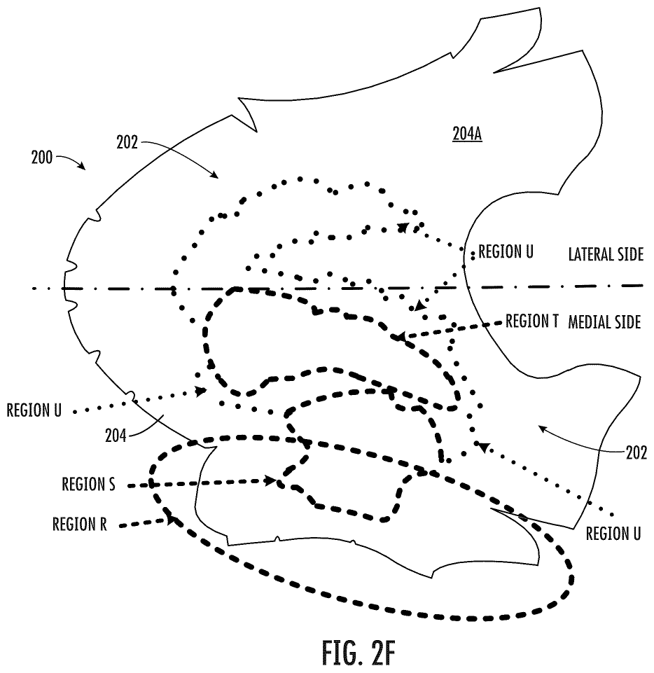

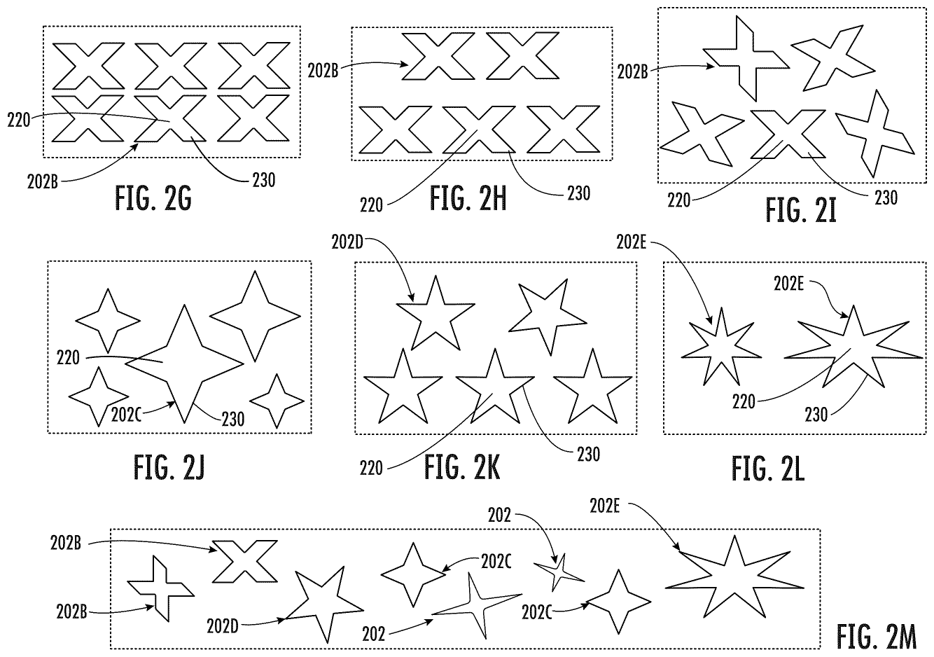

Additional aspects of this technology relate to substrates 104 with one or more printed structures 102 formed thereon. Various examples will be described in detail below in conjunction with FIGS. 2A-10. In at least some examples of this technology, the substrates (e.g., textiles, upper base members, and/or other articles of apparel) and printed elements shown in FIGS. 2A-10 may have any of the compositional, material, and/or structural features described above in conjunction with FIGS. 1A and 1B (for substrate 104 and printed elements 102). Additionally or alternatively, in at least some examples of this technology, the substrates and printed elements shown in FIGS. 2A-10 may be formed by any of the method features described above in conjunction with FIGS. 1A and 1B.

FIGS. 2A-2M illustrate various examples of footwear uppers 200 and portions thereof in accordance with some examples of this technology. The footwear uppers 200 include (a) a footwear upper base member 204 having (b) a plurality of printed elements 202 fixed to an exterior surface 204A thereof. The upper base members 204 of FIGS. 2A-2M may be formed from one or more upper component parts. Each upper base member 204 may have any of the features of substrate 104 described above in conjunction with FIGS. 1A and 1, and/or each upper base member surface 204A may include any of the features of surface 104A described above in conjunction with FIGS. 1A and 1B. Additionally or alternatively, printed elements 202 of FIGS. 2A-2M may have any of the features of printed elements 102 described above in conjunction with FIGS. 1A and 1B, and/or the printed elements 202 may be formed from any of the print media materials 120 described above in conjunction with FIGS. 1A and 1B.

In the examples of FIGS. 2A-2M, at least some of the discrete printed elements 202 of the plurality of printed elements 202 are formed to include: (a) a base region 220 (e.g., a central region) and (b) at least three wing elements 230 extending outward from the base region 220 in different directions. The wing elements 230 may have the same or different lengths from other wing elements 230 of the printed element 202. In at least some examples of this technology, at least some of the discrete printed elements 202 of the plurality of printed elements 202 have a largest dimension extending along the surface 204A in any one direction of less than 30 mm. Note FIG. 2D.

As used herein, a “discrete” printed element 202 means a printed element 102 structure separated from all adjacent printed element 102 structures by a portion of the surface 204A of the footwear upper base member 204. Additionally or alternatively, at least some adjacent printed elements 202 may abut one another, but the surface of abutting printed elements 202 at the abutting area may be such that the general shape and/or distinction between the individual printed elements 202 may be discerned. Note, for example, Region A in FIG. 2D and Region V in FIG. 2E, which show a wing element 230 of one printed element 202 abutting a wing element 230 of an adjacent printed element 202. A valley area 240V at the abutting region generally shows the boundaries of the two adjacent printed elements 202.

Printed elements 202 of the types illustrated in FIGS. 2A-2M may have different numbers of wing elements 230 extending away from a single base region 220 in various different examples of this technology. In the examples of FIGS. 2A-2J, the printed elements 202 include four wing elements 230 extending outward from their respective base regions 220. In at least examples (and as illustrated on one sample printed element 202X in FIG. 2D), one or more of the discrete printed elements 202 on an upper base member 204 may include: (i) a first wing element 230A and a second wing element 230B extending away from the base region 220A in opposite directions and (ii) a third wing element 230C and a fourth wing element 230D extending away from the base region 220A in opposite directions (and in a direction different from the directions that the first wing element 230A and the second wing element 230B extend). In some examples of this technology, providing plural wing element 230 extending outward in different directions helps assure that at least one wing element 230 surface (and the raised edges thereof) will be located in a position and/or orientation to engage a game ball surface. The printed elements 202 (e.g., the wing elements 230, their raised surfaces, their exposed edges, etc.) may provide an increased coefficient of friction, e.g., for “grip” when contacting a game ball and/or trying to impart spin on a game ball when kicking it.

For example, the material of the printed elements 202 may “grip” the ball surface better than the material of the upper base member 204, and/or the edges of the wing element(s) 230 may engage seams on the game ball to improve “grip” properties and/or increase the coefficient of friction of the upper 200 with respect to the game ball surface.

As further shown in FIGS. 2A-2J (and as illustrated on one sample printed element 202X in FIG. 2D), in at least some examples: (a) the third wing element 230C will be located between the first wing element 230A and the second wing element 230B on a first side of the base region 220A and the first and second wing elements 230A, 230B, and (b) the fourth wing element 230D will be located between the first wing element 230A and the second wing element 230B on a second side of the base region 220A and the first and second wing elements 230A, 230B. In other words, in at least some examples, the four wing elements 230 (and 230A-230D) will extend outward from the base region 220 such that the free ends 230E of the wing elements 230 are located at corners of a four-sided polygon and/or such that the wing elements 230A-230D form a cross or “X” shape.

Additionally, in at least some of the printed elements 202 in the examples of FIGS. 2A-2J (and as illustrated on one sample printed element 202X in FIG. 2D), the four wing elements 230A-230D will define: (a) a first distance D1 from a free end 230E of the first wing element 230A and a free end 230E of the second wing element 230B, and (b) a second distance D2 from a free end 230E of the third wing element 230C to a free end 230E of the fourth wing element 230D. In at least some examples of this technology, for at least a subset of the plurality of printed elements 202, the first distance D1 will be at least 10% greater than the second distance D2, and in some examples, at least 20% greater, at least 30% greater, at least 40% greater, or at least 50% greater.

FIGS. 2A-2C and 2F show the upper base member 204 of these examples formed as a flat sheet-like structure or substrate, e.g., as a footwear upper blank (i.e., a footwear upper component before being attached to a sole structure and assembled into a final footwear product). The upper base members 204 of FIGS. 2A-2C, and 2F may comprise: (i) textile elements, which may be knitted, woven, or non-woven and include a surface 204A made from threads and/or fibrous materials; (ii) materials having a non-fibrous surface 204A, such as a synthetic leather material or a film layer (e.g., a polyurethane film or skin and/or a TPU film or skin, optionally formed on an underlying fabric base layer). FIG. 2F is a schematic view showing areas of an upper 200 having printed element 202 structures with different height features.

As noted above, the upper base members 204 may be formed from one or more component parts. As a more specific example, the upper base members 204 of FIGS. 2A and 2C (or at least the exterior surfaces 204A thereof) may be formed from a single, continuous textile element or from a single, continuous non-threaded/non-fibrous textile element (e.g., synthetic leather, a polyurethane film or skin layer, a TPU film or skin layer, other film, skin, or sheet layer, etc.).

On the other hand, upper base members 204 in accordance with some examples of this technology may include multiple upper component parts. As one example, the upper base member 204 of FIG. 2B includes: (a) a main upper component part 204M forming a majority of the upper base member 204, (b) a stretchable component part 204S (e.g., forming one or more of instep region 2041 and/or a collar region 204C of the upper base member 204), and (c) a reinforcing component part 204R (e.g., forming a wear resistant or abrasion resistant layer at the forward toe region 204T of the upper base member 204) in this illustrated example. More or fewer upper component parts may be provided in other specific examples of this technology, e.g., to provide any desired properties at that/those local area(s).

In the example of FIG. 2B, at least some of the plurality of printed elements 202 provided on the stretchable component 204S are located in the instep region 2041 and the collar region 204C. In some examples, the printed elements 202 may be dispersed through the instep region 2041 and/or the collar region 204C.

The one or more upper component parts of the upper base member 204 may be provided in and/or form any one or more of: a medial heel upper region, a lateral heel upper region, a medial midfoot upper region, a lateral midfoot upper region, a medial forefoot upper region, a lateral forefoot upper region, a rear heel upper region, a forward toe upper region, an instep upper region, a collar upper region, a medial side upper region, and/or a lateral side upper region of the footwear upper 200. When formed from multiple component parts, the parts of the upper base member 204 may be attached together in any manner, including via sewn seams, via adhesives or other bonding, via mechanical connectors, etc., including in conventional manners known and used in the footwear arts.

Printed elements 202 may be provided in any desired portions of a footwear upper in accordance with aspects of this technology. As some additional examples, one or more printed elements 202 may be provided in any one or more of: a medial heel upper region, a lateral heel upper region, a medial midfoot upper region, a lateral midfoot upper region, a medial forefoot upper region, a lateral forefoot upper region, a rear heel upper region, a forward toe upper region, an instep upper region, a collar upper region, a medial side upper region, and/or a lateral side upper region of the footwear upper 200.

Additional example features of aspects of this technology are shown in FIGS. 2A-2F. For example, as shown in these figures, the distribution density of printed elements 202 need not be constant over the entire surface 204A of an upper base member 204. These figures show upper base member 204 components with discrete printed elements 202 formed thereon, in which: (a) a first subset of printed elements 202 located in a first region of the footwear upper base member 204 has a first printed element 202 distribution density and (b) a second subset of printed elements 202 located in a second region of the footwear upper base member 204 has a second printed element 202 distribution density, wherein the first printed element 202 distribution density is higher than the second printed element 202 distribution density. Printed element 202 “distribution density” means a number of discrete printed elements 202 within a unit area.

In some examples of this technology, the medial side of an upper base member 204 will have a higher printed element distribution density that the lateral side.

In some more specific examples, a first region having a greater printed element 202 distribution density may be provided in at least one of a medial midfoot region and/or a medial heel region of the footwear upper base member 204. This medial midfoot region and/or medial heel region of footwear upper base member 204 may have a higher printed element 202 distribution density than the distribution densities provided at all or most other regions of the footwear upper base member 204.

Additionally or alternatively, in at least some examples of this technology, this medial midfoot region and/or a medial heel region of a footwear upper base member 204 having a greater printed element 202 distribution density may correspond to an area of a footwear upper 200 that often receives an incoming game ball (e.g., a soccer ball) and is used to control the ball during play (also called a “ball receiving region” herein). Note Region S shown in FIGS. 2A, 2A1, 2B, and 2F. These example first regions having a greater printed element 202 distribution density may provide some additional force damping properties (e.g., using printed elements 202 having elastomeric properties) to absorb impact energy of a game ball incident thereon. The printed elements 202 in the ball receiving region (Region S) may be made from a material that improves “grip” on the ball surface. These features may lessen the ball's rebound force, help keep the ball closer to the player that contacted it, and/or help the user maintain control of the ball. Additionally or alternatively, at least some of the printed elements 202 in these ball receiving regions having a greater printed element 202 distribution density also may have a greater thickness than thicknesses of printed elements 202 located at other regions of the footwear upper 200. Thicker printed elements 202 within that Region S may further enhance the game ball energy absorption and ball control features described above.

In some examples of this technology, a part of the upper 200 may extend around a side edge of the upper 200 to an area that will be located beneath the plantar surface of a wearer's foot in a final footwear product. This region may correspond to Region R shown in FIGS. 2A, 2A3, and 2F. This Region R may include one or more printed elements 202 thereon and/or may form at least a portion of the ball receiving region (Region S) of an article of footwear and footwear upper 200. Such printed elements 202 may remain exposed at the bottom of the final footwear product, e.g., through an opening or gap provided in an outsole component of the footwear, so that these bottom printed elements 202 are able to contact a game ball is use. In this manner, the printed elements 202 located at a bottom of the article of footwear may be used, for example, to “grip,” slow, and/or stop an incoming ball and/or to absorb at least some force from an incoming ball. These features can help a player keep the ball closer to them and control the ball during play.

The illustrated examples show Region R located on a medial side of the upper 200, e.g., in the medial midfoot upper region. Additionally or alternatively, such features could be provided at the medial forefoot upper region and/or the medial heel upper region. Additionally or alternatively, one or more printed elements 202 may be provided at the bottom of the upper 200 and exposed in a final footwear product at the lateral midfoot upper region, the lateral forefoot upper region, and/or the lateral heel upper region.

Still additionally or alternatively, a region having a greater printed element 202 distribution density may correspond to an area of a footwear upper 200 that often propels (e.g., kicks) a game ball (e.g., a soccer ball) away from a player during play (also called a “ball propelling region” herein). Note Region T shown in FIGS. 2A, 2A2, 2B, and 2F. As some more specific examples, a region having a greater printed element 202 distribution density may be provided at least in a medial forefoot region and/or a medial midfoot region of a footwear upper base member 204. In such structures, this example region having a greater printed element 202 distribution density may provide a greater surface area on the footwear upper 200 having increased frictional or “grip” properties with respect to the game ball surface (e.g., using raised printed elements 202 and/or printed elements 202 having greater coefficient of friction properties with respect to the game ball than the upper base member 204). These features may enable a player to impart spin onto the game ball when kicking it. The printed elements 202 in this region having a greater printed element 202 distribution density (e.g., Region T) are “raised up” from the base surface 204A of the upper base member 204 to enable them to contact the game ball surface. And the increased distribution density helps better assure that more printed element 202 surface area is available to interact with the ball surface. The printed elements 202 in the ball propelling region may be made from a material that improves “grip” on the ball surface and/or raised edges thereof may interact with the ball seams to impart spin.

Additionally or alternatively, in at least some examples of this technology, a footwear upper base member 204 may include: (a) a first subset of printed elements 202 having a first maximum thickness dimension and (b) a second subset of printed elements 202 having a second maximum thickness dimension wherein the first maximum thickness dimension is greater than the second maximum thickness dimension. As some more specific examples: (i) one region of a footwear upper base member 204 may include the first subset of thicker printed elements 202 having their maximum thickness dimension of 1.25 mm or greater (e.g., in Region S and/or Region T of FIGS. 2A, 2B, and/or 2F), and in some instances 1.5 mm or greater and (ii) another region of a footwear upper base member 204 may include the second subset of thinner printed elements 202 having their maximum thickness dimension of less than 1.25 mm (e.g., in regions other than Region S and/or Region T of FIGS. 2A, 2B, and/or 2F). In some examples, the “thicker” region(s) may have a maximum thickness dimension of at least 1.5 mm and/or within a range of 1.25 mm to 2 mm, within a range of 1.25 mm to 1.75 mm, within a range of 1.25 mm to 1.5 mm, or within a range of 1.5 mm to 1.75 mm. Additionally or alternatively, in some examples, the “thinner” region(s) may have a maximum thickness dimension of less than 1 mm and/or within a range of 1 mm to less than 1.25 mm, within a range of 0.25 to 0.75 mm, or within a range of 0.4 mm to 0.6 mm.

As noted above, Region S of FIGS. 2A, 2A1, 2B, and/or 2F may include thicker printed elements on an upper base member 204. In this illustrated example, Region S includes a medial midfoot and/or medial heel region of the footwear upper base member 204 and generally constitutes at least part of an incoming game ball receiving zone of the upper 200 as described above. The thicker printed elements 202 in Region S may provide additional impact force absorption for this region, as described above. In one specific example, the printed elements 202 in Region S will have a thickness dimension within a range of 1.5 mm to 1.75 mm. As shown in FIG. 2F, Region S may extend into Region R such that some of the printed elements 202 of Region S may be located underfoot and/or exposed at the sole of the article of footwear in the final footwear product.

Additionally or alternatively, a footwear upper base member 204 may include one or more other regions having thicker printed elements 202, such as Region T. Region T in the example of FIGS. 2A, 2A2, 2B, and/or 2F is located higher on the upper base member 204 than Region S (if a thicker Region S is present), and it includes at least parts of a medial forefoot, a medial midfoot, and a medial heel region of the upper base member 204 in these examples. The thicker printed elements 202 in Region T may provide higher raised surface to interact with (and produce friction on) a game ball being propelled (e.g., kicked) by the wearer. In one specific example, the printed elements in Region T will have a thickness dimension within a range of 1.25 mm to 1.5 mm.

While FIG. 2F shows an example upper base member 204 that includes thicker printed elements 202 in both Region S and Region T, this is not a requirement in all examples of this technology. Some specific example uppers 200 may include thicker printed elements 202 only in Region S or only in Region T. When thicker printed elements 202 are included on a single footwear upper 200, the printed elements 202 in Region S may be made from different materials than the printed elements 202 in Region T; the printed elements 202 in Region S may have a different structure from those in Region T; and/or the printed elements 202 in Region S may have a greater maximum thickness than the maximum thickness of the printed elements 202 in Region T.

In the specific example of FIG. 2F: (a) the printed elements 202 in Region S have a thickness within a range of 1.5 mm to 1.75 mm, (b) the printed elements 202 in Region T have a thickness within a range of 1.25 mm to 1.5 mm, (c) the printed elements 202 in Region U have a thickness within a range of 1 mm to 1.25 mm, and (d) the printed elements 202 located outside of Regions S, T, and U have a thickness within a range of 0.4 mm to 0.6 mm. Additionally, in the specific example of FIG. 2F, (a) Region S includes a medial midfoot and/or medial heel region of the footwear upper base member 204 (and extends into Region R such that at least some printed elements 202 may be located at an underfoot area of the upper 200 and/or at the bottom of the sole structure of a finished article of footwear), (b) Region T is located higher on the footwear upper base member 204 than Region S (closer to the top instep area) and includes at least parts of a medial forefoot, a medial midfoot, and a medial heel region of the upper base member 204, (c) Region U generally separates Region S from Region T and generally surrounds Region T, and (d) the area outside Regions S, T, and U is located in the central top instep region and generally around the outer perimeter of the upper base member 204 (including extending to one or more of: a lateral midfoot region, a lateral forefoot region, a lateral heel region, a forward toe region, and/or a medial heel region of the footwear upper base member 204).

Additionally or alternatively, Region S may have a greater printed element 202 distribution density than the other regions and/or Region T may have a greater printed element 202 distribution density than at least Region U and/or the region outside of Regions S, T, and U.

In the example footwear upper 200 of FIG. 2A, the printed elements 202 in the medial heel and/or medial midfoot regions (e.g., the game ball receiving region, Region S) may include a very high distribution density and/or may form a substantially continuous printed structure. FIG. 2A1 illustrates a view of one example of a printed element 202 arrangement for Region S of FIG. 2A. At least some of the printed elements 202 in this game ball receiving Region S may have a multi-tiered structure (also called a “multi-layered structure” herein), e.g., to provide added thickness and/or additional edges. The game ball receiving Region S of FIG. 2A generally may correspond in location to Region S described above in conjunction with FIGS. 2A and 2F. Additionally or alternatively, the printed element(s) 202 in this area may have thicknesses corresponding to Region S described above. The ball receiving region of the example of FIG. 2A also may extend to areas of the upper 200 that will be located beneath the wearer's plantar surface in the final footwear product (e.g., into a part of Region R shown in FIG. 2A). These features may enhance force damping characteristics of this region, as described above.

The example footwear upper 200 of FIG. 2A further includes a game ball propelling region, Region T, e.g., generally located higher and forward on the footwear upper base member 204 from the game ball receiving Region S. FIG. 2A2 illustrates a view of one example of a printed element 202 arrangement for Region T of FIG. 2A. At least some of the printed elements 202 in this game ball propelling Region T may have a multi-tiered structure, e.g., to provide surfaces (edges) for engaging the surface of a game ball (e.g., engaging the ball's seams). The game ball propelling Region T of FIG. 2A generally may correspond in location to Region T described above in conjunction with FIG. 2F. The printed elements 202 at least in the medial forefoot and/or medial midfoot regions of Region T may have a high distribution density, but in the example of FIG. 2A, not as high as that in the game ball receiving Region S of FIG. 2A. Additionally or alternatively, at least some of the printed elements 202 of Region T will not form a continuous printed structure, but Region T may include at least some abutting wing elements 230 (e.g., of the types described above). Additionally or alternatively, the printed element(s) 202 in this ball propelling Region T may have a thickness corresponding to Region T described above in conjunction with FIG. 2F. These features may enhance coefficient of friction features and grip enhancing characteristics of this region, as described above.

FIG. 2A3 illustrates a view of one example of a printed element 202 arrangement for Region R of the upper 200 of FIG. 2A. This Region R of FIG. 2A may wrap around a side edge of an article of footwear such that at least a portion of Region R (and at least a portion of the printed element(s) 202 thereon) will be located at the bottom of the footwear structure in the final footwear assembly. In some examples, at least some of the printed elements 202 of Region R may have thickness features corresponding to Region S and/or Region T of FIG. 2F. Additionally or alternatively, in some examples, at least some of the printed elements 202 of Region R may have thickness features corresponding to Region U or the area outside of Regions S, T, and U in FIG. 2F.

In the example footwear upper 200 of FIG. 2A, the areas outside of the game ball receiving Region S and the game ball propelling Region T (e.g., generally corresponding to Region U and the area outside of Regions S, T, and U shown in FIG. 2F) may have printed element 202 thickness features within the ranges described above for Region U and/or thickness features within the ranges described above for the area outside of Regions S, T, and U shown in FIG. 2F. In other words, the thickness features described above for FIG. 2F also may apply to the corresponding regions of the upper 200 shown in FIG. 2A.

Additionally, the thickness features described above for FIGS. 2A and 2F also may apply to the corresponding regions of the uppers 200 shown in FIGS. 2B and 2C.

Additional features of printed elements 202 in accordance with at least some examples of this technology are described below in conjunction with FIGS. 2C-2E. FIGS. 2D and 2E show enlarged portions of printed elements 202 located in the noted regions of FIG. 2C, and the printed element 202 features described in conjunction with FIGS. 2D and 2E may be included in at least some of the printed elements 202 in the uppers 200 shown in FIGS. 2A, 2B, and/or 2F.

As shown in FIG. 2D, at least some of the plurality of printed elements 202 in an upper 200 may include a recess 220R in the base region 220. The recess(es) 220R, when present, may have a wide variety of shapes and/or sizes. In at least some such printed elements 202, the recess 220R may extend completely through the printed element 202 thereby forming an opening through printed element 202. Thus, the surface 204A of the underlying upper base member 204 may be exposed through the recess and/or opening 220R of at least some of these printed elements 202. The recesses and/or openings 220R, when present, may enhance the flexion properties of that specific printed element 202 (e.g., providing room for the printed element 202 to deform under applied force), which can further enhance the force damping properties. Thus, in at least some examples of this technology, one or more printed elements 202 having recesses/openings 220R in the base region 220 may be provided in the ball receiving region of the upper base member 204 (e.g., in areas corresponding to Region R and/or Region S described above) (although these recess and/or opening 220R features may be provided in one or more of the other areas of an upper 200 as well).

Additionally or alternatively, in at least some examples, recesses and/or openings 220R of this type may be provided in one or more wing elements 230 of a printed element 202 structure (e.g., along a portion of the length of the wing element(s) 230).

Additionally or alternatively, as also shown in FIG. 2D, at least some of the printed elements 202 in an upper 200 may include a raised printed structure overlaying the base region 220 and/or overlaying the wing elements 230 extending outward from the base region 220. In other words, the base region 220 and/or the wing elements 230 may have a two (or more) tiered structure. As shown in FIG. 2D, at least some of the printed elements 202 include: (a) a base tier or level 250 (e.g., fixed to the surface 204A of the upper base member 204) and (b) a raised tier or level 252 (e.g., built up from the base tier or level 250). This type of multi-layered structure may provide additional edges and/or surface area on the printed element(s) 202 available to interact with the surface of a game ball, which can further enhance the grip and/or spin inducing properties described above. Thus, in at least some examples of this technology, one or more printed elements 202 having a multi-tiered structure may be provided in the ball propelling region of the upper base member 204 (e.g., in Region T described above) (although these features may be provided in one or more of the other areas of an upper 200 as well).

The raised tiers or levels 252 in the specific examples shown in FIG. 2D overlay both the base region 220 and all of the wing elements 230. Other options are possible. For example, the raised tier or level area 252 may be provided only in the base region 220 and/or only in the wing elements 230. Additionally or alternatively, the raised tier or level area 252 need not be provided on all of the wing elements 230 of a specific printed element 202 structure. Rather, the raised tier or level area 252, when present, may be provided on none or on any one or more wing elements 230. Still additionally or alternatively, a raised tier or level area 252 may be utilized in combination with a recess and/or opening 220R provided in a central region of the base region 220 and/or at other areas (e.g., such that only one or more wing elements 230 have the raised tier(s) and/or level area(s) 252). Thus, a wide variety of different specific structures, appearances, and/or features may be provided for the printed elements 202.

As noted above, in uppers 200 in accordance with at least some examples of this technology, portions of adjacent printed elements 202 may abut one another. FIG. 2E illustrates additional potential features of such “abutting” structures. As shown in FIG. 2E, at least some printed elements 202 may be formed such that at least one wing element 230 of a first printed element 202 will abut a wing element 230 of an adjacent printed element 202. Note, for example, the abutting wing elements 202 in Region A shown in FIG. 2D and in Region V shown in FIG. 2E.

Additionally or alternatively, in uppers 200 in accordance with at least some examples of this technology, portions of adjacent printed elements 202 may be formed such that wing elements 230 of multiple adjacent printed elements 202 abut to form a continuous line of printed structure spanning the multiple adjacent printed elements 202. Wing elements 230 of two or more printed elements 202 may abut in this manner, and in some examples, three or more printed elements 202 may abut in this manner, four or more printed elements 202 may abut in this manner, etc. The example shown in Region W of FIG. 2E shows at least four printed elements 202 abutting to form a continuous line of printed material spanning at least through the wing elements 230 of those four printed elements 202.

Additionally or alternatively, as also shown in FIG. 2E, in some areas of a footwear upper 200, adjacent printed elements 202 may be oriented such that at least one wing element 230 of a first printed element 202 will extend between two adjacent wing elements 230 of an adjacent second printed element 202. Further, one wing element 230 of the second printed element 202 may extend between two adjacent wing elements 230 of the first printed element 202. See Region X in FIG. 2E. The wing elements 230 of adjacent printed elements 202 in Region X may abut or they may be separated from one another.

Abutting structures and continuous lines of printed elements 202 of the types described above and shown in Regions V, W, and/or X of FIG. 2E may be provided at various different locations of an upper 200 structure (e.g., on one or more of a medial side, a lateral side, a heel region, a forefoot region, and/or a midfoot region of the upper 200). The specific example of FIG. 2C shows Regions V, W, and X in a medial midfoot region and/or a medial heel region of that upper 200 (e.g., in a ball receiving zone or in a region corresponding to Region S from FIG. 2A, 2B, or 2F). In this manner, greater surface area of printed elements 202 is available, e.g., to provide force damping characteristics as described above. The printed elements 202 in Regions V, W, and/or X of FIG. 2E may have thickness properties corresponding to the thickness ranges for Region S described above in conjunction with FIG. 2F. Additionally, as shown in FIG. 2E, the printed elements 202 in one or more of Regions V, W, and/or X may have recesses/openings 220R through the base region 220 of the respective printed elements 202.

When present, abutting printed elements 202 forming continuous lines of printed structure may have the continuous line(s) oriented at various different directions. In the illustrated examples of FIG. 2E, the continuous line of Region W generally is oriented in a top-to-bottom direction of the footwear upper 200 (e.g., extending in a direction from the sole toward the instep region in a final assembled footwear product).

Various example printed element 202 structures are shown in FIGS. 2A-2F and are described above. While these examples generally show printed elements 202 having a base region 220 and four wing elements 230, it is recognized that a wide range of other printed element 202 structures could be provided having materially different appearances. For example, the base region(s) 220 and/or wing elements 230 could be varied in size, shape, spacings, and the like. Additionally or alternatively, different numbers and/or arrangements of printed elements 202 having recesses 220R and/or multi-leveled structures (250, 252) may be provided on an upper base member 204. Additionally or alternatively, more or fewer wing elements 230 could be provided (e.g., from two to eight wing elements 230) extending from a single base region 220. As another example, printed elements 202 having different numbers of wing elements 230 and/or different shapes could be provided on a single upper base member 204.

Thus, the aesthetic appearance of an upper 200 and/or printed elements 202 on an upper 200 could be varied widely while still providing the desired functionality (e.g., such as force damping and/or improved coefficient of friction features as described above). Some additional and/or alternative uppers 200 and/or articles of footwear having printed structures thereon are described in more detail below, e.g., in conjunction with FIGS. 2G to 10.

Some example printed element variations are shown in FIGS. 2G-2M. For example, FIG. 2G shows a partial pattern of printed elements 202B having a base region 220 and four wing elements 230, but the wing elements 230 are differently shaped from the wing elements 230 shown in FIGS. 2A-2E. In this illustrated area of FIG. 2G, the printed elements 202B are arranged in rows and columns. At least some of the printed elements 202B of FIG. 2G also may include a recess and/or opening 220R in the base region 220, a multi-tiered structure, and/or abutting features, e.g., of the types described above.

FIG. 2H shows a partial pattern of printed elements 202B having the same general shapes as those in FIG. 2G (e.g., with a base region 220 and four wing elements 230), but the printed elements 202B are arranged in staggered rows such that a printed element 202B in one row is located between and not aligned with printed elements 202B in the adjacent row. At least some of the printed elements 202B of FIG. 2G also may include a recess and/or opening 220R in the base region 220, a multi-layered structure, and/or abutting features, e.g., of the types described above.

FIG. 2I shows a partial pattern of printed elements 202B having the same general shapes as those in FIGS. 2G and 2H (e.g., with a base region 220 and four wing elements 230), but the printed elements 202B in this area are arranged in an irregular or inconsistent pattern. At least some of the printed elements 202B of FIG. 2I also may include a recess and/or opening 220R in the base region 220, a multi-layered structure, and/or abutting features, e.g., of the types described above.

FIG. 2J shows another partial pattern of printed elements 202C having a base region 220 and four wing elements 230. The printed elements 202C of FIG. 2J differ from the printed elements 202 shown in FIGS. 2A-2F in that the base region 220 is relatively larger and the wing elements 230 are more triangular shaped. Additionally or alternatively, the example area shown in FIG. 2J illustrates printed elements 202C of different sizes (but similar shapes) within the same substrate. At least some of the printed elements 202C of FIG. 2J also may include a recess and/or opening 220R in the base region 220, a multi-layered structure, and/or abutting features, e.g., of the types described above.

FIG. 2K shows a partial pattern of still different example printed elements 202D. These printed elements 202D have a base region 220 and five wing elements 230. The wing elements 230 of this example are generally triangular shaped (although other shapes could be used, such as the more elongated shapes of wing elements 230 shown in FIGS. 2A-2F). At least some of the printed elements 202D of FIG. 2K also may include a recess and/or opening 220R in the base region 220, a multi-layered structure, and/or abutting features, e.g., of the types described above.

FIG. 2L shows a partial pattern of additional different example printed elements 202E. These printed elements 202E have a base region 220 and seven wing elements 230. The wing elements 230 of this example are generally triangular shaped (although other shapes could be used, such as the more elongated shapes of wing elements 230 shown in FIGS. 2A-2F). FIG. 2L further illustrates that the printed elements 202E on a single substrate may have different overall shapes (e.g., with one seven-wing printed element 202E elongated as compared to the other). At least some of the printed elements 202E of FIG. 2L also may include a recess and/or opening 220R in the base region 220, a multi-layered structure, and/or abutting features, e.g., of the types described above.

FIG. 2M further illustrates that a single substrate may include printed elements having a variety of different sizes and/or shapes. In this illustrated example, the printed elements shown are some of those from the arrangements shown in FIGS. 2A-2L, although more or fewer different sizes and/or shapes may be included and/or different printed element structures may be included. Additionally or alternatively, the pattern and/or relative arrangement of printed elements could be varied widely from the specific pattern/arrangement shown in FIG. 2M.

As illustrated in FIGS. 2A-2M, at least some of the printed elements 202 may be relatively small as compared to an overall size and/or surface area of the upper 200. Thus, several printed elements 202 having any of the features and/or characteristics described above may be provided on a single upper base member 204. As some more specific examples, an upper base member 204 may include at least 25 discrete printed elements 202, and in some examples, at least 50, at least 75, at least 100, at least 150, at least 200, at least 250, or even at least 300 discrete printed elements 202 (having any of the features and/or characteristics described above).

As evident from the discussion of FIGS. 2A-2M, printed elements 202 provided for footwear uppers 200 may have a wide variety of structures and/or arrangements in different examples of this technology. Thus, the aesthetic appearance of an upper 200 and/or printed elements 202 on an upper 200 could be varied widely while still providing the desired functionality (e.g., such as the desired force damping and/or improved coefficient of friction features).

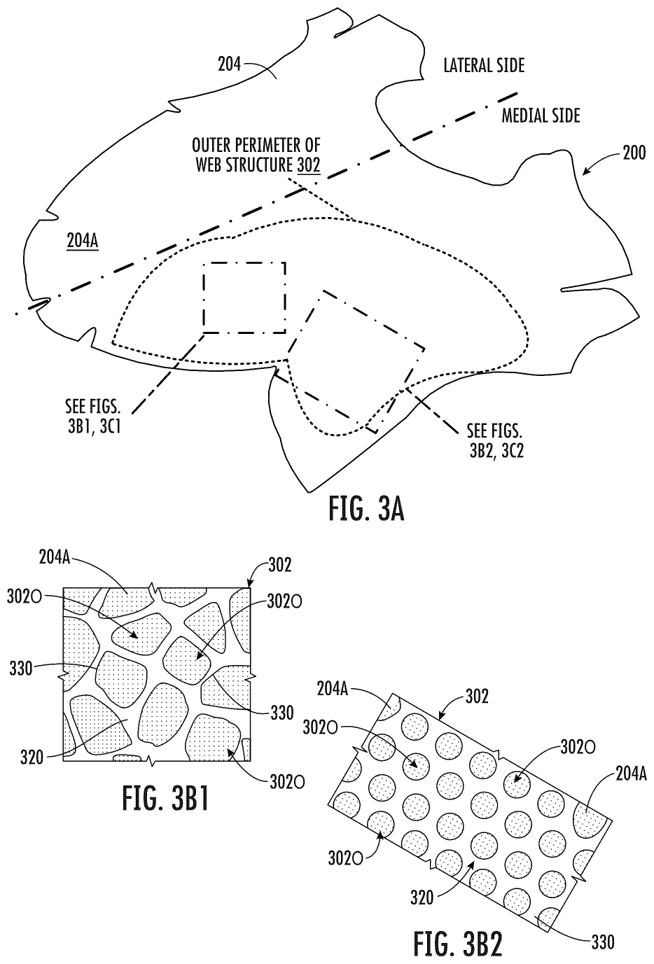

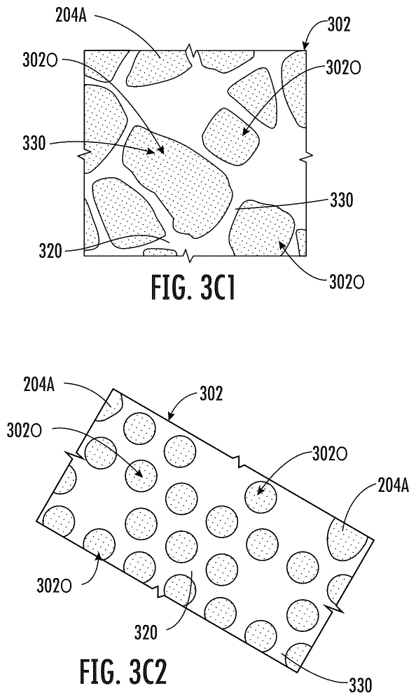

At least some examples of this technology may include printed elements that are in a form other than printed elements having a base region and three or more wing elements extending outward from the base region. FIGS. 3A-5C illustrate examples of footwear uppers 200 in accordance with some examples of this technology in which the printed elements are formed as web structures 302. More specifically, such footwear uppers 200 may include: (a) an upper base member 204 having an exterior surface; and (b) a printed web structure 302 fixed to the exterior surface. The upper base members 204 of FIGS. 3A-5C may be formed from one or more upper component parts. Each upper base member 204 may have any of the features of substrate 104 described above in conjunction with FIGS. 1A and 1, and/or each upper base member surface 204A may include any of the features of surface 104A described above in conjunction with FIGS. 1A and 1B.

The printed web structure 302, portions of which are shown in FIGS. 3B1 and 3B2, may include: (i) a plurality of printed nodes elements 320, and (ii) a plurality of printed segments 330 extending between two of the node elements 320. In at least some example web structures 302, at least 25% of the plurality of printed node elements 320 in a continuous web structure 302 will have at least three printed segments 330 extending outward in different directions on the surface 204A of the upper base member 204. In some examples, one or more node elements 320 may include four printed segments, five printed segments, six printed segments, or from three to six printed segments extending outward therefrom. Additionally, in some examples, at least 40%, at least 50%, at least 60%, at least 75%, or even at least 90% of the node elements 320 in a continuous web structure 302 will have any of these node element 320 and/or printed segment 330 features.

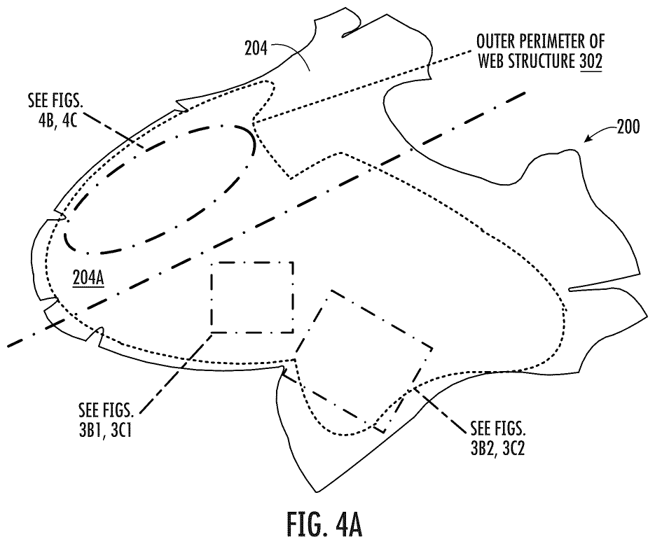

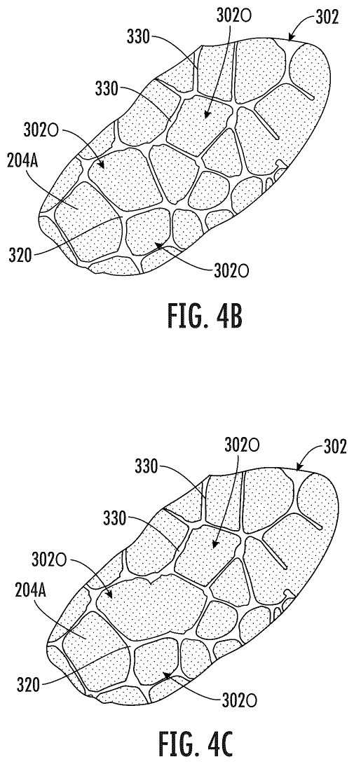

In some examples of this technology, the web structure 302 located on the surface 204A of the upper base member 204 forms a continuous web of interconnected segments 330, and this continuous web may span a surface area of at least 25 cm² on the surface 204A of the upper base member 204 (and in some examples, it may span a surface area of at least 50 cm², at least 75 cm², or at least 100 cm² on the surface 204A of the upper base member 204). The surface area “spanned” will correspond to an area enclosed within an outermost perimeter of the continuous web structure 302, e.g., as shown by the “Outer Perimeter” extents of in FIGS. 3A and 4A.

The web structures 302 of FIGS. 3A-5C may have any of the features of printed elements 102 described above in conjunction with FIGS. 1A and 1i, may be formed by any of the methods described above (e.g., in conjunction with FIGS. 1A and 1), and/or may be formed from any of the print media materials 120 described above in conjunction with FIGS. 1A and 1B.

As illustrated in FIGS. 3B1, 3B2, 3C1, 3C2, 4B, 4C, and 5A-5C, in at least some examples, the printed web structure 302 will define a plurality of enclosed openings 302O through which the exterior surface 204A of the upper base component 204 is exposed. These openings 302O may be defined by at least three printed node elements 320 and at least three printed segments 330 connecting the node elements 320. In at least some examples of this technology, at least 25% of the plurality of enclosed openings 302O will enclose a continuous open area of less than 25 cm² (or an area of less than 10 cm²). As some additional examples, at least 40%, at least 50%, at least 60%, at least 75%, or even at least 90% of the plurality of enclosed openings 302O in a continuous web structure 302 will have sizes within the above area ranges.

The areas of the openings 302O in a single web structure 302 may vary in a single upper 200. In general, larger openings 302O may provide increased flexibility as compared to smaller openings 302O.

Additionally or alternatively, smaller openings 302O may provide an increased surface area, an increased thickness, and/or increased volume of print media material 120 at that local area. The increased surface area, thickness, and/or volume may be used to produce and/or enhance the force damping effects described above (e.g., when the print media material 120 forming the web structure 302 has elastomeric properties). In the examples of FIGS. 3B2, 3C2 and 5B, the areas of the ball receiving zones of the illustrated uppers 200 (e.g., the area generally corresponding to Regions R and/or S of FIGS. 2A and 2F) include openings 302O of smaller size than openings 302O at other areas of that web structure 302 and/or upper 200. In some examples of this technology, at least some of the openings 302O in the medial midfoot region and/or the medial heel region (e.g., in the ball receiving Region S) may have an average size that is at least 25% smaller than an average size of the openings 302O located outside the medial midfoot region and/or the medial heel region (e.g., at the medial forefoot region, the forward toe region, and/or at the lateral side).

Additionally or alternatively, the sizes of the segments 330 may vary in a single upper 200. In at least some examples of this technology, at least 25% of the plurality of printed segments 330 forming the continuous web structure 302 may have a maximum cross-sectional area of less than 0.25 cm² (and in some examples, less than 0.1 cm²). As some additional examples, at least 40%, at least 50%, at least 60%, at least 75%, or even at least 90% of the segments 330 in a continuous web structure 302 will have areas within the above ranges. This cross-sectional area is measured through a plane transverse to a longitudinal length dimension of the printed segment 330 and/or transverse to the direction between the two node elements 320 between which the segment 330 extends.

In general, larger printed segments 330 may provide increased strength and/or durability to the web structure 302. Such larger printed segments may provide increased strength for use in the ball propelling region of an upper 200 (e.g., at least in a medial forefoot region and/or a medial midfoot region of an upper 200, e.g., corresponding to Region T shown in FIGS. 2A, 2B, and 2F).

Additionally or alternatively, larger printed segments 330 may provide added surface area on which one or more additional layers may be built (e.g., to provide a multi-tiered structure on the printed segments). Such multi-tiered structures may provide additional surfaces and/or edges for engaging a game ball (e.g., engaging the seams), e.g., to thereby provide increased coefficient of friction for that local area. Thus, larger printed segments 330 and/or multi-tiered printed segment 330 structures may be provided in the ball propelling region of an upper 200 (e.g., at least in a medial forefoot region and/or a medial midfoot region of an upper 200, such as area corresponding to Region T shown in FIGS. 2A and 2F).

Additionally or alternatively, printed segments 330 having larger cross-sectional areas may be used to provide an increased surface area, increased thickness, and/or increased volume of print media material 120 at that local area. The increased surface area, thickness, and/or volume may be used to produce and/or enhance the force damping effects described above (e.g., when the print media material 120 forming the web structure 302 has elastomeric properties). In the examples of FIGS. 3A-5C, the areas of the ball receiving zones of the illustrated uppers 200 (e.g., the area generally corresponding to Region S of FIGS. 2A and 2F) include printed segments 330 having larger cross-sectional areas than those provided at other areas of the upper 200. The larger sized printed segments 330 also may be used to produce the smaller openings 302O described above.

In some examples of this technology, at least some of the printed segments 330 in the medial midfoot region and the medial heel region (in the ball receiving Region R) may have an average cross-sectional area that is at least 25% larger than an average cross-sectional area of the printed segments 330 outside the medial midfoot region and the medial heel region (e.g., in regions corresponding to Regions T and/or U and/or outside of Regions S, T, and U shown in FIG. 2F).

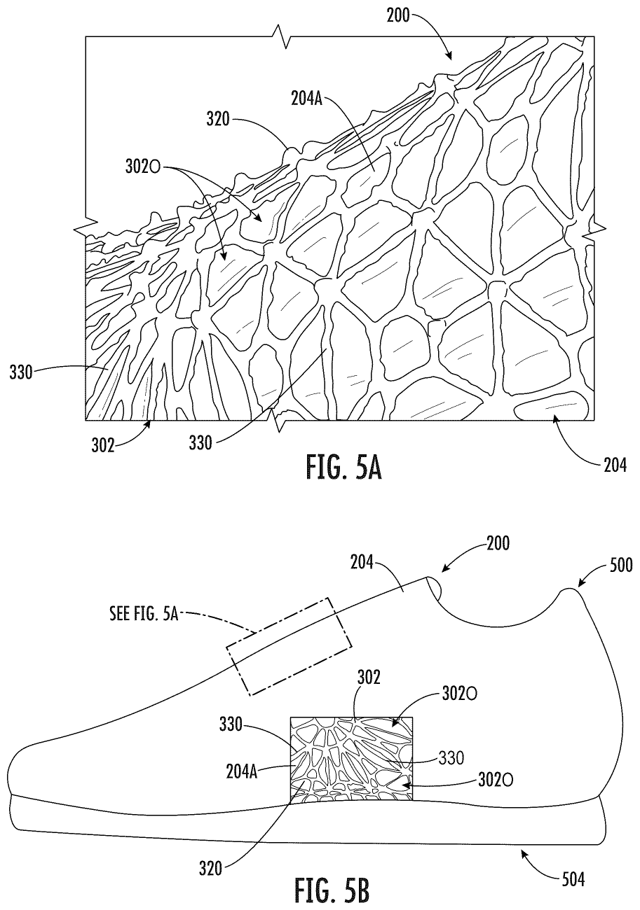

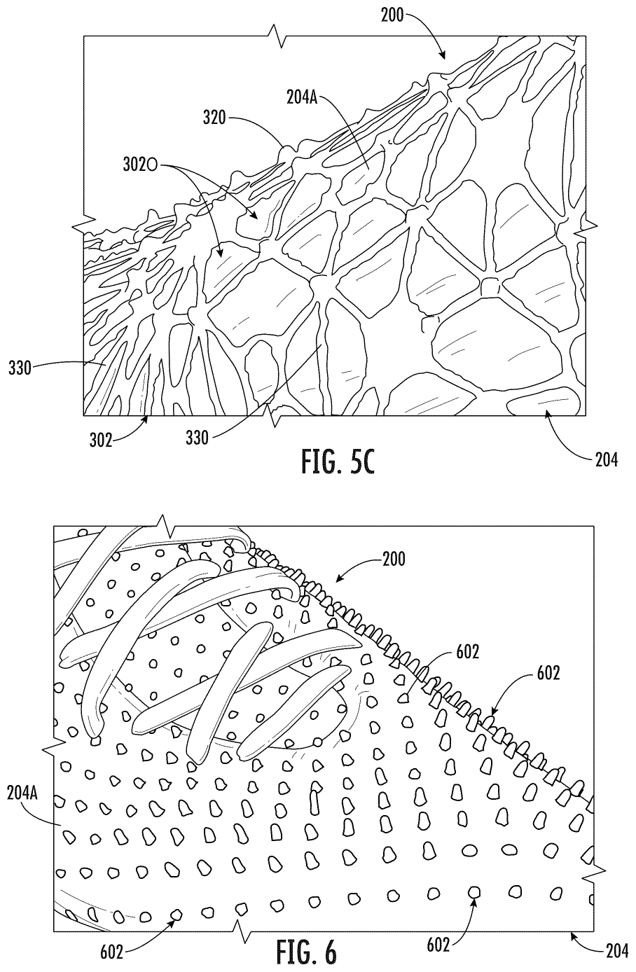

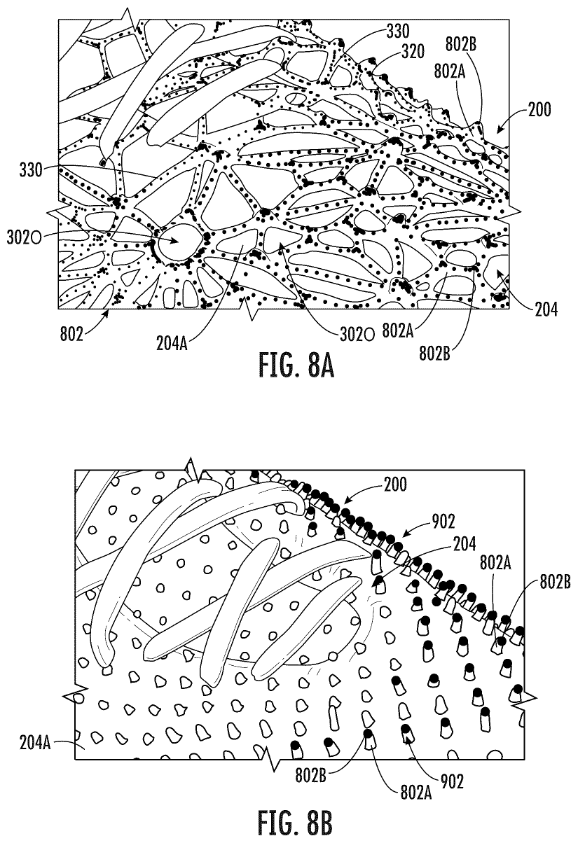

For at least some node elements 320 of a continuous web structure 302 of the types shown in FIGS. 3A-5C, an exposed surface of the printed node element 320 will extend in a direction away from the surface 204A of the upper base member 204 so as to protrude outward from the surface 204A beyond exposed surfaces of the printed segments 330 extending from that printed node element 320. In other words, at least some of the node elements 320 of a continuous web structure 302 will have a raised surface beyond the surfaces of the connected segments 330. Note, for example, FIG. 5A (and FIG. 8A discussed below). Such raised node element 320 surfaces may enhance the web structure 302's ability to interact with a game ball (e.g., to provide increased coefficient of friction, to better enable a user to apply spin to a game ball, to provide added thickness and/or force damping, etc.).

When raised, the raised portion of the node element 320 surface further may include one or more edges, texturing, and/or other features to further enhance its ability to interact with a game ball (e.g., to provide increased coefficient of friction, to better enable a user to apply spin to a game ball, etc.).

In some examples of this technology, at least 10% of the plurality of node elements 320 in the printed web structure 302 will have a raised structure. In other examples, at least 20%, at least 25%, at least 40%, at least 50%, at least 75%, or even at least 90% of the plurality of node elements 320 in a continuous web structure 302 will have a raised node structure, e.g., of the types described above.

Raised node element 320 regions of this type may be provided in various portions and/or proportions of a footwear upper 200 structure. As some more specific examples, in a continuous web structure 302, raised node elements 320 (e.g., of the types described above) may be provided in any one or more of: a medial heel upper region, a medial midfoot upper region, a medial forefoot upper region, a lateral forefoot upper region, a lateral midfoot upper region, a lateral heel upper region, an instep upper region, a forward toe upper region, a rear heel upper region, a medial side upper region, and/or a lateral side upper region of an upper base member 204. The raised area(s) of node elements 320 may have a variety of different shapes (e.g., cubic, hemispherical, hemi-elliptical, etc.).

Additionally, a continuous web structure 302 may extend into various portions and/or proportions of a footwear upper 200 structure. As some more specific examples, in a continuous web structure 302, the web structure 302 may extend continuously (via plural node elements 320 interconnected by segments 330) into and/or over any one or more of: a medial heel upper region, a medial midfoot upper region, a medial forefoot upper region, a lateral forefoot upper region, a lateral midfoot upper region, a lateral heel upper region, an instep upper region, a forward toe upper region, a rear heel upper region, a medial side upper region, and/or a lateral side upper region of an upper base member 204.

In the specific example of FIG. 3A, the illustrated web structure 302 is a continuous structure (one piece structure) that extends into and/or at least partially through: a medial heel upper region, a medial midfoot upper region, and a medial forefoot upper region of the upper base member 204. Note the outer perimeter extent illustrated in FIG. 3A. Example web structures 302 having an outer perimeter extent as shown in FIG. 3A may weigh less than 8 grams (and in some examples less than 6 grams). In the specific examples of FIGS. 4A-4C, the illustrated web structure 302 is a continuous structure (one piece structure) that extends into and/or at least partially through: a medial heel upper region, a medial midfoot upper region, a medial forefoot upper region, a lateral forefoot upper region, a lateral midfoot upper region, and a lateral heel upper region of the upper base member 204, but the web structure 302 does not extend into portions of the upper area of the lateral midfoot upper region (adjacent a lateral side of the top instep region of the upper base member 204) and/or into the upper area of the lateral heel upper region (adjacent a lateral side of the collar region of the upper base member 204). Note the outer perimeter extent illustrated in FIG. 4A. Example web structures 302 having an outer perimeter extent as shown in FIG. 4A may weigh less than 11 grams (and in some examples less than 9 grams). In the specific examples of FIGS. 5A-5C, that illustrated web structure 302 is a continuous structure (one piece structure) that extends into and/or throughout the entire upper base member 204 structure, i.e., into each of: a medial heel upper region, a medial midfoot upper region, a medial forefoot upper region, a lateral forefoot upper region, a lateral midfoot upper region, and a lateral heel upper region of the upper base member 204.

As evident from the above discussion of FIGS. 3A-5C, the aesthetic appearance of an upper 200 and/or web structures 302 provided an upper 200 can be varied widely. A wide range of other web structures 302 could be provided having materially different appearances. For example, the node elements 320 and/or printed segments 330 may be varied in size, shape, spacings, relative locations, and the like. Additionally or alternatively, the sizes, shapes, and/or locations of openings 302O may be varied widely. Still additionally or alternatively, more or fewer node elements 320 and/or segments 330 may be provided.

FIGS. 3A-5C provide some additional examples of potential changes in web structures 302. FIG. 3C1 provides a view similar to FIG. 3B1, but the web structure 302 of FIG. 3C1 has a different structure from that shown in FIG. 3B1. Specifically, in the web structure 302 of FIG. 3C1, some node elements 320 and/or printed segments 330 are removed (as compared to the web structure 302 of FIG. 3B1), resulting in some openings 302O that are larger than the corresponding features in FIG. 3B1. Additionally or alternatively, as also shown in FIG. 3C1, some openings have been filled in with print media material 120 as compared to corresponding locations in FIG. 3B1, thereby forming some larger printed surfaces (which may be considered larger node elements 320). FIG. 3C2 provides a view similar to FIG. 3B2, but the web structure 302 of FIG. 3C2 has a different structure from that shown in FIG. 3B2. Specifically, in the web structure 302 of FIG. 3C2, some node elements 320 and/or printed segments 330 are removed (as compared to the web structure 302 of FIG. 3B2), resulting in some openings 302O that are larger than the corresponding features in FIG. 3B2. Additionally or alternatively, as also shown in FIG. 3C2, some openings have been filled in with print media material 120 as compared to corresponding locations in FIG. 3B2, thereby forming some larger printed surfaces (which may be considered larger node elements 320). These types of structural changes (e.g., eliminating segments 330, changing opening 302O numbers and/or sizes, providing “nodes” having larger printed material 120 surfaces, etc.) may be used at other locations and/or additional locations in a web structure 302 to provide web structures 302 having many different appearances (while still providing the desired functionality).

In the web structure 302 of FIG. 4A, the noted areas may have web structures 302 corresponding to the structures shown in FIGS. 3B1, 3B2, 3C1, and/or 3C2. Alternatively, those areas may have different web structures from those shown in FIGS. 3B1, 3B2, 3C1, and/or 3C2.

The web structure 302 of the example of FIG. 4A extends to the lateral side of the upper 200. FIG. 4B illustrates a portion of the web structure 302 at the lateral side in one specific example web structure. As shown by a comparison of FIG. 4B with FIGS. 3B1, 3B2, 3C1, and 3C2, the web structure 302 at the lateral side area of FIG. 4B generally has smaller node elements 320, smaller segments 330 (e.g., in transverse cross-sectional area through the segments 330), and larger openings 302O than those shown on the medial side. Thus, the lateral side of the example web structure 302 of FIG. 4A includes: (i) node elements 320 and segments 330 with smaller areas (e.g., transverse cross-sectional areas through segments 330) as compared to those on the medial side and/or (ii) openings 302O having larger enclosed areas as compared to those on the medial side.

FIG. 4C provides a view similar to FIG. 4B, but the web structure 302 of FIG. 4C has a different structure from that shown in FIG. 4B. Specifically, in the web structure 302 of FIG. 4C, some node elements 320 and/or printed segments 330 are removed (as compared to the web structure 302 of FIG. 4B), resulting in some openings 302O that are larger than the corresponding features in FIG. 4B. Additionally or alternatively, as also shown in FIG. 4C, some openings have been filled in with print media material 120 as compared to corresponding locations in FIG. 4B, thereby forming some larger printed surfaces (which may be considered larger node elements 320). These types of structural changes (e.g., eliminating segments 330, changing opening 302O numbers and/or sizes, providing “nodes” having larger printed material 120 surfaces, etc.) may be used at other locations and/or additional locations in a web structure 302 to provide web structures 302 having many different appearances (while still providing the desired functionality).

FIGS. 5A and 5B illustrate portions of another example web structure 302 that may be incorporated in an article of footwear 500. FIG. 5A illustrates a portion of the web structure 302 at the medial instep region (e.g., from the area shown in FIG. 5B). While a web structure having the features shown in FIGS. 5A and 5B may extend over any portion or proportion of an upper 200, in the specific example of FIGS. 5A and 5B, the web structure 302 extends to cover at least 90% of the overall exterior surface of the upper 200 (i.e., the web structure 302 extends so that an outer extent of its structure overlays an area corresponding to at least 90% of the overall exterior surface area of the upper 200).

FIG. 5C provides a view similar to FIG. 5A, but the web structure 302 of FIG. 5C has a different structure from that shown in FIG. 5A. Specifically, in the web structure 302 of FIG. 5C, some node elements 320 and/or printed segments 330 are removed (as compared to the web structure 302 of FIG. 5A), resulting in some openings 302O that are larger than the corresponding features in FIG. 5A. Additionally or alternatively, as also shown in FIG. 5C, some openings have been filled in with print media material 120 as compared to corresponding locations in FIG. 5A, thereby forming some larger printed surfaces (which may be considered larger node elements 320). These types of structural changes (e.g., eliminating segments 330, changing opening 302O numbers and/or sizes, providing “nodes” having larger printed material 120 surfaces, etc.) may be used at other locations and/or additional locations in a web structure 302 to provide web structures 302 having many different appearances (while still providing the desired functionality).

As further shown in the view of FIG. 5B, uppers 200 of the types described herein may be engaged with a sole structure 504, to thereby form an article of footwear 500. Any type of sole structure 504 may be provided, and thus, FIG. 5B shows a generic sole structure 504 (and/or illustrate the sole structure schematically). As some more specific examples, the sole structures 504 may be provided with features for specific athletic events, such as sole structures 504 for soccer, football, etc. As some additional or alternative examples, the sole structure 504 may be cleated, may include one or more traction elements designed for use on artificial turf, may include one or more traction elements designed for use in indoor fields/courts, etc. The upper 200 may be engaged with the sole structure 504 in any manner, including through the use of adhesives, mechanical connectors, sewing or stitching, etc., including in manners conventionally known and used in the footwear arts.

FIG. 5B illustrates a portion of web structure 302 at an area corresponding to a portion of Region R shown in FIGS. 2A and 2F. As shown, the upper 200 and web structure 502 wrap around the side edge of the footwear 500 (e.g., at one or more of a medial midfoot region, a medial heel region, and/or a medial forefoot region) such that a portion of the web structure 502 will extend to an area beneath the wearer's foot. While FIG. 5B shows a web structure 302 wrapping the edge to the bottom of the article of footwear 500, other printed element structures may be located and/or wrap an edge of an article of footwear 500 in a similar manner, including printed element structures of any of the types or forms shown in FIGS. 2A-10. The sole structure 504 may be sized and/or shaped to allow the printed elements at the bottom of the footwear 500 structure to be exposed in the final footwear 500 product (e.g., so that those bottom printed elements are available to contact a game ball in use).

Any of the upper base members 204 and/or uppers 200 described above (and those described below) may be engaged with a sole structure 504 and/or incorporated into an article of footwear 500, e.g., in the same or similar manners to those described above in conjunction with FIG. 5B.

FIG. 6 shows an additional example of a footwear upper 200 that includes printed elements thereon in accordance with some examples of this technology. In this illustrated example, the printed elements are formed as discrete printed protrusions 602. More specifically, this example footwear upper 200 includes: (a) an upper base member 204 (formed from one or more upper component parts) having a major surface 204A (e.g., an exterior surface); and (b) a plurality of discrete printed protrusions 602 fixed to and extending outward from the surface 204A. In some examples of this technology, at least 10% (and in some examples, at least 25%, at least 50%, at least 75%, at least 90%, and/or optionally all) of the individual discrete printed protrusions 602 provided on the upper base member 204 define a volume of less than 150 mm³. In at least some examples, the individual printed protrusions 602 (in any of the above amounts and/or ranges) may define a volume of less than 125 mm³, less than 100 mm³, less than 80 mm³, less than 60 mm³, or less than 40 mm³.

The upper base member 204 in the example of FIG. 6 may have any of the features of substrate 104 described above in conjunction with FIGS. 1A and 1, and/or the upper base member surface 204A may include any of the features of surface 104A described above in conjunction with FIGS. 1A and 1B.

Additionally or alternatively, the printed protrusions 602 of FIG. 6 may have any of the features of printed elements 102 described above in conjunction with FIGS. 1A and 1B, may be formed by any of the methods described above (e.g., in conjunction with FIGS. 1A and 1), and/or may be formed from any of the print media materials 120 described above in conjunction with FIGS. 1A and 1B.

In at least some examples of uppers 200 of the type shown in FIG. 6, at least 10% (and in some examples, at least 25%, at least 50%, at least 75%, at least 90%, and/or optionally all) of the discrete printed protrusions 602 provided on the upper base member 204 will be spaced apart from one or more adjacent printed protrusions 602 (and spaced apart at least from its nearest neighbor printed protrusions 602) by a distance of less than 30 mm, and in some examples, by a distance of less than 25 mm, less than 20 mm, less than 15 mm, less than 12 mm, less than 10 mm, or less than 8 mm. The spacing may vary in different areas of an upper 200.

Additionally or alternatively, in at least some examples of uppers 200 of the type shown in FIG. 6, at least 10% (and in some examples, at least 25%, at least 50%, at least 75%, at least 90%, and/or optionally all) of the discrete printed protrusions 602 provided on the upper base member 204 will define: (i) a largest base dimension D of the discrete printed protrusion 602 located at the surface 204A of the upper base member 204, (ii) a height dimension H from the surface 204A to an outermost free end of the discrete printed protrusion 602, and (iii) an aspect ratio H/D of at least 1 (and in some examples, at least 1.25, at least 1.5, at least 1.75, at least 2, at least 2.25, or at least 2.5). In some examples, the base dimension D will be a largest diagonal or diameter dimension of the discrete printed protrusion 602 located at the surface 204A, and it may be within a range of 1 mm to 10 mm, and in some examples, within a range of 1.25 mm to 8 mm, within a range of 1.5 mm to 8 mm, within a range of 1.25 mm to 6 mm, within a range of 1.5 mm to 6 mm, within a range of 1.75 mm to 6 mm, or within a range of 1.75 mm to 5 mm. Additionally or alternatively, in some examples, the height dimension H may be within a range of 1 mm to 10 mm, and in some examples, within a range of 1.25 mm to 8 mm, within a range of 1.5 mm to 8 mm, within a range of 1.25 mm to 6 mm, within a range of 1.5 mm to 6 mm, within a range of 1.75 mm to 6 mm, or within a range of 1.75 mm to 5 mm.

Protrusions 602 of the types shown in FIG. 6 may be provided in various portions and/or proportions of a footwear upper 200 structure. As some more specific examples, protrusions 602 of the type described above may be dispersed within and/or throughout any one or more of: a medial heel upper region, a medial midfoot upper region, a medial forefoot upper region, a lateral forefoot upper region, a lateral midfoot upper region, a lateral heel upper region, an instep upper region, a forward toe upper region, a rear heel upper region, a medial side upper region, and/or a lateral side upper region of an upper base member 204. While FIG. 6 shows only a portion of an instep region of a footwear upper 200, protrusions 602 in the example of FIG. 6 may be dispersed over at least 90% of the upper 200 surface.

In the illustrated example of FIG. 6, the protrusions 602 may be more densely packed in areas of the ball receiving zone (e.g., corresponding to Regions R and/or S shown in FIGS. 2A and 2F), at least compared to some other areas of the upper 200. Greater protrusion 602 packing density in this general area can enhance features of the force damping effects provided by the upper 200 of FIG. 6. Additionally or alternatively, the protrusions 602 may be more densely packed in areas of the ball propelling zone (e.g., corresponding to Region T shown in FIGS. 2A and 2F), at least compared to some other areas of the upper 200. Greater protrusion 602 packing density in this general area can enhance features of the coefficient of friction with respect to a game ball surface (e.g., when the ball is being kicked) and/or spin inducing features of the upper 200 of FIG. 6.

Additionally or alternatively, the protrusions 602 in one area may have different materials and/or compositions from those in other areas, e.g., to provide desired properties at local areas (e.g., to provide properties as described herein for a ball receiving region, to provide properties as described herein for a ball propelling region, etc.).

As illustrated in FIG. 6, at least some of the protrusions 602 may be relatively small as compared to an overall size and/or surface area of the upper 200. Thus, several discrete protrusions 602 having any of the features and/or characteristics described above may be provided on a single upper base member 204. As some more specific examples, an upper base member 204 may include at least 50 discrete protrusions 602, and in some examples, at least 75, at least 100, at least 150, at least 200, at least 250, at least 300, or at least 500 discrete protrusions 602 (having any of the features and/or characteristics described above).

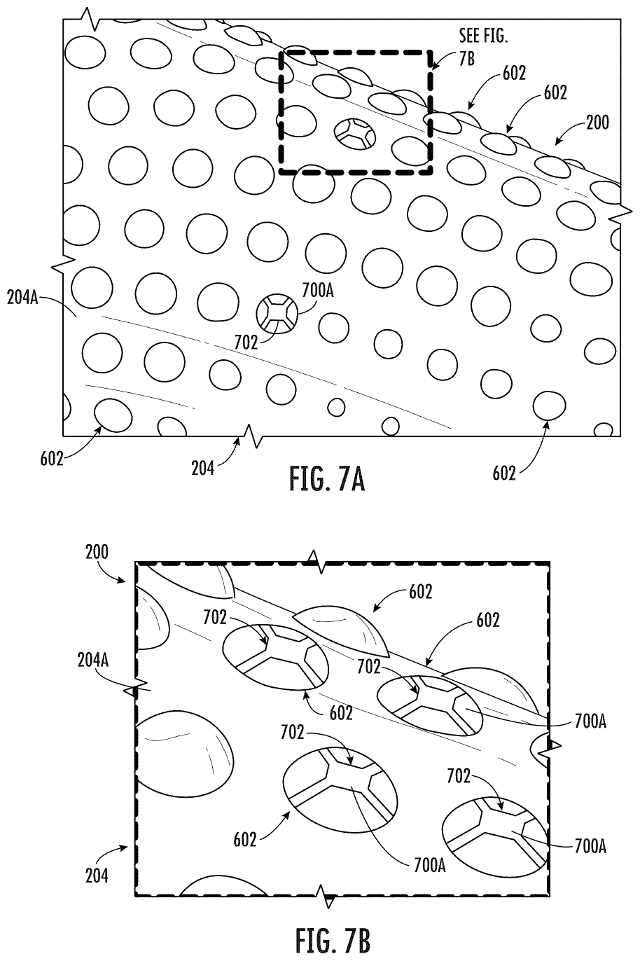

FIGS. 7A and 7B illustrate an upper 200 and article of footwear 500 having discrete protrusions 602 with different features from those shown in FIG. 6. The example of FIGS. 7A-7B shows more variation in sizing of individual protrusions 602 over the area of the upper 200, as compared to the example of FIG. 6. At least some of the protrusions 602 of FIGS. 7A-7B are larger in base area but with a lower aspect ratio as compared to the protrusions 602 of FIG. 6. Also, the protrusions 602 of FIGS. 7A-7B are more “dome” shaped, as compared to the more cylindrical shaped protrusions 602 shown in FIG. 6.

In at least some examples of uppers 200 of the types shown in FIGS. 7A-7B, at least 10% (and in some examples, at least 25%, at least 50%, at least 75%, at least 90%, and/or optionally all) of the discrete printed protrusions 602 provided on the upper base member 204 will be spaced apart from one or more adjacent printed protrusions 602 (and spaced apart at least from its nearest neighbor printed protrusions 602) by a distance of less than 30 mm, and in some examples, by a distance of less than 25 mm, less than 20 mm, less than 15 mm, less than 12 mm, less than 10 mm, or less than 8 mm. The spacing may vary over the surface of the upper 200, as shown in FIGS. 7A and 7B.

Additionally or alternatively, in at least some examples of uppers 200 of the types shown in FIGS. 7A-7B, at least 10% (and in some examples, at least 25%, at least 50%, at least 75%, at least 90%, and/or optionally all) of the discrete printed protrusions 602 provided on the upper base member 204 will define: (i) a largest base dimension D of the discrete printed protrusion 602 located at the surface 204A of the upper base member 204, (ii) a height dimension H from the surface 204A to an outermost free end of the discrete printed protrusion 602, and (iii) an aspect ratio H/D of at least 0.25 (and in some examples, at least 0.5, at least 0.75, or at least 1). In some examples, the base dimension D will be a largest diagonal or diameter dimension of the discrete protrusion 602 located at the surface 204A, and it may be within a range of 1 mm to 10 mm, and in some examples, within a range of 1.25 mm to 8 mm, within a range of 1.5 mm to 8 mm, within a range of 1.25 mm to 6 mm, within a range of 1.5 mm to 6 mm, within a range of 1.75 mm to 6 mm, or within a range of 1.75 mm to 5 mm. Additionally or alternatively, in some examples, the height dimension H may be within a range of 1 mm to 10 mm, and in some examples, within a range of 1.25 mm to 8 mm, within a range of 1.5 mm to 8 mm, within a range of 1.25 mm to 6 mm, within a range of 1.5 mm to 6 mm, within a range of 1.75 mm to 6 mm, or within a range of 1.75 mm to 5 mm.

Protrusions 602 of the types shown in FIGS. 7A-7B may be provided in various portions and/or proportions of a footwear upper 200 structure. As some more specific examples, protrusions 602 of the types described above may be dispersed within and/or throughout any one or more of: a medial heel upper region, a medial midfoot upper region, a medial forefoot upper region, a lateral forefoot upper region, a lateral midfoot upper region, a lateral heel upper region, an instep upper region, a forward toe upper region, a rear heel upper region, a medial side upper region, and/or a lateral side upper region of an upper base member 204. The specific upper 200 and footwear shown in FIGS. 7A-7B may include an upper 200 with protrusions 602 provided throughout the upper surface 204A (e.g., dispersed over at least 90% of the upper surface 204A).

In the example upper 200 of FIGS. 7A-7B, the protrusions 602 may be more densely packed in areas of the ball receiving zone (e.g., corresponding to Regions R and/or S shown in FIGS. 2A and 2F), at least compared to some other areas of the upper 200. Greater protrusion 602 packing density in this general area can enhance features of the force damping effects provided by the upper 200 of FIGS. 7A-7B. Additionally or alternatively, the protrusions 602 may be more densely packed in areas of the ball propelling zone (e.g., corresponding to Region T shown in FIGS. 2A and 2F), at least compared to some other areas of the upper 200. Greater protrusion 602 packing density in this general area can enhance features of the coefficient of friction with respect to a game ball surface (e.g., when the ball is being kicked) and/or spin inducing features of the upper 200 of FIGS. 7A-7B.

Additionally or alternatively, the protrusions 602 in one area may have different materials and/or compositions from those in other areas, e.g., to provide desired properties at local areas (e.g., to provide properties as described herein for a ball receiving region, to provide properties as described herein for a ball propelling regions, etc.).

As illustrated in FIGS. 7A-7B, at least some of the protrusions 602 may be relatively small as compared to an overall size and/or surface area of the upper 200. Thus, several discrete protrusions 602 having any of the features and/or characteristics described above may be provided on a single upper base member 204. As some more specific examples, an upper base member 204 may include at least 50 discrete protrusions 602, and in some examples, at least 75, at least 100, at least 150, at least 200, at least 250, at least 300, or at least 400 discrete protrusions 602 (having any of the features and/or characteristics described above).

FIGS. 7A-7B show additional features of protrusions 602 that may be included in at least some example uppers 200 in accordance with this technology. As shown in FIG. 7B (which is an enlarged view of a region of the upper 200 shown in FIG. 7A), one or more of the protrusions 602 may be formed such that its exposed exterior surface 700A includes one or more edge elements 702. Additionally or alternatively, the exposed exterior surface 700A may include texturing. The edge elements 702 and/or texturing, when present, may provide additional surface area and/or edges to engage a surface of a game ball (e.g., at its seams), to help increase the coefficient of friction and/or spin inducing properties of the upper 200, etc. Thus, in at least some examples of this technology, one or more protrusions 602 with edge elements 702 and/or texturing on its/their exterior surface 700A may be located at least in a ball propelling region of an upper (e.g., corresponding to Region T in FIGS. 2A and 2F).

Additionally or alternatively, the surface 700A features (e.g., edge elements 702 and/or texturing) may provide enhanced aerodynamics for the footwear and/or other article (e.g., article of apparel) on which the protrusions 602 are provided. For example, the surface 700A features (e.g., edge elements 702, texturing, etc.) may increase turbulence in air flow over the substrate.

Edge elements 702 and/or texturing of this type may be provided on at least one protrusion 602, as noted above. In some examples, at least 10% (and in some examples, at least 25%, at least 50%, at least 75%, at least 90%, or even all) of the protrusions 602 may include these types of edge element 702 and/or texturing features. Additionally or alternatively, one or more protrusions 602 on an upper 200 may include two or more edge elements 702 of the types described above.

As evident from the above discussion, the aesthetic appearance of an upper 200 and/or discrete protrusions 602 provided thereon can be varied widely, e.g., by one or more of: changing the shape(s) of one or more protrusion 602 bases (e.g., making them square, rectangular, triangular, other polygons, etc.); changing the size(s) of one or more protrusion 602 bases; making the protrusions 602 more tightly packed in one or more regions; making the protrusions 602 less tightly packed in one or more regions; separating groups of protrusions 602 into discrete zones on the surface 204A of the upper base member 204; spacing zones of protrusions 602 from one another; adding additional protrusions 602; providing combinations of protrusions 602 with different sizes and/or shapes; and/or removing one or more protrusions 602 and/or groups of protrusions 602. These and/or other types of variations may be used in specific upper 200 constructions while providing the desired functionality.

FIGS. 8A and 8B illustrate additional or alternative features that may be provided in printed structures 102 in accordance with at least some examples of this technology. FIG. 8A shows an example footwear upper 200 having a printed web structure 802 on the surface 204A thereof. The printed web structure 802 may have any of the features (sizes, shapes, materials, variations thereof, etc.) of the web structures 302 described above in conjunction with FIGS. 3A-5C, including, for example, any of the features of node elements 320, segments 330, and/or openings 302O described above in conjunction with FIGS. 3A-5C.

FIG. 8B shows an example footwear upper 200 having discrete printed elements 902 on the surface 204A thereof. While the specific example of FIG. 8B shows discrete printed elements 902 most closely resembling the discrete printed elements 602 of FIG. 6, aspects of the variations described herein with respect to FIGS. 8A and 8B may be applied to the discrete printed elements 202, 202A, 202B, 202C, 202D, 202E of FIGS. 2A-2M and/or to the discrete printed edge elements 702 of FIGS. 7A-7B as well. Thus, the discrete printed elements 902 may have any of the features (sizes, shapes, materials, variations thereof, etc.) of the printed elements 202, 202A, 202B, 202C, 202D, 202E, 602, and/or 702 described above.

The examples of FIGS. 8A and 8B show printed structures 802 and printed elements 902 having a multi-material structure. In the specific example of FIG. 8A, at least some of the node elements 320 of the web structure 802 include: (a) a first material 802A having a first composition (e.g., fixed to the upper base member 204) and (b) a second material 802B having a second composition that differs from the first composition (e.g., built up from or fixed to the first material 802A). Additionally or alternatively, in the specific example of FIG. 8A, at least some of the printed segments 330 of the web structure 802 include: (a) a first material 802A having a first composition (e.g., fixed to the upper base member 204) and (b) a second material 802B having a second composition that differs from the first composition (e.g., built up from or fixed to the first material 802A). In FIG. 8A, the first material 802A is shown in a light color and the second material 802B is shown as a darker color. While FIG. 8A shows the second material 802B applied in discontinuous, spaced apart dots, other features could be provided, such as continuous lines or line segments of the second material 802B; larger dots, lines, or line segments of the second material 802B; more or less of the web structure 802 covered by the second material 802B; second material 802B making up one or more complete node elements 320 and/or segments 330; etc.

In the specific example of FIG. 8B, at least some of the discrete printed elements 902 (e.g., protrusions) include: (a) a first material 802A having a first composition (e.g., fixed to the upper base member 204) and (b) a second material 802B having a second composition that differs from the first composition (e.g., built up from or fixed to the first material 802A). In FIG. 8B, the first material 802A is shown in a light color and the second material 802B is shown as a darker color. While FIG. 8B shows the second material 802B applied in a single end part on a protrusion base formed from the first material 802A, other features could be provided, such as two or more regions of second material 802B on an exposed surface of a single protrusion; second material 802B forming at least exposed edge element(s) 702 on a protrusions surface; second material 802B making up a greater proportion of one or more discrete printed elements 902; second material 802B on a greater or lesser proportion of the discrete printed elements 902; second material 802B making up one or more complete printed element 902 protrusion; etc.

Use of two (or more) different materials in a printed structure 102 can provide various features or advantages. For example, the first material 802A may have a different color than the second material 802B. Thus, the two compositions may differ at least in the pigments provided in the two materials. Such features can expand the color palette for designers and allow one to create different aesthetic designs.

Additionally or alternatively, the two compositions may differ in their physical properties. As a more specific example, the first material 802A may be selected to provide enhanced engagement with the surface 204A of the upper base member 204 (e.g., via chemical bonding, adhesion, and/or other fixing mechanisms). Additionally or alternatively, the second material 802B may be selected to provide other features, such as increased durability, increased “grip” (e.g., coefficient of friction with respect to a game ball surface), increased hardness, etc.

Two material composition printed elements may be provided at various different areas and/or different regions of an upper 200. For example, two material web structures 802 and/or two material printed element 902 structures 902 (e.g., two material discrete protrusions) may be provided in any one or more of: a medial heel upper region, a lateral heel upper region, a medial midfoot upper region, a lateral midfoot upper region, a medial forefoot upper region, a lateral forefoot upper region, a rear heel upper region, a forward toe upper region, an instep upper region, a collar upper region, a medial side upper region, and/or a lateral side upper region of the footwear upper 200.

Additionally or alternatively, two material composition printed elements may be provided over different portions and/or proportions of an overall surface area of a printed element (e.g., on web structures 802 and/or printed element 902 protrusion structures). As some more specific examples, at least 5% (and in some examples, at least 10%, at least 25%, at least 50%, at least 75%, at least 90%, or even all) of a web structure 802 on an upper 200 may include two material composition features. As another example, at least 5% (and in some examples, at least 10%, at least 25%, at least 50%, at least 75%, at least 90%, or even all) of the discrete printed elements 902 (e.g., protrusions) on an upper 200 may include two material composition features. Thus, several variations in the two composition structures are possible in different specific examples of this technology.

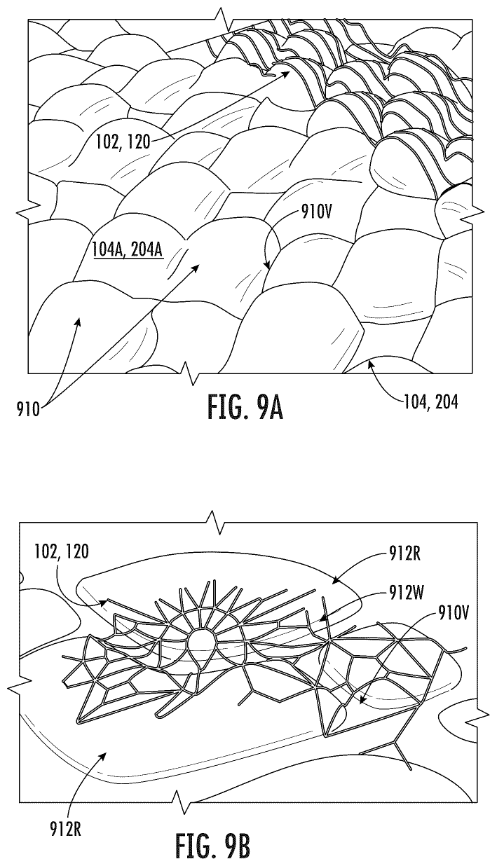

Additional aspects of at least some examples of this technology will be described below in conjunction with FIGS. 1A, 9A, and 9B. As described above, the print media material 120 useful in accordance with jetting systems 100 in at least some examples of this technology may comprise an aqueous polyether polyurethane dispersion having: (a) a high solids content (e.g., at least 40% solids, and in some examples, at least 45% solids, at least 50% solids, at least 55% solids, between 40% and 70% solids, between 45% and 68% solids, between 50% and 68% solids, between 55% and 68% solids, between 55% and 62% solids, or between 60% and 68% solids) and (b) a viscosity of at least 80,000 centipoise (and in some examples, at least 85,000 centipoise, at least 90,000 centipoise, within a range of 80,000 to 190,000 centipoise, within a range of 85,000 to 160,000 centipoise, within a range of 90,000 to 150,000 centipoise, within a range of 95,000 to 140,000 centipoise, or within a range of 100,000 to 135,000 centipoise). The high solids content and/or high viscosity features allow the print media material 120 “droplets” to be jetted a relatively long “throw distance” 140 (see FIG. 1A) in the Z-direction. The “throw distance,” as used herein, corresponds to the distance from the nozzle 110 to the incident location on the surface 104A or on previously deposited print media material 120. Additionally or alternatively, the high solids content and/or high viscosity allows the print media material 120 to form printed structures 102 having high aspect ratio features, e.g., within the ranges described above (e.g., with an aspect ratio of at least 1, and in some examples, at least 1.25, at least 1.5, at least 1.75, at least 2, at least 2.5, or at least 3) and/or fin type structures.

The throw distance 140 may vary over the course of a printing process. As some more specific examples, the throw distance 140 may be at least 5 mm, and in some examples, at least 10 mm, at least 15 mm, from 15 mm to 40 mm, from 15 mm to 35 mm, from 15 mm to 30 mm or from 20 mm to 30 mm.

Jetting methods in accordance with at least some examples of this technology may include: (a) placing a textile component or other substrate 104 (e.g., any of the substrate 104 components, such as upper base member 204, described above) on a print bed 106 of a jetting system 100 so that a surface 104A, 204A of the substrate (e.g., a textile component) faces a print media ejection nozzle 110 of the jetting system 100; (b) dispensing print media material 120 from the print media ejection nozzle 110 to the surface 104A, 204A (e.g., as droplets); and (c) moving the print media ejection nozzle 110 with respect to the print bed 106 to thereby form one or more printed elements 102 on the surface 104A, 204A. The substrate 104 shown in FIGS. 9A and 9B may comprise a textile material, a leather material (e.g., synthetic leather), a film material (optionally on an underlying base layer, such as a textile layer), a molded plastic component, a foam material, and/or other materials. Any of these substrates 104 (such as upper base member 204) may have a non-planar surface, e.g., of the types described herein with respect to FIGS. 9A and 9B.

In some examples of this technology, as shown in FIGS. 9A and 9B, the surface 104A, 204A of a substrate 104 (e.g., a textile component as an upper base member 204) on which printing is to take place may be non-planar. As some more specific examples, the surface 104A, 204A of the substrate 104 (such as upper base member 204) on which printing is to take place may vary in its thickness dimension by more than 1 mm (and in some examples, by more than 2 mm, by more than 5 mm, by more than 8 mm, by more than 12 mm, etc.). This variance in thickness may be observed at relatively closely spaced regions of the substrate 104 (e.g., upper base member 204). For example, the substrate 104 (e.g., upper base member 204) thickness may vary by at least 3 mm between a first location and a second location located within 5 mm of one another). Thus, in some examples, the distance that the print media material 120 must be “thrown” will vary by at least 1 mm (and in some examples, by at least 2 mm, by at least 3 mm, by at least 5 mm, by at least 8 mm, by at least 12 mm, etc.) between the first location and the second location located within 5 mm of one another, unless the Z-dimension distance between the nozzle 110 and the print bed 106 is varied by moving the print nozzle 110 with respect to the print bed 106 in the Z direction to maintain a more constant throw distance. Varying the Z-distance in this manner, however, can be complex, particularly if the surface on which printing is to take place has irregular surface contours or variations.

The example of FIG. 9A shows a substrate 104 (e.g., a textile component, such as an upper base member 204) having its surface 104A, 204A where print is to be applied as a series of dome structures 910 providing raised regions separated by valley regions 910V. This substrate 104 (e.g., upper base member 204) may have a quilted structure (or at least an appearance akin to a quilted structure). In the example of FIG. 9B, the substrate 104 (e.g., upper base member, 204) includes a plurality of spaced apart raised regions 912R separated from one another by a valley region 910V. In at least some specific examples of this technology, a resilient material (e.g., a foam material, an elastomeric material, a rubber material, etc.) may underlie dome structures 910 and/or one or more of the raised regions 912R and/or the dome structures 910 and/or one or more raised regions 912R themselves may be made of resilient material(s).

Sidewalls 912W of the raised regions 912R may extend from a top or exposed surface of the raised regions 912R to the valley regions 910V. In some examples of this technology, the valley regions 910V may include an exposed surface having a width dimension of at least 1 mm extending between and separating the sidewall 912W of one raised region 912R from the sidewall 912W of an adjacent raised region 912R (and in some examples, the width dimension in at least some areas of the surface 104A, 204A may be at least 1.5 mm, at least 2 mm, at least 4 mm, at least 5 mm, or at least 8 mm). Additionally or alternatively, a height dimension of the raised region(s) 912R (from the surface of the valley region 910V to an exposed top surface of the raised region 912R) may be at least 1 mm, and in some examples, at least 1.5 mm, at least 2 mm, at least 4 mm, at least 5 mm, or at least 8 mm.

As further shown in FIGS. 9A and 9B, in jetting processes in accordance with at least some examples of this technology, one or more continuous printed elements 102 will be formed on the surface 104A, 204A of the textile substrate 104 component (e.g., upper base member 204). The one or more continuous printed elements 102 may extend continuously such that one or more continuous segments: (a) extend from one dome structure 910 to at least one adjacent dome structure 910 through the valley region 910V (see FIG. 9A), and/or (b) extend from one raised region 912R, through the valley region 910V, and to at least one adjacent raised region 912R, including print media material 120 deposited on (and optionally extending continuously along) the sidewalls 912W of the raised regions 912R and on the valley region 910V. The sidewall(s) 912W may be sloped between the valley region 910V surface and the top surface of the raised region(s) 912R.

Alternatively, in some examples of this technology, the valley region 910V may not include a significant width dimension. For example, in the dome structures 910 of FIG. 9A, the valley region 910V between two adjacent dome structures 910 in at least some of the surface 104A, 204A may comprise a low point between the sidewalls of the dome structures 910. At least in the dome structures 910, the sidewalls may be curved (as shown in FIG. 9A).

The continuous printed elements 102 of FIGS. 9A and/or 9B may form all or part of a continuous web structure, e.g., of the types described above in conjunction with FIGS. 3A-5C and 8A, or they may comprise printed structures 102 of other shapes and/or constructions.

Additionally or alternatively, in some examples of this technology, the substrate 104 (e.g., upper base member 204) on which printed structures 102 are formed may comprise two separate components, and the printed structures 102 may be formed on both substrates 104 (e.g., both upper base member 204 components). In some examples, a continuous segment of printed structure 102 may bridge the junction between the two separate components. Thus, in the example of FIG. 9A, one dome 910 may be part of a first substrate 104 (e.g., a first upper base member 204 component), another dome 910 may be part of another, separate substrate 104 (e.g., another upper base member 204 component), and a continuous printed structure 102 and/or a continuous segment of print media material 120 may extend between and span a junction between the two separate substrates 104 (e.g., the two separate upper base member 204 components, e.g., through the valley region 910V. In the example of FIGS. 9B, one raised region 912R may be part of a first substrate 104 (e.g., a first upper base member 204 component), another raised region 912R may be part of another, separate substrate 104 (e.g., a second upper base member 204 component), and a continuous printed structure 102 and/or a continuous segment of print media material 120 may extend between and span a junction between the two separate substrates (e.g., the valley region 910V may represent a joint or interface between the two substrates 104 (e.g., the two upper base member 204 components)).

Advantageously, in accordance with at least some examples of this technology, the jetting process may take place without the need to alter the spacing distance (the Z-distance) between the nozzle 110 and the print bed 106. Because the substrate 104 (e.g., the upper base member 204) of the examples of FIGS. 9A and 9B are non-planar, however, the throw distance 140 will vary over the course of the jetting process (e.g., as the nozzle 110 moves with respect to the surface 104A, 204A of the substrate 104 (e.g., upper base member 204)). As some more specific examples, a distance from the nozzle 110 to the surface 104A, 204A of the substrate 104 (e.g., upper base member 204) may vary, e.g., by an amount found within a range extending from 15 mm and 35 mm (and in some examples, within a range from 20 mm and 30 mm), even when printing continuous structures, such as printed lines or segments. In other words, even though distance from the print nozzle 110 to the print bed 106 (in the Z direction) may not vary during a jetting process, the distance that the print media material 120 may travel in the Z direction to reach the substrate surface 104A, 204A or previously deposited print media material 120 (the “throw” distance 140) may vary, e.g., within the ranges identified above, at least in part due to contours on the surface 104A, 204A. But, due to the high solids content and/or the high viscosity of the print media material 120 being dispensed by the nozzle 110 in accordance with at least some examples of this technology, such variance in the distance print media material 120 may need to travel during a jetting process will not adversely impact the jetting process and/or the resulting printed structures 102. These features can simplify the jetting process in accordance with at least some examples of this technology because the Z direction dimension between the print head 108 and the print bed 106 does not need to be adjusted.

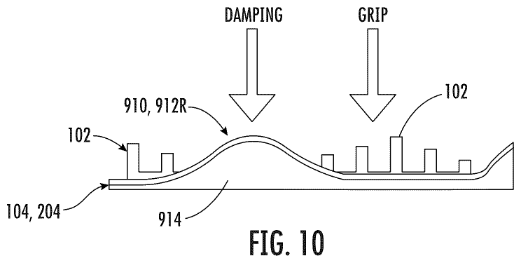

Additional aspects of some example features of this technology are described below in conjunction with FIG. 10. As described above, some examples of this technology may be useful to provide (i) impact force dampening properties (e.g., to help reduce the rebound of a game ball and/or help maintain ball control) and (ii) “grip” or coefficient of friction enhancing properties (e.g., to enable application of spin to a game ball). Features of the printed structures (e.g., 102, 202, 202A-202E, 302, 602, 802, 902) may provide and/or enhance these features, as described above.

Additionally or alternatively, in at least some examples of this technology, features of the substrate 104 (e.g., upper base member 204) also may be used to enhance at least some of these properties. As a more specific example, as shown in FIG. 10, the substrate 104 (e.g., the textile components of upper base member 204 or other substrates 104 as described in conjunction with FIGS. 9A and/or 9B) may be more resilient in the dome structures 910 and/or raised region(s) 912R. For example, as noted above, the dome structures 910 and/or raised region(s) 912R may be formed from and/or include an underlying resilient material 914, such as a foam material, an elastomeric material, a rubber material, etc. This resilient material 914 may provide at least some of the force damping properties of the substrate 104 (e.g., upper base member 204). Printed structures 102 (e.g., 102, 202, 202A-202E, 302, 602, 802, 902) of the types described above may be provided on, near, and/or around the resilient material 914 area to provide the “grip” and/or improved coefficient of friction features. The printed structures 102 also may provide some force damping properties (e.g., if made from an elastomeric material).

As described above, substrates 104 with printed structures 102 thereon in accordance with examples of this technology may provide enhanced coefficient of friction, e.g., as compared to the substrate 104 without the printed structures 102 thereon. In some examples, substrates 104 with printed structures 102 thereon may have a coefficient of friction with respect to material of a game ball surface (e.g., a soccer ball surface material) that is at least 50% higher than the coefficient of friction of the surface 104A of the substrate 104 along (without the printed structures 102 thereon), and in some examples, at least 90% higher, at least 100% higher, at least 120% higher, at least 150% higher, at least 200% higher, or even at least 300% higher.

As some additional examples, in a “dry” test (with dry substrates 104 and dry test material (e.g., soccer ball material), substrates 104 with printed structures 102 thereon may have a static coefficient of friction with respect to material of a game ball surface (e.g., a soccer ball surface material) that is at least 50% higher than the static coefficient of friction of the surface 104A of the substrate 104 alone (without the printed structures 102 thereon). In some examples, the printed structure including samples may be at least 90% higher, at least 100% higher, or at least 120% higher. For “wet” materials, substrates 104 with printed structures 102 thereon may have a static coefficient of friction with respect to material of a game ball surface (e.g., a soccer ball surface material) that is at least 90% higher than the static coefficient of friction of the surface 104A of the substrate 104 alone (without the printed structures 102 thereon). In some examples, the printed structure including samples may be at least 100% higher, or at least 120% higher.

Additionally or alternatively, in some examples, in a “dry” test (with dry substrates 104 and dry test material (e.g., soccer ball material), substrates 104 with printed structures 102 thereon may have a dynamic coefficient of friction with respect to material of a game ball surface (e.g., a soccer ball surface material) that is at least 100% higher than the dynamic coefficient of friction of the surface 104A of the substrate 104 alone (without the printed structures 102 thereon). In some examples, the printed structure including samples may be at least 120% higher, at least 150% higher, at least 200% higher, or at least 300% higher. For “wet” materials, substrates 104 with printed structures 102 thereon may have a dynamic coefficient of friction with respect to material of a game ball surface (e.g., a soccer ball surface material) that is at least 75% higher than the dynamic coefficient of friction of the surface 104A of the substrate 104 alone (without the printed structures 102 thereon). In some examples, the printed structure including samples may be at least 100% higher, at least 120% higher, at least 150% higher, at least 200% higher, or at least 300% higher.

Print media materials 120 of the types described above may be used to make printed elements 102 in a wide variety of different sizes, shapes, and/or thicknesses. As some examples, printed elements 102 may have a thickness in a range from 40 micron to 12 mm, and in some examples, from 45 microns to 10 mm, from 45 microns to 8 mm, from 45 microns to 5 mm, or from 45 microns to 3 mm.

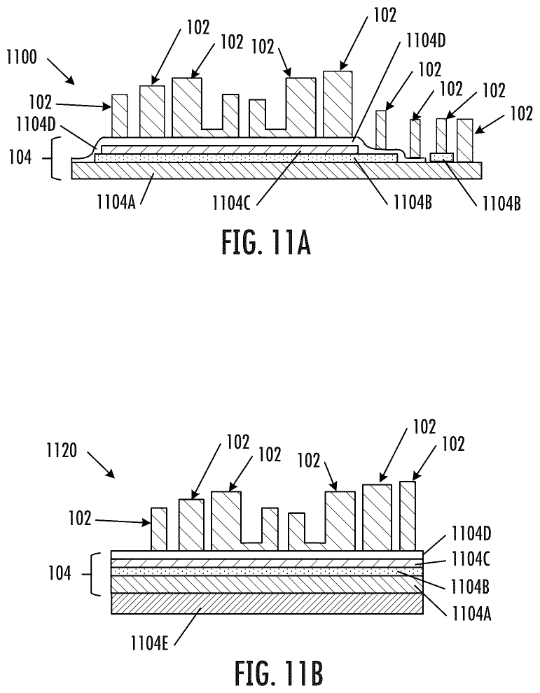

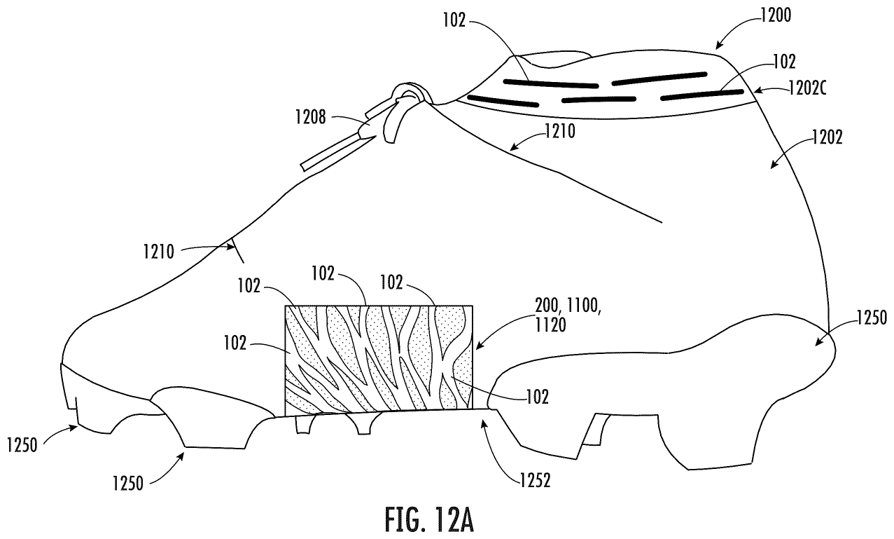

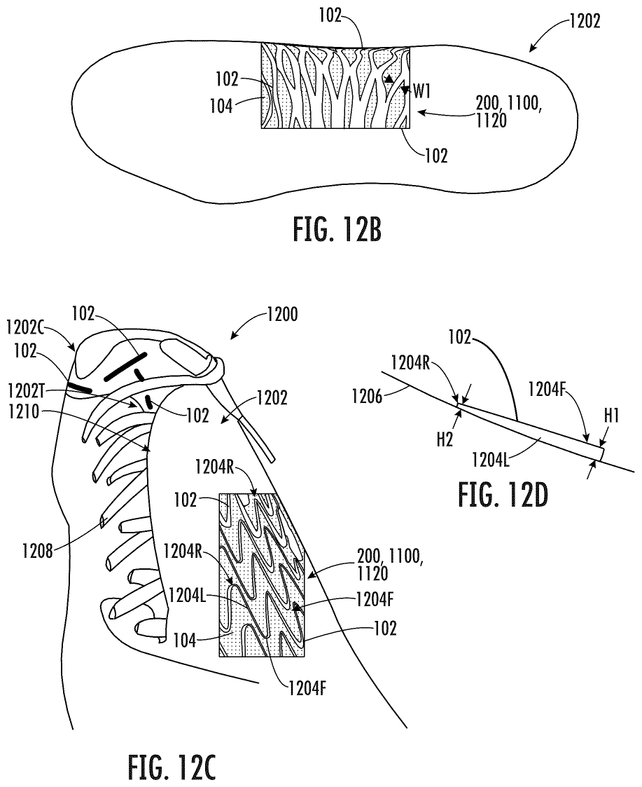

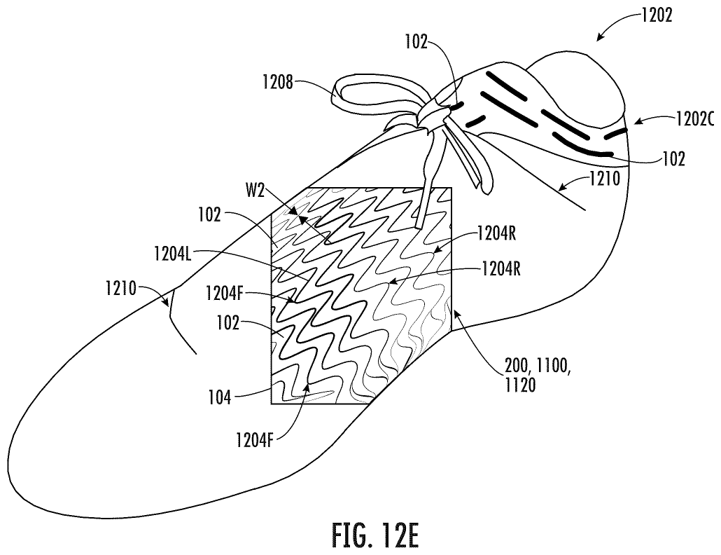

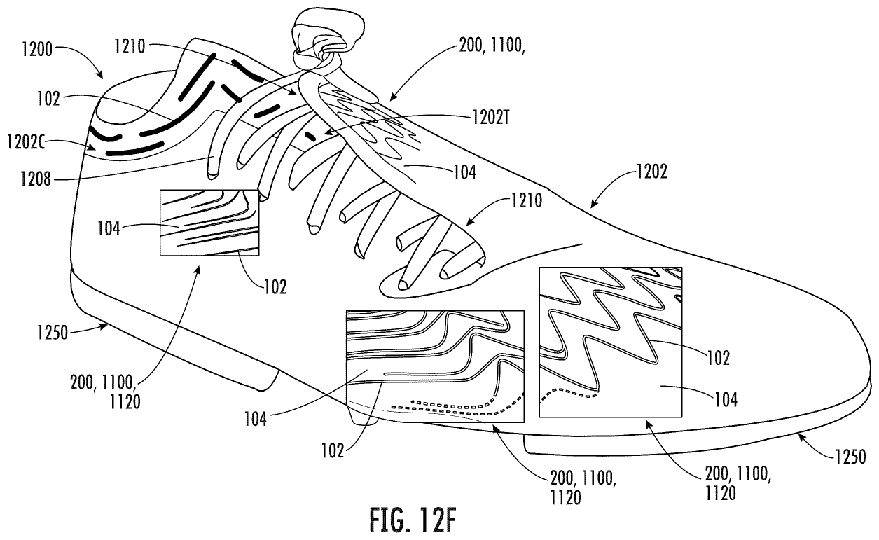

Additional or alternative aspects of this technology are described below in conjunction with FIGS. 11A-12F.

FIG. 11A provides a cross-sectional view through one or more printed elements 102 on a substrate 104 in accordance with some examples of this technology. Where the same reference number is used in FIG. 11A as used in any of FIGS. 1A-10 described above, the same or similar part is being referenced, and much of the overlapping description may be omitted.

The substrate 104 of this example includes a multilayer construction to be described in more detail below. The combined substrate 104 with the printed elements 102 may form a wearable component 1100, e.g., a component for an article of footwear, such as an upper for cleated footwear or other footwear, an article of apparel, or a component for an article of apparel. The printed elements 102 in FIG. 11A may have any of the features (sizes, shapes, materials, variations thereof, etc.) of the printed elements 202, 202A, 202B, 202C, 202D, 202E, 602, 702, 802, and/or 902 described above and/or may be formed from print media material 120 having any of the compositions, characteristics, and/or features described above.

In this particularly illustrated example, the substrate 104 includes a base fabric layer 1104A, such as a knitted textile layer (although other types of textiles may be used, such as a woven textile, a non-woven textile, a synthetic leather material, etc.). The base fabric layer 1104A of this example provides a lightweight base for supporting the other parts of the component 1100.

In this example, a “skin” layer 1104B is applied to at least some portion(s) of a surface of the base fabric layer 1104A. The skin layer 1104B may be formed from any of the materials for a skin described above, such as one or more of a polyurethane material or layer and/or a thermoplastic polyurethane material or layer. The skin layer 1104B may be joined to the base fabric layer 1104A in any suitable manner, such as by heat pressing using a hot melt adhesive. The skin layer 1104B in this illustrated example may provide weatherizing functions (e.g., waterproofing, water resistance, abrasion resistance, durability, etc.) and/or function to provide a base color for the component 1100. The “skin” may be applied in conventional manners, e.g., as known and used in the footwear arts, such as in the manner described in U.S. Pat. No. 9,723,895, which patent is entirely incorporated herein by reference. Skin layer 1104B need not completely cover the base fabric layer 1104A. For example, the base fabric layer 1104A may remain “unskinned” or exposed, e.g., at the collar region of a footwear upper, and/or at the tongue or instep region of a footwear upper, at the bite line along a bottom edge of a footwear upper (e.g., and/or locations where the upper connects with (e.g., is bonded to) a sole component), etc.

The component 1100 of the example FIG. 11A further includes one or more additional layers 1104C over some or all portions of the surface of the component 1100 (e.g., over at least some portion of base fabric layer 1104A and/or over at least some portion of skin layer 1104B). These one or more additional layers 1104C may be provided to add color, designs, graphics, and/or other features to desired locations on the component 1100. As some more specific examples, the one or more additional layers 1104C may be made from polyurethane inks with an isocyanate cross-linker and/or other suitable screen printing ink materials. The one or more additional layers may be applied by screen printing techniques, e.g., in manners conventionally known and used in the screen printing arts (such as screen printing with multiple colors with 10-15 seconds of air drying (e.g., using heated and/or moving air) between different color stations). The one or more additional layers 1104C need not completely cover the base fabric layer 1104A and/or the skin layer 1104B.

In at least some examples of this technology, the presence of one or more additional layers 1104C in substrate 104 may adversely affect the bonding strength between the desired printed elements 102 and the substrate 104. Additionally or alternatively, the presence of one or more additional layers 1104C in substrate 104 may change the coefficient of friction properties of the substrate 1104 (e.g., the additional layer(s) 1104C may have a lower coefficient of friction as compared to the coefficient of friction of the substrate material that the layer(s) 1104C covers). As one more specific example, the one or more additional layers 1104C (e.g., graphics layer(s)) may adversely affect (e.g., reduce) a footwear upper's “grippiness” with respect to a game ball surface (e.g., as compared to other areas on the upper that do not include the additional layer(s) 1104C and/or as compared to the “grippiness” (e.g., coefficient of friction) of the surface(s) the additional layer(s) 1104C cover).

Thus, in at least some examples of this technology, a topcoat layer 1104D is applied over at least some portion(s) of the one or more additional layers 1104C (the layers that provide the color, designs, graphics, weatherproofing, durability, and/or other features). In this illustrated example, the topcoat layer 1104D is transparent (i.e., clear), although a colored topcoat could be used in other specific examples of this technology (e.g., with a pigment included in the topcoat print media material 1104M).

In this illustrated example, the topcoat layer 1104D comprises an aqueous polyurethane dispersion (e.g., such as a polyether polyurethane dispersion), e.g., of the types described above for the print media material 120. As some more specific examples, the topcoat layer 1104D may be formed from a print media material 120, 1104M that includes: (a) an aqueous compact resin of polyurethane in water having a high solids content (e.g., at least 40% solids), e.g., of the types described above for the print media material 120; (b) a cross-linking material (e.g., a carbodiimide, an isocyanate, etc.), e.g., of the types described above for the print media material 120; (c) an alcohol (e.g., an aminoalkyl alcohol), e.g., of the types described above for the print media material 120; and/or (d) a rheological modifier (e.g., a thickening agent, etc.), e.g., of the types described above for the print media material 120. See the ingredients and amounts in the Table above. But, in topcoat layer 1104D, less of the rheological modifier may be used as compared to the amounts used in making the print media material 120 shown in the Table above for the jetting process. As more specific examples, the rheological modifier may comprise: (a) less than 1% by weight (based on the total weight of the mixture), (b) less than 0.8% by weight (based on the total weight of the mixture), and/or (c) an appropriate amount of rheological modifier to make the viscosity of the overall mixture in the range of 10,000 centipoise to 15,000 centipoise (and in some examples, in the range of 11,000 centipoise to 13,000 centipoise). The amount(s) of the other ingredients in the aqueous dispersion also may be adjusted, if necessary, to give the dispersion a proper viscosity and/or other properties.

As noted above, the topcoat layer 1104D may be transparent, e.g., no pigment may be needed. Additionally or alternatively, if desired, a functional filler, such as a matting agent, may be provided within the aqueous polyurethane dispersion applied as a topcoat layer 1104D, e.g., to give the topcoat layer 1104D more of a matte finish (e.g., less shiny and/or glossy). As some more specific examples, the topcoat layer 1104D may include silica (e.g., 100% fumed silica, precipitated silica, 1% to 3% dry silica, etc.) as a functional filler (e.g., a matting agent) added to the other topcoat layer 1104D ingredients, e.g., present in an amount up to 4%, and in some examples, from 1.5% to 3.5% (based on a total weight of the mixture to be applied as a topcoat).

Additionally or alternatively, in at least some examples of this technology, the topcoat layer 1104D (e.g., with the functional filler (e.g., silica) therein) may be used to control the “grippiness” or coefficient of friction of the area(s) of the component 1100 where it is applied. As a more specific footwear upper example, the topcoat layer 1104D (e.g., with the functional filler therein) may be used at desired locations so as to lower the coefficient of friction of the exposed surface of the upper with respect to a game ball and/or other object with which it may come into contact. The functional filler may help reduce the coefficient of friction properties of the topcoat layer 1104D as compared to its properties when the functional filler is not present.

Additionally or alternatively, in some examples, the additional layer 1104C (e.g., a graphics layer) may reduce grippiness or coefficient of friction (e.g., with respect to a game ball) at the local area(s) where it is applied. A topcoat layer 1104D (e.g., with a functional filler of the types described above therein) may be provided over the additional layer 1104C to control (e.g., increase) the grippiness and/or coefficient of friction at the local area(s) of the additional layer 1104C. Thus, the topcoat layer 1104D can be used to control and place the grippiness and/or coefficient of friction at a desired level at the area(s) where it is applied.

Use of a topcoat layer 1104D of the types described herein (e.g., with the materials described above) over a substrate layer (e.g., a base fabric layer 1104A), one or more skin layers 1104B, and/or one or more additional layers 1104C (e.g., a graphics layer) to control grippiness and/or coefficient of friction at local areas may be used in examples of this technology irrespective of whether jetted printed elements 102 are applied over the topcoat layer 1104D. In other words, at least some aspects of this technology may relate to substrates and/or methods of making them that include: (A) a substrate layer (e.g., a base fabric layer 1104A), (B) optionally one or more skin layers 1104B, (C) optionally one or more additional layers 1104C (e.g., a graphics layer), and (D) a topcoat layer 1104D. In such products and methods, the topcoat layer 1104D may be screen printed onto (or otherwise applied to) one or more of the substrate layer (e.g., base fabric layer 1104A), the skin layer(s) (if any are present), and/or the additional layer(s) (if any are present). The topcoat layer 1104D may be present over any one or more of the other noted layers to control the local properties (e.g., color, glossiness, coefficient of friction, grippiness, etc.) at the local areas where it is applied. The topcoat layer 1104D may be quite thin, e.g., less than 1 mm, and in some examples, less than 0.5 mm, less than 0.25 mm, less than 0.2 mm, less than 0.1 mm, less than 0.05 mm, or less than 0.03 mm. In some more specific examples, the topcoat layer 1104D may improve grippiness and/or coefficient of friction to reduce slipping and improve a user's grasp when handling the substrate 104, e.g., if the substrate 104 is present at a collar or tongue region of an article of footwear.

In at least some examples of this technology, the amounts of the various ingredients may be modified to produce an overall aqueous dispersion for the topcoat layer 1104D that is suitable for screen printing. As some more specific examples, the amount of the various ingredients will be controlled so that the viscosity of the overall mixture applied as the topcoat is in the range of 10,000 centipoise to 15,000 centipoise (and in some examples, in the range of 11,000 centipoise to 13,000 centipoise). Viscosity control and adjustment may be accomplished, e.g., by adjusting the amount of rheological modifier, functional filler(s), and/or other components used in making the mixture to be screen printed for the topcoat layer 1104D.

Other ways of applying the topcoat layer 1104D may be used in other specific examples of this technology. For example, spraying, dipping, and/or other coating methods may be used to apply the topcoat layer 1104D over the one or more other layers 1104C and/or over other layers of the overall component 1100 or substrate 104. In at least some footwear upper examples, the topcoat layer 1104D may be applied such that the bite line along the bottom edge of the upper (e.g., the bottom 1.5 mm to 4 mm around the bottom edge of the upper and/or where the upper meets and/or will be bonded to a sole component) may remain free of the topcoat layer 1104D. This bottom bite line edge area also may remain free of the materials of skin layer 1104B and/or additional layer(s) 1104C (if any are present), e.g., so that the bite line edge area is made of just the base fabric layer 1104A.

Once the additional layer(s) 1104C and topcoat layer 1104D are applied, the resulting composite substrate 104 may be dried, e.g., to allow the materials of layers 1104C and 1104D to dry and/or cure. This may be accomplished, for example, by air drying for a period of time (e.g., for 1 day to 7 days, and in some examples, from 2 days to 6 days, or 3 days to 5 days). After drying and/or curing have taken place, then, in at least some examples, the print media material 120 may be applied, e.g., in any of the manners described above (including use of any of the jetting systems and/or techniques described above), to form the printed elements 102 on the substrate 104. In at least some examples of this technology, the topcoat layer 1104D improves bonding with the print media material 120, at least as compared to bonding directly on the one or more additional layers 1104C providing the color, design, and/or graphical features.

The topcoat layer 1104D need not completely cover the base fabric layer 1104A, the skin layer 1104B, and/or the additional layer(s) 1104C. Rather if desired, the topcoat layer 1104D may be applied only where its properties (e.g., enhanced bonding, controlled coefficient of friction, reduced glossiness, etc.) are desired for the overall component 1100.

Additionally or alternatively, the topcoat layer 1104D need not be applied only over areas of the substrate 104 that include the additional layers 1104C and/or only at areas where print media material 120 is to be applied. Rather, the topcoat layer 1104D may be applied over at least some of the exposed surfaces of the skin layer 1104B (if any) and/or over at least some of the exposed surfaces of the base fabric layer 1104A (if any). Thus, the topcoat layer 1104D may be applied to any areas of the overall component 1100 where its properties (e.g., enhanced bonding, controlled coefficient of friction, reduced glossiness, etc.) are desired.

Additionally or alternatively, printed elements 102 may be applied to a topcoat layer 1104D irrespective of which other layers are located beneath the topcoat layer 1104D (e.g., even if an additional layer 1104C and/or skin layer 1104B is not present at that location). See the right side of FIG. 11A. Still additionally or alternatively, printed elements 102 may be applied directly to the skin layer 1104B and/or directly to the base fabric layer 1104A at least at some locations of the composite component 1100 (e.g., with no topcoat layer 1104D present at that location). See the far right side of FIG. 11A. Thus, aspects of this technology include several different ways and/or combination of ways of applying printed elements 102 to a substrate 104.

Additionally or alternatively, in some examples, at least some areas of the topcoat layer 1104D, optionally up to all of the topcoat layer 1104D, will not have jetted printed elements 102 formed thereon. In such areas, the topcoat layer 1104D may be present (e.g., over a substrate base fabric layer 1104A, one or more skin layers 1104B (if present), and/or one or more additional layers 1104C (if present)) to control properties of the component 1100, such as color, glossiness, grippiness, coefficient of friction, etc.

The elasticity and/or stretchability of a substrate 104 with a topcoat layer 1104D formed thereon (e.g., over one or more of a substrate base fabric layer 1104A, one or more skin layer 1104B (if any), and/or one or more additional layers 1104C (if any)) may, at least in part, depend on the thickness of the topcoat layer 1104D. For example, the elasticity and/or stretchability of the final product (or retained elasticity and/or stretchability for the final product as compared to elasticity and/or stretchability of the substrate 104 prior to application of topcoat layer 1104D) may be inversely proportional to the thickness of topcoat layer 1104D. Thus, elastomeric and/or stretchable substrates 104 with thinner topcoat layers 1104D formed thereon may retain more elasticity and/or stretchability than elastomeric and/or stretchable substrates 104 with thicker topcoat layers 1104D formed thereon. In at least some examples of this technology, substrates 104 with a topcoat layer 1104D formed thereon in which the topcoat layer 1104D has a thickness of no more than 25 microns may retain the same or substantially the same elasticity and/or stretchability of the substrate 104 prior to (or without) the topcoat layer 1104D thereon. The term “substantially the same” as used herein in this context, means that the elasticity and/or stretchability of the substrate 104 after the topcoat layer 1104D is applied is at least 95% of the elasticity and/or stretchability of the substrate 104 before the topcoat layer 1104D is applied. The additional presence of printed elements 102 over the topcoat layer 1104D, if any, however, may impact the elasticity and/or stretchability of the resulting component 1100 structures.

After the desired printed elements 102 are formed over the topcoat layer 1104D (if any), the resulting component 1100 may be dried (e.g., at 40 to 60 degrees C. for 5 minutes to an hour), e.g., to prevent smudging. After this initial drying step, the component 1100 may be stored for a time period (e.g., four to six days) to promote further drying (e.g., open air drying) and then cured (e.g., at 70 to 90 degrees C. (e.g., such as at 80 degrees C.) for 3 minutes to 40 minutes, and in some examples, from 5 to 10 minutes). Additionally or alternatively, drying and/or curing conditions of the types described above in conjunction with print media material 120 also may be used. After drying and/or curing, the component 1100 may be ready for further assembly steps (e.g., assembly into a footwear upper).

FIG. 11B shows a cross-sectional view through one or more printed elements 102 on a substrate 104 in accordance with other examples of this technology. Where the same reference number is used in FIG. 11B as used in any of FIGS. 1A-11A described above, the same or similar part is being referenced, and much of the overlapping description may be omitted.

The upper component 1120 of FIG. 11B is similar to the component 1100 of FIG. 11A in many respects, and it may include any of the features of FIG. 11A discussed above. Upper component 1120 of FIG. 11B additionally includes an interior layer 1104E (e.g., a foam layer, a fabric layer, a moisture wicking layer, a comfort enhancing layer, etc.) applied to the base fabric layer 1104A on the side opposite from the skin layer 1104B. The interior layer 1104E may be applied by a hot melt layer at an appropriate time (e.g., during hot pressing to apply to skin layer 1104B to the base fabric layer 1104A or another appropriate time). The interior layer 1104E may be relatively thin, e.g., 4 mm or less, from 2 mm to 4 mm, from 2 mm to 3 mm, etc.

FIGS. 12A-12F show an article of footwear 1200 including a footwear upper 1202 (formed from one or more component parts) and a sole structure 1250 (formed from one or more component parts) in accordance with some aspects of this technology. The upper 1202 may be formed, in whole or in part, as an upper 200 and/or an upper component 1100 and/or 1120, e.g., of the types described above, having one or more printed elements 102 formed thereon. FIGS. 12A-12F are provided to show specific features of uppers 200, 1202 and printed elements 102 that may be included in such uppers 200, 1202 and/or upper components 1100, 1120 in accordance with at least some examples of this technology.

As shown in FIGS. 12A and 12B, this example upper 200 or component 1100, 1120 includes printed structures 102 in the medial midfoot region, within the game ball receiving region of the upper 200 or component 1100, 1120. These printed structures 102 extend around the medial side edge of the upper 200 or component 1100, 1120 from the medial midfoot sidewall of the upper 1202 to a medial midfoot bottom portion of the upper 1202. The medial midfoot bottom portion of the upper 1202 may remain exposed in this footwear 1200 structure so that those printed elements 102 remain exposed at the exterior surface of the final footwear 1200 product. The printed element 102 features of FIGS. 12A and 12B may extend into an open space 1252 provided at the bottom of the sole structure 1250 (or its sole plate), as shown in FIG. 12A. In some examples, the printed element 102 features of FIGS. 12A and 12B may extend into an open space provided at the bottom of the sole structure 1250 by a sole plate of the type shown in FIGS. 44A-44F of U.S. Provisional Patent Appln. No. 63/808,367.

As shown in FIG. 12A, at the side of the upper 1202, the printed elements 102 are elongated and extend in generally a top-to-bottom direction of the footwear upper 1202 and article of footwear 1200. As shown in FIGS. 12A and 12B, at the bottom of the upper 1202, the printed elements 102 are elongated and extend in generally a side-to-side direction of the footwear upper 1202 and article of footwear 1200. In this illustrated example, at least some of the elongated printed elements 102 extend continuously from the bottom surface of the upper 1202 to the medial, midfoot sidewall of the upper 1202 (thus wrapping around a medial midfoot side edge of the upper 1202 and the article of footwear 1200).

The individual printed elements 102 in the ball receiving region of the medial midfoot area of the upper 1202 generally are less than 8 mm wide, and in some examples, less than 5 mm wide, less than 4 mm wide or even less than 3 mm wide. At the bottom, medial midfoot region, the printed elements 102 may combine to cover at least 15% of the surface area of the upper 1202, and in some examples, covering at least 20%, at least 25%, at least 30%, at least 40%, or at least 50% of the surface area of the bottom, medial midfoot region of the upper 1202. Additionally or alternatively, the printed elements 102 in the ball receiving region of the medial midfoot area of the upper 1202 (e.g., the areas shown in FIGS. 12A and 12B) may be raised outward from the base surface of the substrate on which they are printed: (i) by at least 0.2 mm (and in some examples, at least 0.5 mm, at least 1 mm, or at least 1.25 mm), and (ii) in some examples, by no more than 8 mm (and in some examples, no more than 6 mm, no more than 4 mm, or no more than 3 mm).

The printed elements 102 may have a wide variety of sizes, shapes, and/or appearances in different examples of this technology. FIGS. 12A and 12B show these example elongated printed elements 102 as curved with adjacent elongated printed elements 102 curving toward and away one another and even abutting one another at some locations. Many other sizes and/or shapes are possible. For example, at least some of the elongated printed elements 102 may be positioned to maintain a constant spacing with respect to one another, may have varied spacings, need not abut one another, need not be curved in the front-to-back direction, etc. Additionally or alternatively, at least some of the elongated printed elements 102 at the bottom of the upper 1202 need not extend continuously to form the elongated printed elements 102 on the medial side surface of the upper 1202. Rather, at least some of the elongated printed elements 102 on the bottom surface of the upper 1202 may be spaced from adjacent elongated printed elements 102 on the medial side surface of the upper 1202 by a gap or a staggered arrangement, and that gap or staggered arrangement, when present, may vary in size. Additionally or alternatively, the widths of the elongated printed elements 102 may vary in different manners from the width dimensions and variations shown in FIGS. 12A and 12B. Thus, the printed elements 102 in the ball receiving region of an upper 1202 may have a wide variety of different sizes, shapes, arrangements, relative arrangements, and/or other features while still providing the desired ball receiving functions described herein.

FIGS. 12C-12E show additional potential features of uppers 1202 and articles of footwear 1200 in accordance with aspects of this technology. These figures show features of the game ball propelling region of an upper 1202 and article of footwear 1200, e.g., features of the medial instep or top medial region of an upper 1202 and article of footwear 1200.

At least portions of the printed elements 102 in the ball propelling region of this specific example have a V-shape. In this particular example, the apex 1204F of some of the V-shapes is located closer to a forward end of the upper 1202 and article of footwear 1200, and the legs 1204L of the V-shape extend rearward from the forward apex 1204F. Multiple rows of V-shaped printed elements 102 may be provided in the ball propelling region of the upper 1202 and article of footwear 1200, e.g., with the multiple rows arranged in a forward-to-rear direction of the upper 1202 and article of footwear 1200. When multiple rows are present, the forward apexes 1204F in one row may extend into the spaces between the legs 1204L of a V-shape in an adjacent forward row. In other words, one row of printed elements 102 may be at least partially “nested” within an adjacent forward row and/or at least partially “nested” within an adjacent rearward row.

In some examples of this technology, at least some of the individual V-shaped printed elements 102 of a row may be spaced apart from one another. In this particular example, however, at least portions of the printed elements 102 in this ball propelling region of the upper 1202 and article of footwear 1200 have a general sine wave shape with alternating forward oriented apices 1204F and rearward oriented apices 1204R. In this manner, at least some of the adjacent V-shaped printed elements 102 within a row will be interconnected and formed by a continuous elongated printed element 102. Additionally or alternatively, in such sine wave type printed element 102 structures: (i) at least some of the forward oriented apices 1204F of one row or waveform will extend into an area between at least some of the rearward apices 1204R of the adjacent forward row or waveform (if an adjacent forward row or waveform is present), and/or (ii) at least some of the rearward oriented apices 1204R of one row or waveform will extend into an area between at least some of the forward apices 1204F of the adjacent rearward row or waveform (if an adjacent rearward row or waveform is present). In other words, the sine type rows or waveforms may be at least partially “nested” within an adjacent forward row or waveform (if any) and/or at least partially “nested” within an adjacent rearward row or waveform (if any).

FIG. 12D shows a side view of a V-shaped printed element 102 having a forward apex 1204F and a rearward end (e.g., a rearward apex 1204R or a rearward free end of a leg 1204L) interconnected by a leg 1204L. As shown in FIG. 12D, the height of the printed element 102 may vary (e.g., taper) along the length of the leg 1204L, with the forward height H1 (e.g., at the forward apex 1204F) being greater than the rearward height H2 (e.g., at the rear edge of a leg 1204L or at the rearward apex 1204R of a sine type waveform). In some specific examples, H1 may be at least 1.5 times H2, and in some examples, H1 may be 2 times or 2.5 times H2. As some specific values, H1 may be within a range of 1.5 to 5 mm, and in some examples, from 1.75 to 3.5 mm or 2 to 3 mm (with the heights H1 and H2 being measured outward from the base surface 1206 of the substrate 104 on which the printed element 102 is formed). The printed elements 102 may help provide the “gripping” features and/or increased coefficient of friction with respect to a game ball surface (e.g., increased coefficient of friction as compared to the material and surface of topcoat layer 1104D (if any), and/or as compared to the material and surface of the one or more additional layers 1104C (if any), and/or as compared to the material and surface of the skin layer 1104B (if any), and/or as compared to the material and surface of the base fabric 1104A, and/or as compared to the material and surface of the substrate 104 on which the printed element(s) 102 are provided).

FIGS. 12A, 12C, 12E, and 12F further show that the ball propelling region of this example upper 1202 and article of footwear 1200 includes a flap 1210 of upper material that extends over and at least partially covers the lace 1208 and lacing region of the upper 1202. At least a portion of the printed elements 102 for the ball propelling region (e.g., the V-shaped and/or sine wave shaped printed elements 102 described above in conjunction with FIGS. 12C-12E) are provided on (e.g., printed onto) this flap 1210. The flap 1210 may be formed continuously with and/or from the same material as the upper 200 or components 1100, 1120 described above (e.g., it may constitute a substrate 104 material as described above). The flap 1210 at least partially covers the lace 1208 and provides a more consistent surface for applying the printed elements 102 and for striking the ball during play. The flap 1210 may be secured over the lace region, e.g., using the lace 1208 (see FIGS. 12C and 12F) or in another manner. The flap 1210 may form somewhat of a pocket to at least partially receive and cover the lace 1208.

Notably, in this illustrated example, the printed element 102 distribution density (i.e., the percentage of upper 1202 surface covered by printed element 102 material) is lower in the ball propelling region as compared to the ball receiving region. As a more specific example, the ball striking region may have a printed element 102 distribution density of less than 75% of the printed element 102 distribution density in the ball receiving region (and in some examples, less than 60% or less than 50%). This may be accomplished, for example: (i) by making the width dimensions W2 of the printed element(s) 102 in the ball striking region smaller than the width dimensions W1 of the printed element(s) 102 in the ball receiving region, and/or (ii) by spacing the printed elements 102 further apart in the ball striking region as compared to the ball receiving region. The width dimension is the dimension directly across a printed element 102 from one side edge to the other (see W1 in FIG. 12B and W2 in FIG. 12E).

In at least some examples of this technology, as shown in FIG. 12F, one or more printed elements 102 may be provided on the lateral side of the upper 1202 and article of footwear 1200. The printed element 102 distribution density (i.e., the percentage of upper 1202 surface covered by printed element 102 material) may be lower on the lateral side of the upper 1202 (or article of footwear) as compared to the medial side of the upper 1202 (or article of footwear 1200). As a more specific example, the lateral side of the upper 1202 and article of footwear 1200 may have a printed element 102 distribution density of less than 75% of the printed element 102 distribution density on the medial side of the upper 1202 and article of footwear 1200 (and in some examples, less than 60%, less than 50%, or less than 40%). This may be accomplished, for example: (i) by making the width dimensions of the printed element(s) 102 on the lateral side smaller than the width dimensions of the printed element(s) 102 on the medial side, and/or (ii) by spacing the printed elements 102 further apart on the lateral side as compared to the medial side. The lateral side printed elements 102 can help enhance grip (e.g., increase the coefficient of friction with respect to a game ball surface), e.g., for accepting a ball on the lateral side of the foot and/or for propelling a ball using the lateral side of the foot.

Additionally or alternatively, as shown in FIGS. 12A, 12C, 12E, and 12F, in some examples of this technology, one or more printed elements 102 may be provided on portions of the upper 1202 corresponding to the tongue or instep region 1202T of the upper 1202 and/or at or around the collar region 1202C of the upper 1202. In these areas, the printed elements 102 may be provided directly on the substrate 104 irrespective of what specific material is present or exposed at that area (e.g., on any one or more of base fabric layer 1104A, skin layer 1104B (if present), additional layer(s) 1104C (if present), and/or topcoat layer 1104D (if present)). In some specific examples of this technology, the collar region 1202C and/tongue or instep region 1202T may be formed at least in part from an elastomeric material (e.g., as the base fabric layer 1104A) to enable stretching of the tongue or instep region 1202T and/or collar region 1202C when a foot is inserted or removed), and in such examples of this technology, the printed element(s) 102 may extend, expand, elongate, and/or stretch along with the material to which it is applied. Additionally or alternatively, in some examples, one or more of the skin layer 1104B, additional layer(s) 1104C, and/or topcoat layer 1104D may be omitted at the tongue or instep region 1202T and/or collar region 1202C (and, if applicable, the printed elements 102 may be formed directly on the base fabric layer 1104A). The printed elements 102 in the tongue or instep region 1202T and/or the collar region 1202C may provide structures to help a wearer get a secure grip, e.g., when donning or doffing the article of footwear 1200.

The printed element 102 structures shown in FIGS. 12A-12F may be varied widely in size, shape, orientation, relative orientation, and the like while still providing the desired gripping and coefficient of friction enhancing features. For example, the V-shaped printed elements 102 in the ball propelling region may have a sine wave shape and/or may be unattached, discreet V shapes. The sine waveforms, when present, may vary in amplitude, wavelength, printed element height, printed element taper, and/or printed element width. Further, these different features may vary from one waveform to the next on a single shoe and/or within a single waveform of a shoe. Likewise, the separated V-shaped printed components, when present, may vary within a specific row and/or from row to row, e.g., in one or more of V element height, V element width, V element spacing, V element nesting properties, etc. Additionally or alternatively, the waveforms and/or V shaped printed elements 102 need not be arranged in discrete rows and/or in a nested formation. Thus, the printed elements 102 in the ball propelling region of an upper 1202 may have a wide variety of different sizes, shapes, arrangements, relative arrangements, and/or other features while still providing the ball propelling functions described above.

Additionally or alternatively, the printed elements 102 on the lateral side, when present, may have a wide variety of sizes, shapes, arrangements, relative arrangements, and/or other features while still providing the ball interacting functions described above. As some more examples, the lateral side may have curved and/or linear printed elements arranged in different patterns, sizes, widths, heights, etc.

Printed elements 102 in accordance with at least some examples of this technology may have a ply adhesion property (the strength with which the printed element 102 attaches to an exposed layer of the substrate 104) of at least 3 kgf/cm (and in some examples, at least 4 kgf/cm, or at least 4.5 kgf/cm).

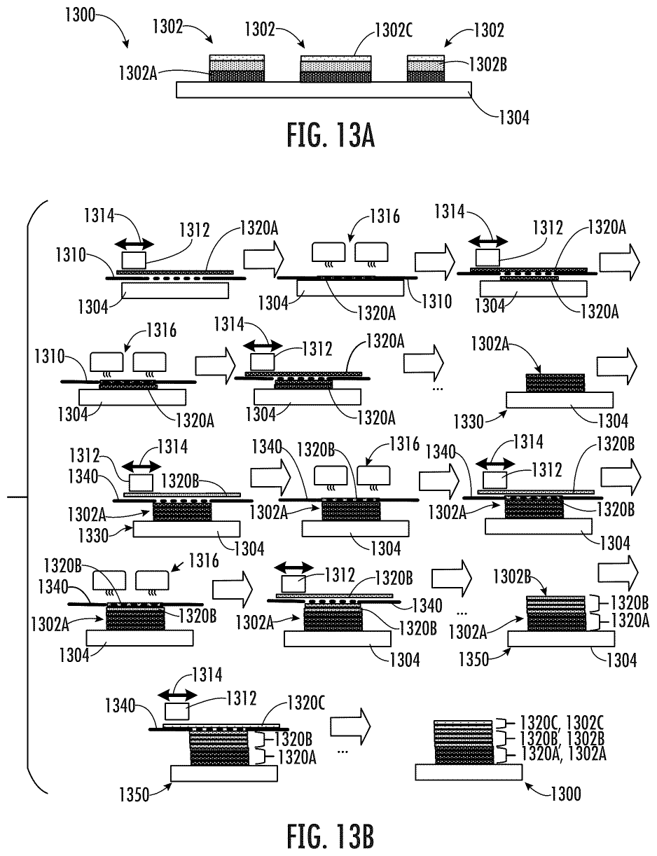

Additional or alternative aspects of this technology relate to components (e.g., wearable components, such as uppers for articles of footwear, other articles of apparel, etc.) that include elements formed on substrates by multi-stage screen printing processes. This aspect of the present technology can be used to form elastomeric and/or “grippy” (increased coefficient of friction) printed components in select areas of a substrate. As more specific examples, aspects of this technology can be used to form ball receiving regions and/or ball propelling regions of a footwear upper, e.g., in the areas of an upper as described above. These additional or alternative aspects of this technology will be described in more detail below in conjunction with FIGS. 13A-15.

FIG. 13A shows an example component 1300 (e.g., a wearable component, such as an article of apparel, a footwear upper component, etc., of the types generally described above) that includes a substrate 1304 with one or more printed elements 1302 formed thereon. The substrate 1304 may be made from any of the materials, any of the components, and/or have any of the features of substrates 104 (e.g., upper base member 204) described above in conjunction with FIGS. 1A-12F (including a multi-layered construction with two or more of layers 1104A-1104E as described above in conjunction with FIGS. 11A-11B). As some more specific examples, the substrate 1304 may comprise: a textile; a polyurethane component; a polyvinylchloride component; a synthetic leather component; a woven textile component; a knitted textile component; or a non-woven textile component.

The printed elements 1302 in the example component 1300 of FIG. 13A include three distinct portions: (a) a first region 1302A (the darker shaded, bottom region of printed elements 1302 shown in FIG. 13A located closest to the substrate 1304) formed from a first print media material 1320A having a “high” viscosity; (b) a second region 1302B (the lighter shaded, middle region of printed elements 1302 shown in FIG. 13A) formed from a second print media material 1320B having a “mid-range” viscosity; and (c) a third region 1302C (the lightest shaded, top region of printed elements 1302 shown in FIG. 13A) formed from a third print media material 1320C having a “low” viscosity.

The term “high viscosity” as used herein in this context means a viscosity within a range of 85,000 to 500,000 centipoise (and in some examples, within a range of 90,000 centipoise to 450,000 centipoise). This “high viscosity” print media material 1320A may have a greater viscosity than that of the other print media material(s) used in making the printed element 1302. The term “mid-range viscosity” as used herein in this context means a viscosity within a range of 40,000 to 80,000 centipoise (and in some examples, within a range of 50,000 centipoise to 77,500 centipoise or within a range of 55,000 centipoise to 75,000 centipoise). This “mid-range viscosity” print media material 1320B may have a viscosity between the viscosities of two other print media materials used in making the printed element 1302. The term “low viscosity” as used herein in this context means a viscosity within a range of 3500 to 25,000 centipoise (and in some examples, within a range of 4000 centipoise to 20,000 centipoise or 4500 centipoise to 15,000 centipoise). This “low viscosity” print media material 1320C may have a lower viscosity than that of the other print media material(s) used in making the printed element 1302.

In accordance with at least some examples of this technology, the component 1300 may be made by a method that includes: (a) printing (e.g., screen printing) the high viscosity print media material 1320A onto a substrate 1304 to form region 1302A; (b) thereafter, printing (e.g., screen printing) the mid-range viscosity print media material 1320B onto at least a part of an exposed surface of the high viscosity print media material 1320A to form region 1302B; and (c) thereafter, printing (e.g., screen printing) the low viscosity print media material 1320C onto at least a part of an exposed surface of the mid-range viscosity print media material 1320B to form region 1302C.

Each of the high viscosity print media material 1320A, the mid-range viscosity print media material 1320B, and the low viscosity print media material 1320C in the method described above may be made from print media material of the types described above for print media material 120. As some more specific examples, for the high viscosity print media material 1320A (for forming region 1302A in the example of FIG. 13A), the print media material may include: (a) 75% to 95% by weight of the aqueous resin (e.g., an aqueous polyether polyurethane dispersion) described above; (b) 2.5% to 5% by weight of a cross-linker material of the types described above; (c) up to 10% by weight of a pigment; (d) a pH stabilizer (e.g., alcohol, such as 2-amino-2-methyl-1-propanol), if needed; and (e) a rheological modifier (e.g., a thickening agent) of the types described above, if needed or as needed in a sufficient amount to make the viscosity within a range of 85,000 centipoise to 500,000 centipoise (or within any of the ranges described above for the high viscosity print media material). The amount of water included in the aqueous resin, the amount of pigment, and/or the amount of other ingredients also may be altered to adjust and/or control the viscosity of the resulting print media material.

As some additional examples, the high viscosity print media material 1320A in accordance with at least some examples of this technology may have the following ingredients and/or properties:

| | Range A - (all | Range B - (all |
|---|---|---|
| | Percentages are % By | Percentages are % By |
| | Weight based on Total | Weight Based on Total |
| Component/Property | Weight of Mixture) | Weight of Mixture) |
| Aqueous Resin (e.g., an | 75%-95% | 80%-90% |
| aqueous polyether | | |
| polyurethane dispersion) | | |
| Cross-Linking Material | 2%-5% | 3%-4.5% |
| (e.g., a VOC-free, water- | | |
| based, polycarbodiimide | | |
| crosslinker) | | |
| Alcohol (e.g., 2-amino- | 0%-0.6% | 0.2%-0.55% |
| 2-methyl-1-propanol) | | |
| Rheological | 0%-5% | 2.5%-4% |
| Modifier/Thickening | | |
| Agent (e.g., an acrylic | | |
| thickener/rheological | | |
| modifying material) | | |
| Pigment | 0%-12% | 3.5%-10% |
| Other Ingredients* | 0%-8% | 0%-6% |
| Water | Balance to 100% | Balance to 100% |
| Viscosity | 85,000 centipoise- | 90,000 centipoise- |
| | 500,000 centipoise | 200,000 centipoise |

*“Other Ingredients” may include, for example, functional fillers (e.g., matting agent(s), coefficient of friction modifying agents, debubbling agents, etc., as discussed herein); inert fillers; etc.

As some more specific examples, a high viscosity print media material 1320A in accordance with at least some examples of this technology may include (all percentages are percentages by weight based on the total weight of the print media material): (a) about 84.7% aqueous resin (e.g., an aqueous polyether polyurethane dispersion of the types described above in conjunction with print media material 120); (b) about 3.4% cross-linking material (e.g., a VOC-free water-based polycarbodiimide cross-linker of the types described above in conjunction with print media material 120); (c) about 0.3% alcohol (e.g., 2-amino-2-method-1-propanol); (d) 3.1% rheological modifier/thickening agent (e.g., an acrylic agent of the types described above in conjunction with print media material 120); (e) about 8.5% pigment (e.g., of the types described above in conjunction with print media material 120, such as a white pigment, for example, titanium dioxide); and (f) water (if needed) comprising the balance of the print media material (e.g., in an amount sufficient to reach 100% by weight). This mixture may provide a viscosity of about 100,000 cp. The various amounts of the ingredients and/or the specific compositions used for an ingredient may be adjusted, as needed, to modulate one or more functional desired properties, such as viscosity.

Additional aspects of this technology relate to high viscosity print media materials 1320A having compositions, ingredients, and combinations of ingredients of the types described above, including, but not limited to, high viscosity print media materials 1320A having compositions falling within the scope of the table above.

Additionally or alternatively, as some more specific examples, the mid-range viscosity print media material 1320B (for forming region 1302B in the example of FIG. 13A) may include: (a) 75% to 95% by weight of the aqueous resin (e.g., an aqueous polyether polyurethane dispersion) described above; (b) 2.5% to 5% by weight of a cross-linker material of the types described above; (c) up to 10% by weight of a pigment; (d) a pH stabilizer (e.g., alcohol, such as 2-amino-2-methyl-1-propanol), if needed; and (e) a rheological modifier (e.g., a thickening agent) of the types described above, if needed or as needed in a sufficient amount to make the viscosity within a range of 40,000 centipoise to 80,000 centipoise (or within any of the ranges described above for the mid-range viscosity print media material). The amount of water included in the aqueous resin, the amount of pigment, and/or the amount of other ingredients also may be altered to adjust and/or control the viscosity of the resulting print media material.

As some additional examples, the mid-range viscosity print media material 1320B in accordance with at least some examples of this technology may have the following ingredients and/or properties:

| | Range A - (all | Range B - (all |
|---|---|---|
| | Percentages are % By | Percentages are % By |
| | Weight based on Total | Weight Based on Total |
| Component/Property | Weight of Mixture) | Weight of Mixture) |
| Aqueous Resin (e.g., an | 75%-95% | 80%-90% |
| aqueous polyether | | |
| polyurethane dispersion) | | |
| Cross-Linking Material | 2%-5% | 3%-4.5% |
| (e.g., a VOC-free, water- | | |
| based, polycarbodiimide | | |
| crosslinker) | | |
| Alcohol (e.g., 2-amino- | 0%-0.6% | 0.2%-0.55% |
| 2-methyl-1-propanol) | | |
| Rheological | 0%-4.5% | 1.5%-3.5% |
| Modifier/Thickening | | |
| Agent (e.g., an acrylic | | |
| thickener/rheological | | |
| modifying material) | | |
| Pigment | 0%-12% | 3.5%-10% |
| Other Ingredients* | 0%-8% | 0%-6% |
| Water | Balance to 100% | Balance to 100% |
| Viscosity | 40,000 centipoise- | 40,000 centipoise- |
| | 80,000 centipoise | 65,000 centipoise |

*“Other Ingredients” may include, for example, functional fillers (e.g., matting agent(s), coefficient of friction modifying agents, debubbling agents, etc., as discussed herein); inert fillers; etc.

As some more specific examples, a mid-range viscosity print media material 1320B in accordance with at least some examples of this technology may include (all percentages are percentages by weight based on the total weight of the print media material): (a) about 85.1% aqueous resin (e.g., an aqueous polyether polyurethane dispersion of the types described above in conjunction with print media material 120); (b) about 3.4% cross-linking material (e.g., a VOC-free water-based polycarbodiimide cross-linker of the types described above in conjunction with print media material 120); (c) about 0.3% alcohol (e.g., 2-amino-2-method-1-propanol); (d) 2.6% rheological modifier/thickening agent (e.g., an acrylic agent of the types described above in conjunction with print media material 120); (e) about 8.5% pigment (e.g., of the types described above in conjunction with print media material 120, such as a white pigment, for example, titanium dioxide); and (f) water (if needed) comprising the balance of the print media material (e.g., an amount sufficient to reach 100% by weight). This mixture may provide a viscosity of about 40,700 cp. The various amounts of the ingredients and/or the specific compositions used for an ingredient may be adjusted, as needed, to modulate one or more functional properties, such as viscosity.

Additional aspects of this technology relate to mid-range viscosity print media materials 1320B having compositions, ingredients, and combinations of ingredients of the types described above, including, but not limited to, mid-range viscosity print media materials 1320B having compositions falling within the scope of the table above.

Additionally or alternatively, as some more specific examples, the low viscosity print media material 1320C (for forming region 1302C in the example of FIG. 13A) may include (all percentages are percentages by weight based on the total weight of the print media material): (a) 75% to 95% by weight of the aqueous resin (e.g., an aqueous polyether polyurethane dispersion) described above; (b) 2.5% to 5% by weight of a cross-linker material of the types described above; (c) a pH stabilizer (e.g., alcohol, such as 2-amino-2-methyl-1-propanol), if needed; and (d) a rheological modifier (e.g., a thickening agent) of the types described above, if needed or as needed in a sufficient amount to make the viscosity within a range of 3500 centipoise to 10,000 centipoise (or within any of the ranges described above for the low viscosity print media material). If desired, a pigment also may be included in the low viscosity print media material. The amount of water included in the aqueous resin, the amount of pigment (if any), and/or the amount of other ingredients also may be altered to adjust and/or control the viscosity of the resulting print media material. In some examples, if no pigment is added, the low viscosity print media material may be clear (e.g., transparent).

As some additional examples, the low viscosity print media material 1320C in accordance with at least some examples of this technology may have the following ingredients and/or properties:

| | Range A - (all | Range B - (all |
|---|---|---|
| | Percentages are % By | Percentages are % By |
| | Weight based on Total | Weight Based on Total |
| Component/Property | Weight of Mixture) | Weight of Mixture) |
| Aqueous Resin (e.g., an | 75%-95% | 80%-90% |
| aqueous polyether | | |
| polyurethane dispersion) | | |
| Cross-Linking Material | 0%-5% | 0%-4% |
| (e.g., a VOC-free, water- | | |
| based, polycarbodiimide | | |
| crosslinker) | | |
| Alcohol (e.g., 2-amino- | 0%-0.6% | 0.1%-0.55% |
| 2-methyl-1-propanol) | | |
| Rheological | 0%-4.5% | 1.5%-4% |
| Modifier/Thickening | | |
| Agent (e.g., an acrylic | | |
| thickener/rheological | | |
| modifying material | | |
| and/or a water based | | |
| polyurethane type | | |
| thickener/rheological | | |
| modifying material) | | |
| Pigment | 0%-12% | 0%-10% |
| Defoaming Agent (e.g., a | 0%-2% | 0%-1% |
| debubbling agent, such | | |
| as silicone oil) | | |
| Other Ingredients* | 0%-8% | 0%-6% |
| Water | Balance to 100% | Balance to 100% |
| Viscosity | 3500 centipoise- | 10,000 centipoise- |
| | 20,000 centipoise | 20,000 centipoise |

*“Other Ingredients” may include, for example, functional fillers (e.g., matting agent(s), coefficient of friction modifying agents, etc., as discussed herein); inert fillers; etc.

Low viscosity print media materials of the types described in the Table above may be used for the print media material 1104M used to make topcoat layer 1104D described above in conjunction with FIGS. 11A and 11B. For at least print media materials 1104M, the pigment may be omitted and/or one or more “other ingredients,” such as functional fillers as described herein may be included, e.g., to provide desired properties.

As some more specific examples, a low range viscosity print media material 1320C in accordance with at least some examples of this technology may include (all percentages are percentages by weight based on the total weight of the print media material): (a) about 88.3% aqueous resin (e.g., an aqueous polyether polyurethane dispersion of the types described above in conjunction with print media material 120); (b) about 0.24% alcohol (e.g., 2-amino-2-method-1-propanol); (c) about 2.6% rheological modifier/thickening agent (e.g., with about half of this rheological modifier/thickening agent being an acrylic agent of the types described above in conjunction with print media material 120 and about half of this rheological modifier/thickening agent being a water-based polyurethane type rheological modifier/thickening agent); (d) about 8.5% pigment (e.g., of the types described above in conjunction with print media material 120, such as a white pigment, for example, titanium dioxide); (e) about 0.4% of a defoaming agent (e.g., a silicone based defoamer or debubbling agent); and (f) water (if needed) comprising the balance (e.g., an amount sufficient to reach 100% by weight). Another low range viscosity print media material 1320C in accordance with at least some examples of this technology may include (all percentages are percentages by weight based on the total weight of the print media material): (a) about 84.9% aqueous resin (e.g., an aqueous polyether polyurethane dispersion of the types described above in conjunction with print media material 120); (b) about 0.2% alcohol (e.g., 2-amino-2-method-1-propanol); (c) about 2.4% rheological modifier/thickening agent (e.g., with about half of this rheological modifier/thickening agent being an acrylic agent of the types described above in conjunction with print media material 120 and about half of this rheological modifier/thickening agent being a water-based polyurethane type rheological modifier/thickening agent); (d) about 8.2% pigment (e.g., of the types described above in conjunction with print media material 120, such as a white pigment, for example, titanium dioxide); (e) about 0.4% of a defoaming agent (e.g., a silicone based defoamer or debubbling agent); (f) about 3.6% cross-linker material (e.g., a VOC-free water-based polycarbodiimide cross-linker of the types described above in conjunction with print media material 120); and (g) water (if needed) comprising the balance (e.g., an amount sufficient to reach 100% by weight). The various amounts of the ingredients and/or the specific compositions used for an ingredient may be adjusted, as needed, to modulate one or more functional properties, such as viscosity.

Additional aspects of this technology relate to low viscosity print media materials 1320C having compositions, ingredients, and combinations of ingredients of the types described above, including, but not limited to, the viscosity print media materials 1320C having compositions falling within the scope of the table above.

FIG. 13B schematically illustrates steps of an example method of forming a component 1300 (e.g., a wearable component, such as a footwear upper component, another article of apparel, etc.) in accordance with at least some examples of this technology. The method steps in this example proceed from left-to-right and then top-to-bottom in the figure. As shown at the top left of FIG. 13B, the method starts by placing a substrate 1304 adjacent to a screen 1310 of a screen printing system and in a position to be screen printed. As shown, the screen 1310 includes openings through which print media material 1320A passes to be deposited on the substrate 1304. Squeegee 1312 is moved (shown by arrow 1314) to push high viscosity print media material 1320A through the screen 1310 openings to be deposited onto the substrate 1304. This action forms a layer (or a sub-layer) of the print media material 1320A having a first thickness on the substrate 1304. Once this layer (or sub-layer) is formed, the intermediate structure may be subjected to a drying step (e.g., by exposure to drying conditions, such as heated and/or moving air from a dryer 1316 for one or more minutes), as shown in the top center of FIG. 13B. This drying step may produce sufficient drying of the first print media material 1320A at this stage to maintain a stable structure (e.g., to maintain its shape, prevent smudging, etc.) as the screen printing process continues.

If a thicker layer of the first print media material 1320A is desired than that deposited in the first step, additional “sub-layers” of the first print media material 1320A may be deposited (with one sub-layer at least in part forming atop the surface of a previously printed sub-layer). This may be accomplished by repeating a series of screen print application steps. This series may include: (a) raising the screen 1310 with respect to the already deposited sub-layer as shown at the top right of FIG. 13B, (b) applying additional first print media material 1320A to the screen 1310 (if needed), and (c) repeating the processes of squeegeeing and drying as many times as needed—to form as many sub-layers as needed—to produce a desired thickness of the first print media material 1320A on the substrate 1304. See the top two rows of FIG. 13B resulting in the intermediate product 1330 with the region 1302A formed on the substrate 1304.

In at least some examples of this technology, the screen printing with the high viscosity print media material 1320A may use screens with a mesh size in the range of 60 to 180 (and in some examples, from 75 to 160 or 80 to 150) and/or screens with a lacquer thickness of 150 to 250 microns (and in some examples, 175 to 225 microns).

Once the desired layer or sub-layers of the first print media material region 1302A have been deposited, then an additional layer or multiple sub-layers of the mid-range viscosity print media material 1320B may be deposited. At least a portion of the mid-range viscosity print media material 1320B may be deposited on an exposed surface of the last layer or sub-layer of the first print media material 1320A. The beginning of this portion of the process is schematically illustrated at the left side of the third row in FIG. 13B.

As shown, this example method continues with the intermediate product 1330 including the first printed region 1302 thereon adjacent to a screen 1340 (which may be the same as screen 1310 or a different screen) and in a position to be screen printed. As shown, the screen 1340 includes openings through which print media material 1320B passes to be deposited over the substrate 1304 (e.g., onto at least a portion of a surface of the first print media material 1320A). Squeegee 1312 is moved (shown by arrow 1314) to push the mid-range viscosity print media material 1320B through the screen 1340 openings to be deposited, e.g., onto at least a portion of the first print media material 1320A. This action forms a layer (or a sub-layer) of the print media material 1320B having a first thickness on the first print media material 1320A. Once this layer (or sub-layer) is formed, the intermediate structure may be subjected to a drying step (e.g., by exposure to heated and/or moving air from a dryer 1316), as shown in the center of the third row of FIG. 13B. This drying step may produce sufficient drying of the second print media material 1320B at this stage to maintain a stable structure as the screen printing process continues.

If a thicker layer of the second print media material region 1320B is desired than that deposited in the previous step, additional sub-layers of the second print media material 1320B may be deposited (with one sub-layer forming at least in part atop the surface of a previously printed sub-layer). This may be accomplished by repeating a series of screen print application steps. This series may include: (a) raising the screen 1340 with respect to the already deposited sub-layer as shown at the right side of the third row FIG. 13B, (b) applying additional second print media material 1320B to the screen 1340 (if needed), and (c) repeating the processes of squeegeeing and drying as many times as needed—to form as many sub-layers as needed—to produce a desired thickness of the second print media material 1320B. See the third and fourth rows of FIG. 13B resulting in the intermediate product 1350 with the region 1302A formed on the substrate 1304 and the region 1302B formed at least in part on region 1302A.

In at least some examples of this technology, the screen printing with the mid-range viscosity print media material 1320B may use screens with a mesh size in the range of 60 to 180 (and in some examples, from 75 to 160 or 80 to 150) and/or screens with a lacquer thickness of 150 to 250 microns (and in some examples, 175 to 225 microns).

Once the desired layer or sub-layers of the second print media material 1320B have been deposited, then an additional layer or multiple sub-layers of the low viscosity print media material 1320C may be deposited in a similar manner (e.g., including the squeegee step and an intermediate drying step, if needed). At least a portion of the low viscosity print media material 1320C may be deposited on an exposed surface of the last layer or sub-layer of the second print media material 1320B. This is shown schematically at the bottom row of FIG. 13B. After all layers or sub-layers of the third print media material 1320C are deposited, the final structure can be dried and/or cured (e.g., using the conditions described above for forming printed elements 102 from print media material 120), e.g., to form the component 1300 shown at the bottom right of FIG. 13B and in FIG. 13A.

In at least some examples of this technology, the screen printing with the low viscosity print media material 1320C may use screens with a mesh size in the range of 60 to 180 (and in some examples, 75 to 160 or 80 to 150) and/or screens with a lacquer thickness of 150 to 250 microns (and in some examples, 175 to 225 microns).

In at least some examples of this technology, one or more of the first print media material 1320A, the second print media material 1320B, and/or the third print media material 1320C may be degassed and/or debubbled, e.g., exposed to vacuum pressure, to remove at least some gas from the material or to eliminate voids in the material prior to use of the material in the screen printing steps described above in conjunction with FIG. 13B. The degassing, debubbling, and/or vacuum conditions may be the same as or similar to those described above for print media material 120.

Additionally or alternatively, in at least some examples of this technology, if needed, one or more of the first print media material 1320A, the second print media material 1320B, and/or the third print media material 1320C may include one or more debubbling agents (also called “defoaming agents”) therein. Bubbles can be introduced into printed structures during screen printing processes, such as when squeegee is moved across the screen mesh and/or when the screen is peeled from the printed surface. These bubbles can adversely affect the appearance and/or physical properties of the printed components. Thus, in at least some examples of this technology, one or more debubbling agents may be added to the print media material(s) 1320A, 1320B, and/or 1320C. Examples of suitable debubbling agents may include mineral oils or silicone oils, which may be present, for example, in amounts up to about 2% by weight (e.g., from 0.25 to 2% by weight) based on the total weight of the print media material 1320A, 1320B, and/or 1320C. One example of a suitable debubbling agent (or defoaming agent) may include Permutex® DF-13-617, a silicone based defoamer available from Stahl. A debubbling agent need not be present in all of the print media material viscosity ranges.

Additionally or alternatively, in some examples of this technology, the debubbling agent can be omitted. In still some additional or alternative examples of this technology, the amount of debubbling agent can be controlled and/or adjusted, e.g., to provide different and/or desired aesthetics and/or different and/or desired functionality.

Aspects of the present technology relating to screen printing techniques of the types described in conjunction with FIGS. 13A and 13B may allow three-dimensional elements (e.g., ball receiving region elements and/or ball propelling region elements of the types described above; graphic elements; etc.) to be formed on a substrate 1304 relatively efficiently. The high viscosity print media material 1320A allows the z-height (or thickness) of the printed elements 1302 to be built up relatively quickly (e.g., in fewer screen printing steps), but the printed regions 1302A formed from the high viscosity print media material 1320A may have screen marks and/or may not be as smooth and/or clear as desired. But overlaying that high viscosity print media material 1320A with the mid-range viscosity print media material 1320B can produce a smoother surface and potentially improve the appearance of the printed elements 1302. The low viscosity print media material 1320C can further smooth the surface, provide a further protective layer, and/or provide other desired properties and/or features.

In at least some examples of this technology, the printed elements 1302 may have a thickness (or z-height dimension) of at least 0.15 mm (and in some examples, at least 0.2 mm, at least 0.25 mm, at least 0.5 mm, at least 1 mm). The printed elements 1302 may provide the desired grip or coefficient of friction properties for use in ball receiving regions and/or ball propelling regions of footwear uppers, e.g., as described above, with good aesthetics.

Providing pigments in the high viscosity print media material 1320A and/or the mid-range print media material 1320B in products of the types described in conjunction with FIGS. 13A and 13B may provide certain advantages. For example, by providing pigment in one or both of these lower layers, the color may remain more consistent over a longer period of use, e.g., as the printed elements 1302 erode away over time (e.g., due to a footwear upper contacting a ball or other objects in use). In this manner, the product aesthetic may be improved and remain more consistent over a longer period of use, giving a user confidence that the product remains in good condition for continued use.

The features of the examples described above in conjunction with FIGS. 13A and 13B may be used to create ball receiving regions and/or ball propelling regions of a footwear upper, e.g., of any of the various types described above in conjunction with FIGS. 1A-12F. Alternatively, the features of the examples described above in conjunction with FIGS. 13A and 13B may be used on substrates (e.g., textile elements) for other products, such as articles of apparel.

FIG. 14 illustrates another example component 1400 (e.g., a wearable component, such as a footwear upper component or another article of apparel of the types generally described above) in accordance with some examples of this technology. Where the same reference numbers are used in FIG. 14 as used in FIGS. 13A and/or 13B, the same or similar parts are being referenced, and much of the repetitive description thereof may be omitted.

The example component 1400 of FIG. 14 includes a substrate 1304 with one or more printed elements 1402 formed thereon. The substrate 1304 may be made from any of the materials, any of the components, and/or have any of the features of substrates 104 and/or 1304 (e.g., upper base member 204) described above in conjunction with FIGS. 1A-13B (including a multi-layered construction with two or more of layers 1104A-1104E as described above in conjunction with FIGS. 11A-11B). As some more specific examples, the substrate 1304 may comprise: a textile; a polyurethane component; a polyvinylchloride component; a synthetic leather component; a woven textile component; a knitted textile component; or a non-woven textile component.

The printed elements 1402 in the example component 1400 shown in FIG. 14 include two distinct portions: (a) a first region 1402A (the darker shaded, bottom region of printed elements 1402 shown in FIG. 14 located closest to the substrate 1304) formed from a first print media material having a “mid-range” viscosity; and (b) a second region 1402B (the lighter shaded, top region of printed elements 1402 shown in FIG. 14) formed from a second print media material having a “low” viscosity. The mid-range viscosity print media material used to form the first region 1402A may have any of the features of print media material 1320B used to form second region 1302B described above in conjunction with FIGS. 13A and 13B. Additionally or alternatively, the low viscosity print media material used to form the second region 1402B may have any of the features of print media material 1320C used to form third region 1302C described above in conjunction with FIGS. 13A and 13B.

The component 1400 of FIG. 14 may be made by the same general screen printing processes described above in conjunction with FIG. 13B, except that the initial steps of screen printing the first print media material 1320A are omitted. Rather, the mid-range viscosity print media material 1320B may be screen printed onto a surface of the substrate 1304, and the low viscosity print media material 1320C may be printed onto at least a portion of the surface of the mid-range viscosity print media material 1320B.

While not required, in some examples of this technology, as also shown in FIG. 14, one or more screen printed elements 1402 of the types described above in conjunction with FIG. 14 may be produced or provided on the same substrate 1304 as one or more screen printed elements 1302 of the types described above in conjunction with FIGS. 13A and 13B. The printed element(s) 1302 and/or 1402 may take on any sizes, shapes, orientations, relative positioning, etc., in various specific examples of this technology.

The features of the examples described above in conjunction with FIG. 14 may be used to create ball receiving regions and/or ball propelling regions of a footwear upper, e.g., of any of the various types described above in conjunction with FIGS. 1A-13B.

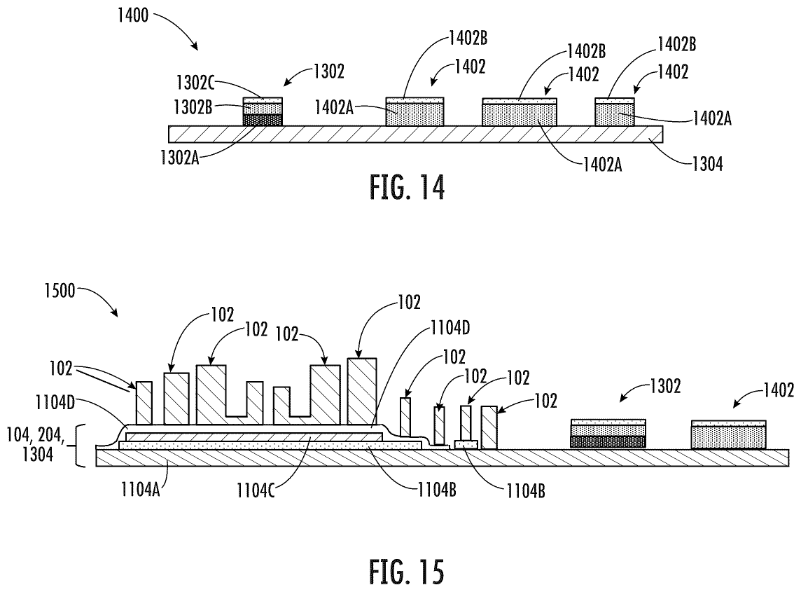

FIG. 15 illustrates another example component 1500 (e.g., a wearable component, such as a footwear upper component or another article of apparel of the types generally described above) in accordance with some examples of this technology. Where the same reference numbers are used in FIG. 15 as used in any of FIGS. 1A-14, the same or similar parts are being referenced, and much of the repetitive description thereof may be omitted.

FIG. 15 schematically shows an example component 1500 with a substrate 104, 1304 (e.g., upper base member 204) having multiple different types and constructions of printed elements 102, 1302, and 1402 thereon. As evident from this figure, components 1500 in accordance with at least some examples of this technology may include one or more of: (a) one or more jetted printed elements 102 of the types shown and described above in conjunction with FIGS. 1A-12F; (b) one or more screen printed elements 1302 of the types shown and described above in conjunction with FIGS. 13A-13B; and/or (c) one or more screen printed elements 1402 of the types shown and described above in conjunction with FIG. 14. A single substrate 104, 1304 (e.g., upper base member 204) may include any numbers of one or more of these printed elements 102, 1302, and/or 1402 in any combination and/or in any arrangement. The printed element(s) 102, 1302, and/or 1402 may take on any sizes, shapes, orientations, relative positioning, etc., in various specific examples of this technology.

The features of the examples described above in conjunction with FIG. 15 may be used to create ball receiving regions and/or ball propelling regions of a footwear upper, e.g., of any of the various types described above in conjunction with FIGS. 1A-14.

When used for forming footwear upper components, in at least some examples of this technology, screen printing using any of the print media materials described above (e.g., 1320A, 1320B, and/or 1320C) may be performed so that the bite line region along the bottom edge of the upper (e.g., the bottom 1.5 mm to 4 mm around the bottom edge of the upper and/or at locations where the upper meets (and/or may be bonded to) a sole component) may remain free of screen printing. This may help assure more secure bonding between the upper and any sole component to which it is to be attached.

As described herein, print media materials (e.g., 120, 1104M, 1320A, 1320B, and 1320C) in accordance with aspects of this technology and used in accordance with aspects of this technology include an aqueous polyurethane dispersion (e.g., an aqueous polyether polyurethane dispersion) as a base ingredient. As described herein (e.g., in the Tables above and the discussion relating to the content of the compositions), such print media materials (e.g., 120, 1104M, 1320A, 1320B, and 1320C) also may include one or more of the following (e.g., with components of the various types and/or in the various amounts described herein): (a) cross-linking material(s); (b) rheological modifier(s); (c) alcohol; (d) pigment(s); (e) debubbling agent(s); and/or (f) functional filler(s) (e.g., matting agent(s), coefficient of friction modifying agent(s), etc.).

When first applied to a substrate (by the printing (jetting and/or screen printing) techniques described herein), the printed structures or printed elements (e.g., 102, 202, 202B, 202C, 202D, 202E, 302, 602, 802, 902, 1104D, 1302, 1402) may include all of their initial ingredients from the print media material as applied. For example, when first applied to a substrate, the printed structures or printed elements may include: (A) the polyurethane component from the dispersion (e.g., a polyether polyurethane component from the dispersion), (B) water (e.g., from the dispersion and/or introduced into the print media material with some other ingredients), (C) cross-linking material(s) (if present in the print media material applied), (D) rheological modifier(s) (if present in the print media material applied), (E) alcohol (if present in the print media material applied), (F) pigment(s) (if present in the print media material applied), (G) debubbling agent(s) (if present in the print media material applied), and/or (H) functional filler(s) (e.g., matting agent(s), coefficient of friction modifying agent(s), etc.) (if present in the print media material applied).

Drying and/or cross-linking, however, may alter the overall composition of the printed structures or printed elements (e.g., 102, 202, 202B, 202C, 202D, 202E, 302, 602, 802, 902, 1104D, 1302, 1402) on the substrate (as compared to the print media material as applied). “Dried” and/or “cross-linked” printed elements, as those terms are used herein, include components having at least a polyurethane component (e.g., a polyether polyurethane containing component) and in some examples, a polyurethane component (e.g., a polyether polyurethane containing component) that is cross-linked via the cross-linking material that was included in the print media material (a “cross-linked” polyurethane component (which includes a “cross-linked” polyether polyurethane component)). Although some water may be present in the dried and/or cross-linked printed elements, in at least some examples of this technology, much (up to all) of the water may be removed from the dried and/or cross-linked structures, e.g., by the drying and/or cross-linking steps. Additionally or alternatively, if present in the initial print media material, some alcohol may be present in the dried and/or cross-linked printed elements, in at least some examples of this technology. But much (up to all) of the alcohol may be removed from the dried and/or cross-linked printed element structures, e.g., by the drying and/or cross-linking steps.

Although not required, in some examples, some cross-linker material (e.g., unused cross-linker material and/or excess cross-linker material from the dispersion) may remain in the dried and/or cross-linked printed elements (e.g., cross-linker material that is not included in the cross-linked polyurethane component (e.g., the “cross-linked” polyether polyurethane component) structures). The presence of such cross-linker material (that is not included in the cross-linked polyurethane component) may depend, for example, on the degree of cross-linking achieved during the cross-linking step and/or whether an excess of cross-linker material was present in the initial print media material.

Additionally or alternatively, rheological modifier(s), if any were present in the initial print media material, may remain in the dried and/or cross-linked printed elements.

Additionally or alternatively, pigment(s), if any were present in the initial print media material, may remain in the dried and/or cross-linked printed elements.

Additionally or alternatively, debubbling agent(s), if any were present in the initial print media material, may remain in the dried and/or cross-linked printed elements.

Additionally or alternatively, the functional filler(s) (e.g., matting agent(s) and/or coefficient of friction modifying agent(s), etc.), if any were present in the initial print media material, may remain in the dried and/or cross-linked printed elements.

In both jetting processes and screen printing processes of the types described above, bubbles may form and “degassing” or “debubbling” may become necessary or otherwise beneficial. Gas bubbles can become trapped in and/or formed in a print media material 120, 1104M, 1320A, 1320B, 1320C in various different ways and at various different stages of a jetting and/or screen printing process. Reference number 1104M is used herein to refer to a print media material used to form topcoat layer 1104D, e.g., in the example processes described above in conjunction with FIGS. 11A and 11B,

For example, when mixing the print media mixture ingredients to form the print media material 120, 1104M, 1320A, 1320B, 1320C to be jetted and/or screen printed, air can become trapped in the print media mixture when mixing different ingredients (such as the rheological modifier) into the aqueous polyurethane dispersion. As the viscosity of the mixture rises, the viscosity can become high enough so that gas bubbles do not rise to the top and get released from the mixture. This may be especially present in print media mixtures and print media materials 120, 1320A with high viscosities, such as viscosities of 100,000 cp or higher. In at least some cases for print media materials having a mid-range viscosity (e.g., from 40,000 cp to 80,000 cp, such as 1320B) and/or a low viscosity (such as 1104M, 1320C), adding a debubbling agent (e.g., of the types described above, such as mineral oils or silicone oil, in amounts up to 2% by weight) into the print media mixture may be sufficient to induce the bubbles to rise to a surface and release. For high viscosity print media mixtures and print media materials (such as 120, 1320A, e.g., for jetting or screen printing), while a debubbling agent may be included, a debubbling agent alone may not be sufficient to adequately suppress bubble or void formation.

For any print media mixture and/or print media material (e.g., 120, 1104M, 1320A, 1320B, 1320C) of the types described herein, irrespective of its viscosity, a filtering step after mixing ingredients together may be included. After the print media mixture is formed, a filtering step can take place to provide at least some degassing and/or debubbling function. More specifically, filtering may help remove bubbles due to agglomeration of bubbles during the filtering process. Such filtering may be included, e.g., at least when forming print media material 120 used for jetting, high viscosity print media material 1320A (e.g., for screen printing), and/or mid-range viscosity print media material 1320B (e.g., for screen printing processes), although, as noted above, filtering may be used with any viscosity print media material.

Additionally or alternatively, for any print media mixture and/or print media material (e.g., 120, 1104M, 1320A, 1320B, 1320C) of the types described herein, irrespective of its viscosity, a vacuum degassing and/or debubbling step after mixing may be included. Vacuum degassing and/or debubbling may be accomplished in any suitable manner. As one example, a volume of the print media material (e.g., 120, 1104M, 1320A, 1320B, 1320C) may be exposed to vacuum conditions for a period of time, e.g., exposing 1 kg of print media material to vacuum (e.g., 300-650 Torr) for 3-5 minutes. The vacuum conditions may help entrapped gas (e.g., bubbles) in the print media mixture and/or print media material move to the material surface and out of the print media mixture and/or print media material due to the lowered surrounding vacuum pressure.

For mid-range viscosity print media material (e.g., 1320B, print media material having a viscosity of 40,000 cp to 70,000 cp, etc.), which may be used to form at least some thick layers (e.g., note the methods described above in conjunction with FIGS. 13A-14), a debubbling agent alone (e.g., of the types described above, such as mineral oils or silicone oil, in amounts up to 2% by weight) may be sufficient to provide adequate degassing and inhibit bubble formation. In other words, for such mid-range print media material 1320B, it may not be necessary to include a vacuum degassing and/or debubbling step and/or a filtering degassing step. Gas (e.g., air) may have the ability to work its way to the surface and out of the material without the need for these additional steps. But, additional vacuum and/or filtering degassing and/or debubbling steps may be used for such mid-range viscosity print media material 1320B, if necessary.

For lower viscosity print media material (e.g., print media material 1320C and/or any print media material having a viscosity below 40,000 cp), a debubbling agent alone (e.g., of the types described above, such as mineral oils or silicone oil, in amounts up to 2% by weight) may be sufficient to provide adequate degassing and inhibit bubble formation. In other words, for such print media material (below 40,000 cp), it may not be necessary to include a vacuum degassing and/or debubbling step and/or a filtering degassing and/or debubbling step. Gas (e.g., air) may have the ability to work its way to the surface and out of the material without the need for these additional steps. But, additional vacuum and/or filtering degassing and/or debubbling steps may be used for such lower viscosity print media material, if necessary.

These degassing steps (e.g., one or more of inclusion of a debubbling agent, filtering, and/or vacuum debubbling) may be useful to help avoid bubble formation in the final printed structures 102, 1302, 1402.

Gas (e.g., air) also can become entrained and/or entrapped in printed structures 102, 1302, 1402 during the printing processes. For example, during jetting processes, there is some chance that gas will be entrapped within the printed structures 102 as the high viscosity print media material 120 lands on the substrate 104 and/or on previously printed features. This entrapped gas may present as bubbles within the printed structures 102, particularly if the substrate 104 on which the print media material 120 lands is gas impermeable (so that the entrapped gas is not able to migrate out through a surface of the substrate 104). But typically, the amount of gas trapped as a result of this process is quite low.

Additionally or alternatively, during jetting, gases dissolved or entrapped in the print media material 120 may try to escape when the viscosity of the print media material 120 is lowered due to shear forces experienced at the jet nozzle 110 (from the piezoelectric actuator) and/or higher temperatures experienced at the print head 108. But typically, the amount of gas trapped in print media material 120 as a result of this process also is quite low.

Thus, the degassing and/or debubbling steps described above (e.g., debubbling agent, applying a vacuum, and/or filtering), particularly for high viscosity print media material 120 used in jetting, may help reduce and/or keep bubbling at a minimum as the print media material 120 is being formed and the printed structures 102 are being applied to the substrate 104 (e.g., during the actual jeffing steps described above).

In the case of screen printing processes, as the print media material (e.g., 1104M, 1320A, 1320B, 1320C) is moved across and through the screen, there is a chance of air getting trapped during the printing process or during the lifting of the screen. In at least some examples of this technology, the presence of a debubbling agent in the print media material (and/or the vacuum debubbling and/or filtering, if conducted), as described above, may help prevent or reduce air entrapment and avoid bubble formation in the printed structures 1302, 1402 and/or topcoat layer 1104D.

In at least some examples of this technology, bubbles also can form as the print media material 120, 1104M, 1320A, 1320B, 1320C is being dried. The various print media materials 120, 1104M, 1320A, 1320B, 1320C described herein, formed from an aqueous polyurethane dispersion (e.g., such as a polyether polyurethane dispersion), contain a significant amount of water (e.g., about 40% water) when applied to a substrate 104. During drying steps (for either or both of jetting processes and/or screen printing processes), water starts to evaporate and depart the printed structures 102, 1302, 1402 and/or topcoat layer 1104D. At the same time, polymer film formation has started (i.e., the printed structures 102, 1302, 1402 and/or topcoat layer 1104D solidify). If the printed structures 102, 1302, 1402 are subjected to a very fast drying process (e.g., high temperatures), the evaporating water may agglomerate and appear as bubbles.

At least some aspects of this technology relate to features to reduce and/or eliminate bubble or void formation during such drying steps.

In accordance with at least some examples of this technology, drying the print media material 120, 1104M, 1320A, 1320B, 1320C in the printed structures 102, 1302, 1402 and/or topcoat layer 1104D slowly, followed by an extended drying period at ambient temperatures and conditions, can help reduce and/or eliminate bubble or void formation in the dried printed structures 102, 1302, 1402 and/or topcoat layer 1104D. As some more specific examples, a drying recipe may include: (A) an initial step of drying at about 60 degrees C. (e.g., ±10 degrees C.) for 5 minutes to an hour, followed by (B) a longer, ambient air drying step (e.g., three to seven days). Additional curing and/or cross-linking steps, if needed, may take place after these initial drying steps. As some examples, the curing and/or cross-linking steps may include exposure to about 80 degrees C. (e.g., ±10 degrees C.) for a relatively short time (e.g., 5 to 10 minutes). These drying (and curing and/or cross-linking) techniques may be used for printed structures formed by both jetting techniques and/or screen printing techniques described herein, but they may be particularly useful for printed structures formed from high viscosity print media materials 120, 1320A and/or thicker printed structures 102, 1302, 1402.

In the case of screen printing with thin lacquer coating, the layer of print media material laid down on the substrate 104 will be very thin. Typically, when such thin layers of print media material (e.g., 1104M, 1320B, 1320C) are dried, whether dried fast or slow, the water departing the print media material 120 will not form significant bubbles or voids.

Thus, in accordance with at least some aspects of this technology, the drying technique or during recipe used may depend, at least in part, on a thickness of the print media material (or a thickness of the printed structure) on the substrate to be dried. As some examples, for print media material 120, 1104M, 1320B, 1320C layers that are less than 0.25 mm thick and/or that are formed from mid-range viscosity or low viscosity print media material 120, 1104M, 1320C, 1320C, no special drying features or techniques may be needed and/or a fast (or faster) drying step may be used. Faster drying steps may include exposure to temperatures greater than 65 degrees C. and/or exposure to heated and/or moving gas (e.g., air). A debubbling agent in these mid-range and/or low viscosity print media materials (e.g., 1104M, 1320B, 1320C, 1402A, 1402B) may be sufficient to reduce or avoid bubble and/or void formation.

In at least some examples of this technology, however, for print media material 120 layers that are 0.25 mm thick or greater (irrespective of the viscosity of the applied print media material) and/or that are formed from high viscosity print media material 120 (such as printed structures 102 formed by jetting processes and/or with high viscosity print media material 1320A in a screen printing process), a slow drying process of the types described above may be useful to prevent and/or reduce bubble and/or void formation. Such slow drying processes may include: (A) an initial step of drying at about 60 degrees C. (e.g., ±10 degrees C.) for 5 minutes to an hour, followed by (B) a longer, ambient air drying step (e.g., three to seven days).

While much of the specific discussion above relates to substrates formed as footwear components (e.g., footwear uppers), those skilled in the art, given benefit of this disclosure, will recognize that features of printed elements, substrates with printed elements formed thereon, products, and/or methods described above in conjunction with FIGS. 1A-15 may be applied to substrates for other products and/or purposes and uses as well, such as textiles and fabrics for articles of apparel, substrates for products having other uses, etc. Thus, at least some aspects of this technology are not limited to use in forming footwear components, such as footwear uppers.

The discussion above mentions the “solids content” of various materials. The solids content of a component may be determined in conventional manners, e.g., in general by: (a) determining the weight of the starting material (Ws); (b) heating the starting material to drive off water and/or other liquids; (c) weighing the dried product (Wd); and (d) determining the solids content as [(Ws−Wd)/Ws]×100 (solids content expressed as a percent). One more specific protocol that may be used for determining solids content of various components described herein includes: (a) determining the weight of a container or support (Wa) in and/or on which the material will be held (i.e., weigh the empty container or support); (b) placing a sample of the starting material in/on the container or support; (c) determining a total weight (W1) of the sample plus container or support; (d) place sample in oven and dry (e.g., a two step drying protocol may be used with a first drying step at 105 degrees C.±2 degrees C. for 30 minutes followed by a second drying step at 150 degrees C.±2 degrees C. for 1 hour); (e) after cool down, determining a total weight (W2) of the dried sample in/on the container or support; and (f) determining the solid content as follows: [(W2−Wa)/(W1−Wa)]×100.

Viscosity of various materials described herein may be measured in conventional manners using a commercially available viscometer, such as Brookfield LV DV-II+Pro or Brookfield LV DV2T viscometers available from Ametek, Inc. Viscosity may be measured at 25 degrees C.±1 degrees C. An appropriate spindle (e.g., RH6 or RH7 spindle) and/or rotational speed (RPMs) may be selected, e.g., depending on the general thickness of the mixture, equipment manufacturer recommendations, and/or through routine experimentation. One suitable protocol may include: (a) place a sample to be measured (e.g., 200 ml) in a beaker; (b) place the beaker in a thermostatic bath to stabilize temperature (e.g., 25 degrees C.±1 degrees C.); (c) select spindle and rotational speed; (d) using the viscometer, rotate the spindle in the material (with the spindle disk and/or plate fully submerged at the center of the sample); and (e) record measured results provided by the viscometer. If necessary or desired, the spindle may be oriented at an angle (e.g., 45 degrees from horizontal), e.g., to reduce or eliminate bubble formation.

This application also describes features of the “coefficient of friction” of various components. Coefficient of friction information of interest in at least some examples of this technology relates to the coefficient of friction of a component (e.g., a footwear upper component, some of which may have a printed structure thereon in accordance with aspects of this technology) with respect to a surface that it will contact (e.g., a game ball surface). Additional coefficient of friction information of interest in at least some examples of this technology relates to a comparison of: (A) the coefficient of friction of a first component (e.g., a substrate with one or more printed structures thereon—“Component A”) with respect to a base surface that it will contact (e.g., a game ball—“Base Surface”) versus (B) the coefficient of friction of a second component (e.g., a substrate having all of the same features but without the one or more printed structures thereon—Component B) with respect to that same Base Surface.

For relative comparisons of (A) the coefficient of friction of Component A with respect to the Base Surface with (B) the coefficient of friction of Component B with respect to the Base Surface, any suitable coefficient of friction testing or measuring protocol can be used, e.g., to determine whether one Component has an “increased” or “greater” coefficient of friction or “grippiness” with respect to the Base Surface or a “decreased” or “lower” coefficient of friction or “grippiness” with respect to the Base Surface as compared to the other Component, provided the same testing conditions are used for each Component.

As some more specific examples, “coefficients of friction” can be measured using a “sled-and-plane” method, such as the methods described in ASTM D1894. Such methods measure the force required to move a movable “sled” (e.g., having a surface including a first material, such as a game ball surface or the Base Surface described above) along a horizontal surface formed from the material of the component being tested (e.g., the component whose coefficient of friction is being measured, such as Component A or Component B described above). As one specific testing or measuring protocol that may be used in accordance with examples of this technology, the method may include: (A) applying a material of the Base Surface to a movable sled (e.g., using double sided tape or other appropriate attachment mechanism)—the sled plus Base Surface may have a mass of about 1.74 kg); (B) mounting a sheet of the material to be tested (e.g., formed from Component A above) to a horizontal test bed (e.g., securing it in place with double sided tape or other appropriate manner); (C) placing the sled on the sheet so that the Base Surface contacts the material to be tested (e.g., on the surface of Component A); and (D) measuring the force (e.g., in kgf) required to (i) initiate movement of the sled (representing the “static coefficient of friction”) and/or (ii) maintain movement of the sled, e.g., at a constant speed (e.g., 300 mm/minute) (representing the “dynamic coefficient of friction).

To compare the coefficient of friction of two components and/or the relative coefficients of friction of two components (e.g., comparing Component A and Component B above), the above sled-and-plane method may be conducted on both a test surface formed from Component A and a test surface formed from Component B using the same sled or two sleds having the same features (having the Base Surface applied thereon), under otherwise the same relevant testing conditions. Coefficients of friction can be measured and compared under a variety of test conditions. For example, coefficients of friction can be measured under dry conditions (e.g., with the surface(s) of Component A and/or Component B dry); under “wet conditions (e.g., the surface(s) of Component A and/or Component B sprayed with water); in multiple directions across the surfaces of Component A and/or B (e.g., in directions oriented 90 degrees with respect to one another, to account for differences induced by surface texturing or features on Component A, Component B, or the Base Surface); etc.

This application also describes components having “particle size” features. Particle size may be determined in any appropriate manner, e.g., by ASTM E3247, by a dynamic light scattering method using particle size measure equipment available from Malvern Panalytical, etc.

This application also describes features of “stretchability” and/or “elasticity” of various components. Stretchability and/or elasticity of interest in at least some examples of this technology relates to the stretchability and/or elasticity of one component (e.g., a footwear upper component, some of which may have a printed structure thereon in accordance with aspects of this technology-Component A) as compared to another component (Component B, e.g., a footwear upper component of the same structure but without the printed structure thereon). For such relative comparisons of (A) the stretchability and/or elasticity of Component A with Component B, any suitable stretchability and/or elasticity testing or measuring protocol can be used, e.g., to determine whether Component A has the same or substantially the same stretchability or elasticity as Component B, provided the same testing conditions are used for each Component. As a more specific examples, elasticity may be measured as described in ASTM D882; stretchability may be measured based on a standard percent elongation test of a sample; etc.

For avoidance of doubt, this invention includes within its scope at least the information described in one or more of the following Clauses:

Clause 1. A method, comprising: (A) loading material into a jetting device, the material forming a print media mixture including at least: a polyurethane material, water, a cross-linker material, a rheological modifier, and an alcohol, wherein the print media mixture forms a non-Newtonian fluid; (B) applying shear force to the print media mixture and ejecting a series of discrete volumes of the print media mixture from a nozzle of the jetting device as a series of separated print media material dots, wherein the shear force causes a reduction in viscosity of the print media mixture to facilitate movement of the print media material dots through the nozzle; and (C) placing a surface of a substrate at a location to receive the series of separated print media material dots ejected from the nozzle, wherein the print media material dots adhere to mechanically fix with and/or to bond with at least one of the surface of the substrate and previously deposited print media material on the surface to form an overlay material located on the surface of the substrate.

Clause 2. The method according to Clause 1, wherein the surface of the substrate comprises a woven textile, a knitted textile, a non-woven textile, or a synthetic leather material.

Clause 3. The method according to Clause 1 or 2, wherein the surface of the substrate includes at least one member selected from the group of: a polyurethane material, a thermoplastic polyurethane material, a polyester material, and a polyethylene terephthalate material.

Clause 4. The method according to any one of Clauses 1 to 3, wherein the print media mixture comprises a polyether polyurethane dispersion.

Clause 5. The method according to any one of Clauses 1 to 4, wherein polyurethane particles in the print media mixture have an average diameter of 20 to 40 microns.

Clause 6. The method according to any one of Clauses 1 to 5, wherein the print media mixture contains at least 40% solids.

Clause 7. The method according to any one of Clauses 1 to 5, wherein the print media mixture contains at least 50% solids.

Clause 8. The method according to any one of Clauses 1 to 5, wherein the print media mixture contains at least 60% solids.

Clause 9. The method according to any one of Clauses 1 to 8, wherein the cross-linker material includes an isocyanate.

Clause 10. The method according to any one of Clauses 1 to 8, wherein the cross-linker material includes a carbodiimide.

Clause 11. The method according to any one of Clauses 1 to 8 or 10, wherein the cross-linker material includes a polycarbodiimide material within a range of 1.5% to 5.5% by weight based on a total weight of the print media mixture and/or the print media material.

Clause 12. The method according to any one of Clauses 1 to 11, wherein the alcohol includes aminomethyl propanol.

Clause 13. The method according to Clause 12, wherein the aminomethyl propanol is present in the print media mixture within a range of 0.075% to 4.5% by weight based on a total weight of the print media mixture and/or the print media material.

Clause 14. The method according to any one of Clauses 1 to 13, wherein the rheological modifier comprises a thickener.

Clause 15. The method according to Clause 14, wherein the thickener comprises an acrylic thickener material.

Clause 16. The method according to Clause 15, wherein the acrylic thickener material is present in the print media mixture within a range of 0.25% to 5% by weight based on a total weight of the print media mixture and/or the print media material.

Clause 17. The method according to any one of Clauses 1 to 16, wherein the print media material further includes one or more pigments.

Clause 18. The method according to any one of Clauses 1 to 17, wherein when not exposed to shear force, the print media mixture within the jetting device has a viscosity within a range of 550 centipoise to 190,000 centipoise.

Clause 19. The method according to any one of Clauses 1 to 17, wherein when not exposed to shear force, the print media mixture within the jetting device has a viscosity of at least 80,000 centipoise.

Clause 20. The method according to any one of Clauses 1 to 17, wherein when not exposed to shear force, the print media mixture within the jetting device has a viscosity of at least 85,000 centipoise.

Clause 21. The method according to any one of Clauses 1 to 20, further comprising drying the overlay material to remove at least some water.

Clause 22. The method according to Clause 21, wherein the drying includes air drying.

Clause 23. The method according to Clause 21, wherein the drying includes passing the substrate with the overlay material received thereon through a drying tunnel.

Clause 24. The method according to Clause 21, wherein the drying includes exposing the substrate with the overlay material located thereon to at least one of heat, moving gas, or heated moving gas.

Clause 25. The method according to Clause 21, wherein after drying, heating the overlay material to activate cross-linking via the cross-linker material.

Clause 26. The method according to any one of Clauses 1 to 24, further comprising exposing the overlay material to conditions that activate cross-linking via the cross-linker material.

Clause 27. The method according to Clause 25 or 26, wherein after cross-linking, the overlay material comprises a thermoset material.

Clause 28. The method according to any one of Clauses 1 to 27, wherein a distance between the surface of the substrate and the nozzle varies as the series of separated print media material dots are being ejected from the nozzle.

Clause 29. The method according to Clause 28, wherein the distance varies within an amount found within a range extending from 15 mm to 35 mm as the series of separated print media material dots are being ejected from the nozzle.

Clause 30. The method according to Clause 28 or 29, wherein a difference in the distance at a first location on the surface of the substrate and the distance at a second location on the surface of the substrate is at least 3 mm, wherein the first location and the second location are located within 5 mm of one another.

Clause 31. The method according to any one of Clauses 28 to 30, wherein the distance varies, at least in part, due to a surface contour on the surface of the substrate.

Clause 32. The method according to any one of Clauses 1 to 31, wherein the overlay material located on the surface of the substrate forms a plurality of spaced apart overlay material structures.

Clause 33. The method according to Clause 32, wherein each overlay material structure of the plurality of spaced apart overlay material structures comprises multiple separate print material dots ejected from the nozzle.

Clause 34. The method according to Clause 32 or 33, wherein the plurality of spaced apart overlay material structures vary in size over an overall surface area of the substrate.

Clause 35. The method according to any one of Clauses 32 to 34, wherein spacing distances between adjacent spaced apart overlay material structures vary on the substrate.

Clause 36. The method according to any one of Clauses 1 to 31, wherein the overlay material located on the surface of the substrate forms a first continuous web of interconnected segments, wherein the first continuous web spans a surface area of at least 25 cm² on the surface of the substrate.

Clause 37. The method according to Clause 36, wherein the first continuous web spans a surface area of at least 50 cm² on the surface of the substrate.

Clause 38. The method according to Clause 1, wherein the print media mixture includes: (a) an aqueous polyether polyurethane dispersion as the polyurethane material and at least some portion of the water, wherein the aqueous polyether polyurethane dispersion has at least 40% solids, (b) an isocyanate or carbodiimide material as the cross-linker material, (c) an acrylic thickener as the rheological modifier, and (d) an aminoalkyl alcohol as the alcohol.

Clause 39. The method according to Clause 38, wherein the cross-linker material includes a polycarbodiimide material within a range of 1.5% to 5.5% by weight based on a total weight of the print media mixture and/or the print media material.

Clause 40. The method according to Clause 38 or 39, wherein the aminoalkyl alcohol comprises aminomethyl propanol present in the print media mixture within a range of 0.075% to 4.5% by weight based on a total weight of the print media mixture and/or the print media material.

Clause 41. The method according to any one of Clauses 38 to 40, wherein the acrylic thickener is present in the print media mixture within a range of 0.25% to 5% by weight based on a total weight of the print media mixture and/or the print media material.

Clause 42. The method according to any one of Clauses 38 to 41, wherein when not exposed to shear force, the print media mixture within the jetting device has a viscosity within a range of 550 centipoise to 190,000 centipoise.

Clause 43. The method according to any one of Clauses 38 to 41, wherein when not exposed to shear force, the print media mixture within the jetting device has a viscosity of at least 80,000 centipoise.

Clause 44. The method according to any one of Clauses 1 to 43, wherein the print media mixture further includes a debubbling agent.

Clause 45. The method according to Clause 44, wherein the debubbling agent includes at least one of a mineral oil or a silicone oil.

Clause 46. The method according to any one of Clauses 1 to 45, further comprising exposing the print media mixture to debubbling and/or degassing conditions prior to ejecting the print media material from the nozzle.

Clause 47. The method according to Clause 46, wherein the exposing includes at least one of placing the print media material under vacuum conditions and/or filtering the print media material.

Clause 48. The method according to any one of Clauses 1 to 47, further comprising screen printing a topcoat layer onto a surface of the substrate so that the topcoat layer forms at least a portion of the surface of the substrate that is placed to receive the print media material, wherein a material used in the screen printing to form the topcoat layer includes a mixture of at least: a polyurethane material, water, a cross-linker material, and a rheological modifier.

Clause 49. The method according to Clause 1, wherein the substrate includes a base textile material.

Clause 50. The method according to Clause 49, wherein the substrate includes a knitted textile material.

Clause 51. The method according to Clause 49 or 50, wherein the substrate includes a skin layer overlaying at least a portion of a surface of the textile material.

Clause 52. The method according to Clause 51, wherein the substrate includes a graphic layer overlaying at least a portion of a surface of the skin layer.

Clause 53. The method according to any one of Clauses 49 to 52, wherein the substrate includes a screen printed topcoat layer formed on at least a portion of at least one of: (i) a surface of the substrate, (ii) a surface of the skin layer, if a skin layer is present, or (iii) a surface of the graphic layer, if a graphic layer is present, wherein the screen printed topcoat layer is formed from a mixture including at least: a polyurethane material, water, a cross-linker material, and a rheological modifier.

Clause 54. The method according to Clause 53, wherein the mixture forming the screen printed topcoat layer further includes a matting agent, wherein optionally the matting agent includes silica.

Clause 55. The method according to Clause 53 or 54, wherein a surface of the screen printed topcoat layer is the surface of the substrate that is placed to receive the print media material dots.

Clause 56. The method according to any one of Clauses 1 to 48, wherein the substrate comprises a textile.

Clause 57. The method according to any one of Clauses 1 to 56, wherein the substrate comprises a wearable component, an article of apparel, or a component for an article of apparel.

Clause 58. The method according to any one of Clauses 1 to 56, wherein the substrate comprises an article of footwear or a component for an article of footwear.

Clause 59. The method according to any one of Clauses 1 to 56, wherein the substrate comprises a footwear upper component.

Clause 60. An article of manufacture formed by the method according to any one of Clauses 1 to 59.

Clause 61. A textile component formed by the method according to any one of Clauses 1 to 59.

Clause 62. A wearable component, such as an article of apparel or a component for an article of apparel, formed by the method according to any one of Clauses 1 to 59.

Clause 63. An article of footwear or a component for an article of footwear formed by the method according to any one of Clauses 1 to 59.

Clause 64. A footwear upper component formed by the method according to any one of Clauses 1 to 59.

Clause 65. An article of manufacture according to Clause 60, a textile component according to Clause 61, a wearable component according to Clause 62, an article of footwear or a component for an article of footwear according to Clause 63, or a footwear upper component according to Clause 64, wherein the overlay material comprises a polyurethane component formed from the polyurethane material in the print media mixture.

Clause 66. The article of manufacture, textile component, wearable component, article of footwear, component for an article of footwear, or footwear upper component according to Clause 65, wherein the overlay material further comprises the cross-linker material.

Clause 67. The article of manufacture, textile component, wearable component, article of footwear, component for an article of footwear, or footwear upper component according to Clause 65 or 66, wherein the overlay material further comprises the rheological modifier.

Clause 68. The article of manufacture, textile component, wearable component, article of footwear, component for an article of footwear, or footwear upper component according to any one of Clause 65 to Clause 67, wherein the overlay material further comprises a pigment.

Clause 69. The article of manufacture, textile component, wearable component, article of footwear, component for an article of footwear, or footwear upper component according to any one of Clause 65 to Clause 68, wherein the overlay material further comprises a debubbling agent.

Clause 70. The article of manufacture, textile component, wearable component, article of footwear, component for an article of footwear, or footwear upper component according to any one of Clause 65 to Clause 69, wherein the overlay material further comprises a functional filler component, such as a silica component.

Clause 71. A method, comprising: (A) placing a textile component on a print bed of a jetting system so that an exterior surface of the textile component faces a print media ejection nozzle of the jetting system, wherein the exterior surface of the textile component is non-planar such that a print region of the textile component on which print media material is to be applied varies in a thickness dimension by more than 1 mm; (B) dispensing print media material from the print media ejection nozzle to the exterior surface in the print region, wherein the print media material has at least 40% solids content and is dispensed from the print media ejection nozzle as a series of discrete and separated volumes of the print media material; and (C) moving the print media ejection nozzle with respect to the print bed to thereby form a continuous printed element in the print region through portions of the print region having different thicknesses, wherein a separation distance between the print media ejection nozzle and the print bed is not changed as the continuous printed element is formed over non-planar portions of the print region.

Clause 72. The method according to Clause 71, wherein the thickness dimension within the print region varies by more than 2 mm.

Clause 73. The method according to Clause 71, wherein the thickness dimension within the print region varies by more than 5 mm.

Clause 74. The method according to Clause 71, wherein the thickness dimension within the print region varies by more than 8 mm.

Clause 75. The method according to any one of Clauses 71 to 64, wherein the exterior surface of the textile component includes a series of dome structures.

Clause 76. The method according to any one of Clauses 71 to 75, wherein the print region of the textile component includes a plurality of spaced apart raised regions separated from one another by a valley region, the plurality of spaced apart raised regions including at least: (i) a first raised region, (ii) a second raised region located adjacent the first raised region, and (iii) a first valley region at least partially separating the first raised region and the second raised region.

Clause 77. The method according to Clause 76, wherein a resilient material underlies the first raised region and the second raised region.

Clause 78. The method according to Clause 76, wherein each of the first raised region and the second raised region forms a dome structure.

Clause 79. The method according to Clause 76, wherein each of the first raised region and the second raised region includes a sidewall extending to the first valley region.

Clause 80. The method according to Clause 79, wherein the first valley region includes an exposed surface having a width dimension of at least 1 mm extending between and separating the sidewall of the first raised region from the sidewall of the second raised region.

Clause 81. The method according to any one of Clauses 76 to 80, wherein the continuous printed element includes at least one continuous segment that extends from the first raised region, through the first valley region, and to the second raised region.

Clause 82. The method according to any one of Clauses 71 to 81, wherein the continuous printed element comprises part of a web of interconnected printed segments formed on the print region.

Clause 83. The method according to any one of Clauses 71 to 82, wherein the textile component comprises a woven textile, a knitted textile, a non-woven textile, or a synthetic leather material.

Clause 84. The method according to any one of Clauses 71 to 83, wherein the textile component comprises a footwear upper component.

Clause 85. The method according to any one of Clauses 71 to 84, wherein the print media material includes at least: a polyurethane material, water, a cross-linker material, a rheological modifier, and an alcohol, and wherein the print media material forms a non-Newtonian fluid.

Clause 86. The method according to Clause 85, wherein the print media material comprises a polyether polyurethane dispersion.

Clause 87. The method according to Clause 85 or 86, wherein polyurethane particles in the print media material have an average diameter of 20 to 40 microns.

Clause 88. The method according to any one of Clauses 85 to 87, wherein the print media material contains at least 60% solids.

Clause 89. The method according to any one of Clauses 85 to 88, wherein the cross-linker material includes an isocyanate or a carbodiimide.

Clause 90. The method according to any one of Clauses 85 to 89, wherein the cross-linker material includes a polycarbodiimide material within a range of 1.5% to 5.5% by weight based on a total weight of the print media material.

Clause 91. The method according to any one of Clauses 85 to 90, wherein the alcohol includes aminomethyl propanol.

Clause 92. The method according to Clause 91, wherein the aminomethyl propanol is present in the print media material within a range of 0.075% to 4.5% by weight based on a total weight of the print media material.

Clause 93. The method according to any one of Clauses 85 to 92, wherein the rheological modifier comprises a thickener.

Clause 94. The method according to Clause 93, wherein the thickener comprises an acrylic thickener material.

Clause 95. The method according to Clause 94, wherein the acrylic thickener material is present in the print media material within a range of 0.5 to 5% by weight based on a total weight of the print media material.

Clause 96. The method according to any one of Clauses 85 to 95, wherein the print media material further includes one or more pigments.

Clause 97. The method according to any one of Clauses 71 to 84, wherein the print media material includes: (a) an aqueous polyether polyurethane dispersion, (b) an isocyanate or carbodiimide cross-linker material, (c) an acrylic thickener as a rheological modifier, and (d) an aminoalkyl alcohol.

Clause 98. The method according to Clause 97, wherein the cross-linker material includes a polycarbodiimide material within a range of 1.5% to 5.5% by weight based on a total weight of the print media material.

Clause 99. The method according to Clause 97 or 98, wherein the aminoalkyl alcohol comprises aminomethyl propanol present in the print media material within a range of 0.075% to 4.5% by weight based on a total weight of the print media material.

Clause 100. The method according to any one of Clauses 97 to 99, wherein the acrylic thickener is present in the print media material within a range of 0.25 to 5% by weight based on a total weight of the print media material.

Clause 101. The method according to any one of Clauses 71 to 100, wherein the print media material further includes a debubbling agent.

Clause 102. The method according to Clause 101, wherein the debubbling agent includes at least one of a mineral oil or a silicone oil.

Clause 103. The method according to any one of Clauses 71 to 102, further comprising exposing the print media material to debubbling and/or degassing conditions prior to dispensing the print media material from the print media ejection nozzle.

Clause 104. The method according to Clause 103, wherein the exposing includes at least one of placing the print media material under vacuum conditions and/or filtering the print media material.

Clause 105. The method according to any one of Clauses 71 to 104, wherein when not exposed to shear force, the print media material within the jetting system has a viscosity within a range of 550 centipoise to 190,000 centipoise.

Clause 106. The method according to any one of Clauses 71 to 104, wherein when not exposed to shear force, the print media material within the jetting system has a viscosity of at least 80,000 centipoise.

Clause 107. A textile component having a continuous printed element formed thereon made by the method according to any one of Clauses 71 to 106.

Clause 108. An article of manufacture formed by the method according to any one of Clauses 71 to 106.

Clause 109. A wearable component, such as an article of apparel or a component for an article of apparel, formed by the method according to any one of Clauses 71 to 106.

Clause 110. An article of footwear or a component for an article of footwear formed by the method according to any one of Clauses 71 to 106.

Clause 111. A footwear upper component formed by the method according to any one of Clauses 71 to 106.

Clause 112. A textile component according to Clause 107, an article of manufacture according to Clause 108, a wearable component according to Clause 109, an article of footwear or a component for an article of footwear according to Clause 110, or a footwear upper component according to Clause 111, wherein the continuous printed element comprises a polyurethane component formed from the print media material.

Clause 113. The textile component, article of manufacture, wearable component, article of footwear, component for an article of footwear, or footwear upper component according to Clause 114, wherein the continuous printed element further comprises the cross-linker material.

Clause 114. The textile component, article of manufacture, wearable component, article of footwear, component for an article of footwear, or footwear upper component according to Clause 112 or 113, wherein the continuous printed element further comprises the rheological modifier.

Clause 115. The textile component, article of manufacture, wearable component, article of footwear, component for an article of footwear, or footwear upper component according to any one of Clauses 112 to 114, wherein the continuous printed element further comprises a pigment.

Clause 116. The textile component, article of manufacture, wearable component, article of footwear, component for an article of footwear, or footwear upper component according to any one of Clauses 112 to 115, wherein the continuous printed element further comprises a debubbling agent.

Clause 117. The textile component, article of manufacture, wearable component, article of footwear, component for an article of footwear, or footwear upper component according to any one of Clauses 112 to 116, wherein the continuous printed element further comprises a functional filler component, such as a silica component.

Clause 118. A footwear upper, comprising: (A) an upper base member formed from one or more upper component parts and having an exterior surface; and (B) a plurality of printed elements fixed to the exterior surface, the plurality of printed elements having a base region and at least three wing elements extending outward from the base region in different directions, wherein discrete printed elements of the plurality of printed elements have a largest dimension in any one direction of less than 30 mm.

Clause 119. The footwear upper according to Clause 118, wherein the plurality of printed elements includes four wing elements extending outward from the base region, including: (i) a first wing element and a second wing element extending away from the base region in opposite directions and (ii) a third wing element and a fourth wing element extending away from the base region in opposite directions, wherein the third wing element is located between the first wing element and the second wing element on a first side of the base region and the first and second wing elements, and wherein the fourth wing element located between the first wing element and the second wing element on a second side of the base region and the first and second wing elements.

Clause 120. The footwear upper according to Clause 119, wherein the four wing elements of the plurality of printed elements further include: (a) a first distance defined from a free end of the first wing element and a free end of the second wing element, and (b) a second distance defined from a free end of the third wing element to a free end of the fourth wing element.

Clause 121. The footwear upper according to Clause 120, wherein for at least a subset of the plurality of printed elements, the first distance is at least 10% greater than the second distance.

Clause 122. The footwear upper according to Clause 120, wherein for at least a subset of the plurality of printed elements, the first distance is at least 20% greater than the second distance.

Clause 123. The footwear upper according to Clause 120, wherein for at least a subset of the plurality of printed elements, the first distance is at least 30% greater than the second distance.

Clause 124. The footwear upper according to any one of Clauses 118 to 123, wherein the one or more upper component parts include at least one upper component part forming a stretchable instep region, wherein at least some of the plurality of printed elements are located in the stretchable instep region.

Clause 125. The footwear upper according to any one of Clauses 118 to 124, wherein the plurality of printed elements (e.g., formed using any of the print media materials described herein and/or using any of the methods described herein) includes: (a) a first subset of printed elements located in a first region of the footwear upper, the first subset having a first printed element distribution density and (b) a second subset of printed elements located in a second region of the footwear upper, the second subset having a second printed element distribution density, wherein the first printed element distribution density is higher than the second printed element distribution density.

Clause 126. The footwear upper according to Clause 125, wherein the first region of the footwear upper includes at least one of a medial midfoot region and a medial heel region of the footwear upper.

Clause 127. The footwear upper according to any one of Clauses 118 to 124, wherein the plurality of printed elements includes: (a) a first subset of printed elements located in a first region of the footwear upper, the first subset having a first maximum thickness dimension of 1.25 mm or greater and (b) a second subset of printed elements located in a second region of the footwear upper, the second subset having a second maximum thickness dimension of less than 1.25 mm.

Clause 128. The footwear upper according to Clause 127, wherein the first region of the footwear upper includes at least one of a medial midfoot region and a medial heel region of the footwear upper.

Clause 129. The footwear upper according to Clause 127, wherein the first region of the footwear upper includes at least one of a medial midfoot region and a medial forefoot region of the footwear upper.

Clause 130. The footwear upper according to any one of Clause 127 to 129, wherein the second region of the footwear upper includes at least one of a lateral midfoot region, a lateral forefoot region, and a lateral heel region of the footwear upper.

Clause 131. The footwear upper according to any one of Clauses 127 to 130, wherein the second maximum thickness dimension for the second subset of printed elements is 1 mm or less.

Clause 132. The footwear upper according to any one of Clauses 127 to 131, wherein the plurality of printed elements includes: (a) a third subset of printed elements having a first printed element distribution density and (b) a fourth subset of printed elements having a second printed element distribution density, wherein the first printed element distribution density is higher than the second printed element distribution density.

Clause 133. The footwear upper according to Clause 132, wherein at least some of the third subset of printed elements are located in least one of a medial midfoot region and a medial heel region of the footwear upper.

Clause 134. The footwear upper according to any one of Clauses 118 to 133, wherein one subset of the plurality of printed elements includes a recess in the base region.

Clause 135. The footwear upper according to any one of Clauses 118 to 134, wherein one subset of the plurality of printed elements includes an opening in the base region that extends to the exterior surface.

Clause 136. The footwear upper according to any one of Clauses 118 to 135, wherein one subset of the plurality of printed elements includes a raised printed structure overlaying the base region and the at least three wing elements extending outward from the base region.

Clause 137. The footwear upper according to any one of Clauses 118 to 136, wherein, for one subset of the plurality of printed elements, at least one wing element of a first printed element will abut a wing element of an adjacent printed element.

Clause 138. The footwear upper according to any one of Clauses 118 to 136, wherein, for one subset of the plurality of printed elements, wing elements of multiple adjacent printed elements abut to form a continuous line of printed structure spanning the multiple adjacent printed elements.

Clause 139. The footwear upper according to Clause 138, wherein the continuous line of printed structure is located at a medial side of the footwear upper.

Clause 140. The footwear upper according to Clause 138, wherein the continuous line of printed structure is located in at least one of at a medial midfoot region or a medial heel region of the footwear upper.

Clause 141. The footwear upper according to any one of Clauses 138 to 140, wherein the continuous line is oriented in a top to bottom direction of the footwear upper.

Clause 142. The footwear upper according to any one of Clauses 118 to 141, wherein the plurality of printed elements includes a first printed element and a second printed element located adjacent the first printed element, wherein at least one wing element of the first printed element will extend between two adjacent wing elements of the second printed element.

Clause 143. The footwear upper according to Clause 142, wherein the first printed element and the second printed element are located at a medial side of the footwear upper.

Clause 144. The footwear upper according to Clause 143, wherein the first printed element and the second printed element are located in least one of at a medial midfoot region or a medial heel region of the footwear upper.

Clause 145. The footwear upper according to any one of Clauses 142 to 144, wherein one of the two adjacent wing elements of the second printed element extends between the first wing element and an adjacent second wing element of the first printed element.

Clause 146. The footwear upper according to any one of Clauses 118 to 145, wherein the upper base member forms at least a medial midfoot upper region, a medial forefoot upper region, a lateral forefoot upper region, and a lateral midfoot upper region, and wherein plural printed elements of the plurality of printed elements are located in each of the medial midfoot upper region, the medial forefoot upper region, the lateral forefoot upper region, and the lateral midfoot upper region.

Clause 147. The footwear upper according to any one of Clauses 118 to 145, wherein the upper base member forms at least a medial heel upper region, a medial midfoot upper region, a medial forefoot upper region, a lateral forefoot upper region, a lateral midfoot upper region, and a lateral heel upper region, and wherein plural printed elements of the plurality of printed elements are located in each of the medial heel upper region, the medial midfoot upper region, the medial forefoot upper region, the lateral forefoot upper region, the lateral midfoot upper region, and the lateral heel upper region.

Clause 148. The footwear upper according to any one of Clauses 118 to 147, wherein a first upper component part of the one or more upper component parts is a stretchable upper component, wherein at least some of the plurality of printed elements are fixed to the stretchable upper component, and wherein said at least some of the plurality of printed elements fixed to the stretchable upper component are stretchable along with the stretchable upper component.

Clause 149. The footwear upper according to any one of Clauses 118 to 148, wherein at least a portion of the plurality of printed elements comprise a polyurethane component.

Clause 150. The footwear upper according to Clause 149, wherein the portion of the plurality of printed element further comprises the cross-linker material.

Clause 151. The footwear upper according to Clause 149 or 150, wherein the portion of the plurality of printed elements further comprises the rheological modifier.

Clause 152. The footwear upper according to any one of Clause 149 to 151, wherein the portion of the plurality of printed elements further comprises a pigment.

Clause 153. The footwear upper according to any one of Clause 149 to 152, wherein the portion of the plurality of printed elements further comprises a debubbling agent.

Clause 154. The footwear upper according to any one of Clause 149 to 153, wherein the portion of the plurality of printed elements further comprises a silica component.

Clause 155. An article of footwear, comprising: (A) a footwear upper according to any one of Clauses 118 to 154; and (B) a sole structure engaged with the footwear upper.

Clause 156. A footwear upper, comprising: (A) an upper base member formed from one or more upper component parts and having an exterior surface; and (B) a printed web structure (e.g., formed using any of the print media materials described herein and/or using any of the methods described herein) fixed to the exterior surface, the printed web structure including: (i) a plurality of printed nodes elements, and (ii) a plurality of printed segments extending between two node elements of the plurality of printed node elements, wherein at least 50% of the plurality of printed node elements have at least three printed segments extending outward in different directions on the exterior surface.

Clause 157. The footwear upper according to Clause 156, wherein the printed web structure defines a plurality of enclosed openings through which the exterior surface is exposed, wherein each opening of the plurality of enclosed openings is defined by at least three printed node elements and at least three printed segments.

Clause 158. The footwear upper according to Clause 157, wherein at least 50% of the plurality of enclosed openings enclose a continuous open area of less than 25 cm².

Clause 159. The footwear upper according to Clause 157, wherein at least 75% of the plurality of enclosed openings enclose a continuous open area of less than 25 cm².

Clause 160. The footwear upper according to Clause 157, wherein at least 90% of the plurality of enclosed openings enclose a continuous open area of less than 25 cm².

Clause 161. The footwear upper according to Clause 157, wherein at least 50% of the plurality of enclosed openings enclose a continuous open area of less than 10 cm².

Clause 162. The footwear upper according to Clause 157, wherein at least 75% of the plurality of enclosed openings enclose a continuous open area of less than 10 cm².

Clause 163. The footwear upper according to Clause 157, wherein at least 90% of the plurality of enclosed openings enclose a continuous open area of less than 10 cm².

Clause 164. The footwear upper according to any one of Clauses 156 to 163, wherein at least 50% of the plurality of printed segments forming the printed web structure have a maximum cross-sectional area of less than 0.25 cm².

Clause 165. The footwear upper according to any one of Clauses 156 to 163, wherein at least 75% of the plurality of printed segments forming the printed web structure have a maximum cross-sectional area of less than 0.25 cm².

Clause 166. The footwear upper according to any one of Clauses 156 to 163, wherein at least 90% of the plurality of printed segments forming the printed web structure have a maximum cross-sectional area of less than 0.25 cm².

Clause 167. The footwear upper according to any one of Clauses 156 to 163, wherein at least 50% of the plurality of printed segments forming the printed web structure have a maximum cross-sectional area of less than 0.1 cm².

Clause 168. The footwear upper according to any one of Clauses 156 to 163, wherein at least 75% of the plurality of printed segments forming the printed web structure have a maximum cross-sectional area of less than 0.1 cm².

Clause 169. The footwear upper according to any one of Clauses 156 to 163, wherein at least 90% of the plurality of printed segments forming the printed web structure have a maximum cross-sectional area of less than 0.1 cm².

Clause 170. The footwear upper according to any one of Clauses 156 to 169, wherein for each of a first subset of the plurality of printed node elements in the printed web structure: at least three printed segments extend outward and away from the printed node element, wherein an exposed surface of the printed node element extends in a direction away from the exterior surface so as to protrude outward from the exterior surface beyond exposed surfaces of the at least three printed segments extending from that printed node element.

Clause 171. The footwear upper according to Clause 170, wherein the first subset includes at least 10% of the plurality of printed node elements in the printed web structure.

Clause 172. The footwear upper according to Clause 170, wherein the first subset includes at least 20% of the plurality of printed node elements in the printed web structure.

Clause 173. The footwear upper according to any one of Clauses 156 to 172, wherein the printed web structure extends continuously over at least portions of each of a medial midfoot upper region and a medial forefoot upper region of the upper base member.

Clause 174. The footwear upper according to any one of Clauses 156 to 172, wherein the printed web structure extends continuously over at least portions of each of a medial midfoot upper region and a medial heel upper region of the upper base member.

Clause 175. The footwear upper according to any one of Clauses 156 to 172, wherein the printed web structure extends continuously over at least portions of each of a medial forefoot upper region, a medial midfoot upper region, and a medial heel upper region of the upper base member.

Clause 176. The footwear upper according to any one of Clauses 156 to 172, wherein the printed web structure extends continuously over at least portions of each of a medial midfoot upper region, a medial forefoot upper region, and a lateral forefoot upper region of the upper base member.

Clause 177. The footwear upper according to any one of Clauses 156 to 172, wherein the printed web structure extends continuously over at least portions of each of a medial midfoot upper region, a medial forefoot upper region, a lateral forefoot upper region, and a lateral midfoot upper region of the upper base member.

Clause 178. The footwear upper according to any one of Clauses 156 to 177, wherein at least one subset of the plurality of printed node elements includes a multi-material structure including a first material having a first composition and a second material having a second composition that differs from the first composition.

Clause 179. The footwear upper according to Clause 178, wherein at least one subset of the plurality of printed segments includes a multi-material structure including a third material having the first composition and a second material having the second composition.

Clause 180. The footwear upper according to any one of Clauses 156 to 177, wherein at least one subset of the plurality of printed segments includes a multi-material structure including a first material having a first composition and a second material having a second composition that differs from the first composition.

Clause 181. The footwear upper according to any one of Clauses 178 to 180, wherein the first material has a different color from the second material.

Clause 182. The footwear upper according to any one of Clauses 178 to 180, wherein the first material has different physical properties from the second material.

Clause 183. The footwear upper according to any one of Clauses 178 to 182, wherein the first material is fixed directly to the exterior surface and the second material is fixed to the first material.

Clause 184. The footwear upper according to any one of Clauses 156 to 183, wherein the printed web structure comprises a polyurethane component.

Clause 185. The footwear upper according to Clause 184, wherein the printed web structure further comprises the cross-linker material.

Clause 186. The footwear upper according to Clause 184 or 185, wherein the printed web structure further comprises the rheological modifier.

Clause 187. The footwear upper according to any one of Clauses 184 to 186, wherein the printed web structure further comprises a pigment.

Clause 188. The footwear upper according to any one of Clauses 184 to 187, wherein the printed web structure further comprises a debubbling agent.

Clause 189. The footwear upper according to any one of Clauses 184 to 188, wherein the printed web structure further comprises a functional filler component, such as a silica component.

Clause 190. An article of footwear, comprising: (A) a footwear upper according to any one of Clauses 156 to 189; and (B) a sole structure engaged with the footwear upper.

Clause 191. A footwear upper, comprising: (A) an upper base member formed from one or more upper component parts and having an exterior surface; and (B) a plurality of discrete printed protrusions fixed to and extending outward from the exterior surface, wherein at least 50% of the discrete printed protrusions provided on the upper base member define a volume of less than 150 mm³.

Clause 192. The footwear upper according to Clause 191, wherein at least a portion of the plurality of discrete printed protrusions comprise a polyurethane component.

Clause 193. The footwear upper according to Clause 192, wherein the portion of the plurality of discrete printed protrusions further comprises the cross-linker material.

Clause 194. The footwear upper according to Clause 192 or 193, wherein the portion of the plurality of discrete printed protrusions further comprises the rheological modifier.

Clause 195. The footwear upper according to any one of Clauses 192 to 194, wherein the portion of the plurality of discrete printed protrusions further comprises a pigment.

Clause 196. The footwear upper according to any one of Clauses 192 to 195, wherein the portion of the plurality of discrete printed protrusions further comprises a debubbling agent.

Clause 197. The footwear upper according to any one of Clauses 192 to 196, wherein the portion of the plurality of discrete printed protrusions further comprises a functional filler component, such as a silica component.

Clause 198. The footwear upper according to Clause 191, wherein the plurality of discrete printed protrusions comprise dried and/or cross-linked structures formed from a print media material that includes at least: a polyurethane material, water, a cross-linker material, a rheological modifier, and an alcohol.

Clause 199. The footwear upper according to Clause 198, wherein the cross-linker material includes an isocyanate or a carbodiimide.

Clause 200. The footwear upper according to Clause 198 or 199, wherein the alcohol includes aminoalkyl alcohol.

Clause 201. The footwear upper according to any one of Clauses 198 to 200, wherein the rheological modifier comprises a thickener.

Clause 202. The footwear upper according to Clause 201, wherein the thickener comprises an acrylic thickener material.

Clause 203. The footwear upper according to any one of Clauses 198 to 202, wherein the print media material further includes one or more pigments.

Clause 204. The footwear upper according to Clause 191, wherein the plurality of discrete printed protrusions comprise dried and/or cross-linked structures formed from a print media material that includes at least: (a) an aqueous polyurethane dispersion, (b) an isocyanate or carbodiimide cross-linker material, (c) an acrylic thickener, and (d) an aminoalkyl alcohol.

Clause 205. The footwear upper according to Clause 191, wherein the plurality of discrete printed protrusions comprise dried and/or cross-linked structures formed from a print media material that includes at least: (a) 65% to 95% by weight of an aqueous polyether polyurethane dispersion, (b) 1.5% to 5.5% by weight of a carbodiimide cross-linker material, (c) 0.25 to 5% by weight of an acrylic thickener, and (d) 0.075% to 4.5% by weight of aminomethyl propanol.

Clause 206. The footwear upper according to any one of Clauses 198 to 205, wherein the print media material further includes a debubbling agent.

Clause 207. The footwear upper according to Clause 206, wherein the debubbling agent includes at least one of a mineral oil or a silicone oil.

Clause 208. The footwear upper according to any one of Clauses 191 to 207, wherein the volume of said at least 50% of the discrete printed protrusions provided on the upper base member is less than 100 mm³.

Clause 209. The footwear upper according to any one of Clauses 191 to 207, wherein the volume of said at least 50% of the discrete printed protrusions provided on the upper base member is less than 60 mm³.

Clause 210. The footwear upper according to any one of Clauses 191 to 207, wherein the volume of at least 75% of the discrete printed protrusions provided on the upper base member is less than 100 mm³.

Clause 211. The footwear upper according to any one of Clauses 191 to 207, wherein the volume of at least 75% of the discrete printed protrusions provided on the upper base member is less than 60 mm³.

Clause 212. The footwear upper according to any one of Clauses 191 to 207, wherein the volume of at least 90% of the discrete printed protrusions provided on the upper base member is less than 100 mm³.

Clause 213. The footwear upper according to any one of Clauses 191 to 207, wherein the volume of at least 90% of the discrete printed protrusions provided on the upper base member is less than 60 mm³.

Clause 214. The footwear upper according to any one of Clauses 191 to 213, wherein each discrete printed protrusion of said at least 50% of the discrete printed protrusions provided on the upper base member is spaced from a nearest adjacent discrete printed protrusion by a distance of less than 15 mm.

Clause 215. The footwear upper according to any one of Clauses 191 to 213, wherein each discrete printed protrusion of said at least 50% of the discrete printed protrusions provided on the upper base member is spaced from a nearest adjacent discrete printed protrusion by a distance of less than 12 mm.

Clause 216. The footwear upper according to any one of Clauses 191 to 213, wherein each discrete printed protrusion of at least 75% of the discrete printed protrusions provided on the upper base member is spaced from a nearest adjacent discrete printed protrusion by a distance of less than 15 mm.

Clause 217. The footwear upper according to any one of Clauses 191 to 213, wherein each discrete printed protrusion of at least 75% of the discrete printed protrusions provided on the upper base member is spaced from a nearest adjacent discrete printed protrusion by a distance of less than 12 mm.

Clause 218. The footwear upper according to any one of Clauses 191 to 213, wherein each discrete printed protrusion of at least 90% of the discrete printed protrusions provided on the upper base member is spaced from a nearest adjacent discrete printed protrusion by a distance of less than 15 mm.

Clause 219. The footwear upper according to any one of Clauses 191 to 213, wherein each discrete printed protrusion of at least 90% of the discrete printed protrusions provided on the upper base member is spaced from a nearest adjacent discrete printed protrusion by a distance of less than 12 mm.

Clause 220. The footwear upper according to any one of Clauses 191 to 219, wherein each discrete printed protrusion of at least 25% of the discrete printed protrusions provided on the upper base member includes: (i) a largest base dimension D of the discrete printed protrusion located at the exterior surface of the upper base member, (ii) a height dimension H from the exterior surface to an outermost free end of the discrete printed protrusion, and (iii) an aspect ratio H/D of at least 1.25.

Clause 221. The footwear upper according to any one of Clauses 191 to 219, wherein each discrete printed protrusion of at least 25% of the discrete printed protrusions provided on the upper base member includes: (i) a largest base dimension D of the discrete printed protrusion located at the exterior surface of the upper base member, (ii) a height dimension H from the exterior surface to an outermost free end of the discrete printed protrusion, and (iii) an aspect ratio H/D of at least 1.5.

Clause 222. The footwear upper according to any one of Clauses 191 to 219, wherein each discrete printed protrusion of at least 25% of the discrete printed protrusions provided on the upper base member includes: (i) a largest base dimension D of the discrete printed protrusion located at the exterior surface of the upper base member, (ii) a height dimension H from the exterior surface to an outermost free end of the discrete printed protrusion, and (iii) an aspect ratio H/D of at least 1.75.

Clause 223. The footwear upper according to any one of Clauses 191 to 222, wherein at least one subset of the plurality of discrete printed protrusions includes a multi-material structure including a first material having a first composition and a second material having a second composition that differs from the first composition.

Clause 224. The footwear upper according to Clause 223, wherein the first material has a different color from the second material.

Clause 225. The footwear upper according to Clause 223 or 224, wherein the first material has different physical properties from the second material.

Clause 226. The footwear upper according to any one of Clauses 223 to 225, wherein the first material is fixed directly to the exterior surface and the second material is fixed to the first material.

Clause 227. The footwear upper according to any one of Clauses 191 to 226, wherein each discrete printed protrusion of at least 25% of the discrete printed protrusions provided on the upper base member includes an outermost free end surface having at least one raised edge element.

Clause 228. The footwear upper according to any one of Clauses 191 to 226, wherein each discrete printed protrusion of at least 25% of the discrete printed protrusions provided on the upper base member includes an outermost free end surface having at least two raised edge elements.

Clause 229. The footwear upper according to any one of Clauses 191 to 228, wherein at least some of the plurality of discrete printed protrusions are located in each of a medial midfoot upper region and a medial forefoot upper region of the upper base member.

Clause 230. The footwear upper according to any one of Clauses 191 to 228, wherein at least some of the plurality of discrete printed protrusions are located in each of a medial midfoot upper region and a medial heel upper region of the upper base member.

Clause 231. The footwear upper according to any one of Clauses 191 to 228, wherein at least some of the plurality of discrete printed protrusions are located in each of a medial forefoot upper region, a medial midfoot upper region, and a medial heel upper region of the upper base member.

Clause 232. The footwear upper according to any one of Clauses 191 to 228, wherein at least some of the plurality of discrete printed protrusions are located in each of a medial midfoot upper region, a medial forefoot upper region, and a lateral forefoot upper region of the upper base member.

Clause 233. The footwear upper according to any one of Clauses 191 to 228, wherein at least some of the plurality of discrete printed protrusions are located in each of a medial midfoot upper region, a medial forefoot upper region, a lateral forefoot upper region, and a lateral midfoot upper region of the upper base member.

Clause 234. The footwear upper according to any one of Clauses 191 to 228, wherein at least some of the plurality of discrete printed protrusions are located in each of a medial heel upper region, a medial midfoot upper region, a medial forefoot upper region, a lateral forefoot upper region, a lateral midfoot upper region, and a lateral heel upper region of the upper base member.

Clause 235. An article of footwear, comprising: (A) a footwear upper according to any one of Clauses 191 to 234; and (B) a sole structure engaged with the footwear upper.

Clause 236. An article of apparel, such as a footwear upper, comprising: (A) a substrate (e.g., an upper base member) formed from one or more component parts and having an exterior surface, wherein the exterior surface includes: (i) a first surface level, (ii) a second surface level, and (iii) a sidewall surface connecting the first surface level and the second surface level, wherein a height dimension from the first surface level to the second surface level is at least 1 mm; and (B) a continuous printed segment extending from the first surface level, along the sidewall surface, and to the second surface level.

Clause 237. The article of apparel (e.g., the footwear upper) according to Clause 236, wherein the height dimension is at least 1.5 mm.

Clause 238. The article of apparel (e.g., the footwear upper) according to Clause 236, wherein the height dimension is at least 2 mm.

Clause 239. The article of apparel (e.g., the footwear upper) according to any one of Clauses 236 to 238, wherein a resilient material underlies the first surface level but not the second surface level.

Clause 240. The article of apparel (e.g., the footwear upper) according to any one of Clauses 236 to 239, wherein the sidewall surface forms a dome structure extending between the first surface level and the second surface level.

Clause 241. The article of apparel (e.g., the footwear upper) according to any one of Clauses 236 to 239, wherein the sidewall surface is sloped between the first surface level and the second surface level.

Clause 242. An article of apparel, such as a footwear upper, comprising: (A) a substrate (e.g., an upper base member) formed from one or more component parts and having an exterior surface, wherein the exterior surface includes a plurality of spaced apart raised regions separated from one another by a valley region, the plurality of spaced apart raised regions forming a non-planar exposed surface including at least: (i) a first raised region, (ii) a second raised region located adjacent the first raised region, and (iii) a first valley region at least partially separating the first raised region and the second raised region, wherein when supported on a planar base surface, a first height dimension between an outermost location of the first raised region and the first valley region is at least 1 mm and a second height dimension between an outermost location of the second raised region and the first valley region is at least 1 mm; and (B) a continuous printed segment extending from the first raised region, through the first valley region, and to the second raised region.

Clause 243. The article of apparel (e.g., the footwear upper) according to Clause 242, wherein each of the first height dimension and the second height dimension is at least 1.5 mm.

Clause 244. The article of apparel (e.g., the footwear upper) according to Clause 242, wherein each of the first height dimension and the second height dimension is at least 2 mm.

Clause 245. The article of apparel (e.g., the footwear upper) according to any one of Clauses 242 to 244, wherein a resilient material underlies the first raised region and the second raised region.

Clause 246. The article of apparel (e.g., the footwear upper) according to any one of Clauses 242 to 244, wherein each of the first raised region and the second raised region forms a dome structure.

Clause 247. The article of apparel (e.g., the footwear upper) according to any one of Clauses 242 to 244, wherein each of the first raised region and the second raised region includes a sloped sidewall extending to the first valley region.

Clause 248. The article of apparel (e.g., the footwear upper) according to any one of Clauses 242 to 244, wherein each of the first raised region and the second raised region includes a sidewall extending to the first valley region.

Clause 249. The article of apparel (e.g., the footwear upper) according to Clause 247 or 248, wherein the first valley region includes an exposed surface having a width dimension of at least 1 mm extending between and separating the first raised region from the second raised region.

Clause 250. The article of apparel (e.g., the footwear upper) according to any one of Clauses 242 to 249, wherein the continuous printed segment comprises part of a web of interconnected printed segments located on the exterior surface.

Clause 251. The article of apparel (e.g., the footwear upper) according to any one of Clauses 236 to 250, wherein the continuous printed segment comprise a polyurethane component.

Clause 252. The article of apparel (e.g., the footwear upper) according to Clause 251, wherein the continuous printed segment further comprises the cross-linker material.

Clause 253. The article of apparel (e.g., the footwear upper) according to Clause 251 or 252, wherein the continuous printed segment further comprises the rheological modifier.

Clause 254. The article of apparel (e.g., the footwear upper) according to any one of Clauses 251 to 253, wherein the continuous printed segment further comprises a pigment.

Clause 255. The article of apparel (e.g., the footwear upper) according to any one of Clauses 251 to 254, wherein the continuous printed segment further comprises a debubbling agent.

Clause 256. The article of apparel (e.g., the footwear upper) according to any one of Clauses 251 to 255, wherein the continuous printed segment further comprises a functional filler component, such as a silica component.

Clause 257. The article of apparel (e.g., the footwear upper) according to any one of Clauses 236 to 255, wherein the continuous printed segment comprises a dried and/or cross-linked segment structure formed from a print media material that includes at least: a polyurethane material, water, a cross-linker material, a rheological modifier, and an alcohol.

Clause 258. The article of apparel (e.g., the footwear upper) according to Clause 257, wherein the cross-linker material includes an isocyanate or a carbodiimide.

Clause 259. The article of apparel (e.g., the footwear upper) according to Clause 257 or 258, wherein the alcohol includes aminoalkyl alcohol.

Clause 260. The article of apparel (e.g., the footwear upper) according to any one of Clauses 257 to 259, wherein the rheological modifier comprises a thickener.

Clause 261. The article of apparel (e.g., the footwear upper) according to Clause 260, wherein the thickener comprises an acrylic thickener material.

Clause 262. The article of apparel (e.g., the footwear upper) according to any one of Clauses 257 to 261, wherein the print media material further includes one or more pigments.

Clause 263. The article of apparel (e.g., the footwear upper) according to any one of Clauses 236 to 256, wherein the continuous printed segment comprises a dried and/or cross-linked segment structure formed from a print media material that includes at least: (a) an aqueous polyurethane dispersion, (b) an isocyanate or carbodiimide cross-linker material, (c) an acrylic thickener, and (d) an aminoalkyl alcohol.

Clause 264. The article of apparel (e.g., the footwear upper) according to any one of Clauses 236 to 256, wherein the continuous printed segment comprises a dried and/or cross-linked segment structure formed from a print media material that includes at least: (a) 65% to 95% by weight of an aqueous polyether polyurethane dispersion, (b) 1.5% to 5.5% by weight of a carbodiimide cross-linker material, (c) 0.25% to 5% by weight of an acrylic thickener, and (d) 0.075% to 4.5% by weight of aminomethyl propanol.

Clause 265. The article of apparel (e.g., the footwear upper) according to any one of Clauses 257 to 264, wherein the print media material further includes a debubbling agent.

Clause 266. The article of apparel (e.g., the footwear upper) according to Clause 265, wherein the debubbling agent includes at least one of a mineral oil or a silicone oil.

Clause 267. The article of apparel (e.g., the footwear upper) according to any one of Clauses 236 to 266, wherein the article of apparel includes a footwear component.

Clause 268. The article of apparel (e.g., the footwear upper) according to any one of Clauses 236 to 266, wherein the article of apparel includes a footwear upper.

Clause 269. A composite component, comprising: (A) a base textile layer; (B) a skin layer located on a first surface of the base textile layer, the skin layer comprising at least one of a polyurethane component or a thermoplastic polyurethane component; (C) a graphic layer located on a surface of the skin layer; (D) a topcoat layer located on a surface of the graphic layer, wherein the topcoat layer is formed from a mixture including a polyurethane material, water, a cross-linker material, and a rheological modifier; and (E) one or more printed elements formed on the topcoat layer, the one or more printed elements formed from a print media mixture including at least: a polyurethane material, water, a cross-linker material, a rheological modifier, and an alcohol.

Clause 270. The composite component according to Clause 269, wherein the skin layer is less than 2 mm thick.

Clause 271. The composite component according to Clause 269 or 270, wherein the substrate includes a knitted textile material.

Clause 272. The composite component according to any one of Clauses 269 to 271, wherein the skin layer comprises at least one of a polyurethane material or a thermoplastic polyurethane material.

Clause 273. The composite component according to any one of Clauses 269 to 272, wherein the topcoat layer is formed from a mixture including at least: a polyurethane material, water, a cross-linker material, and a rheological modifier.

Clause 274. The composite component according to Clause 273, wherein the mixture forming the topcoat layer further includes a matting agent, wherein optionally the matting agent includes silica.

Clause 275. The composite component according to any one of Clauses 269 to 274, further comprising a foam layer engaged with a second surface of the base textile layer located opposite the first surface.

Clause 276. The composite component according to any one of Clauses 269 to 275, wherein the skin layer is provided on only a portion of the first surface of the base textile layer.

Clause 277. The composite component according to any one of Clauses 269 to 276, wherein the graphic layer is provided on only a portion of the surface of the skin layer.

Clause 278. The composite component according to any one of Clauses 269 to 277, wherein the topcoat layer is provided on only a portion of the graphic layer.

Clause 279. The composite component according to any one of Clauses 269 to 278, wherein the topcoat layer extends to cover at least one of: (a) at least a portion of the skin layer not covered by the graphic layer and/or (b) at least a portion of the base textile layer not covered by the skin layer or the graphic layer.

Clause 280. The composite component according to any one of Clauses 269 to 279, further comprising one or more printed elements formed from the print media mixture is formed directly on the first surface of the base textile layer.

Clause 281. The composite component according to any one of Clauses 269 to 280, wherein the base textile layer comprises an elastomeric material.

Clause 282. The composite component according to any one of Clauses 269 to 281, wherein the base textile layer comprises a stretchable material.

Clause 283. The composite component according to any one of Clauses 269 to 282, wherein the composite component is configured as an upper for an article of footwear or a component for an upper for an article of footwear.

Clause 284. A method, comprising: (A) screen printing a first print media material onto a substrate, the first print media material including at least: a polyurethane material, water, a cross-linker material, and a rheological modifier, wherein the first print media material has a viscosity within a range of 85,000 to 120,000 centipoise; (B) thereafter, screen printing a second print media material onto an exposed surface of the first print media material, the second print media material including at least: a polyurethane material, water, a cross-linker material, and a rheological modifier, wherein the second print media material has a viscosity within a range of 40,000 to 80,000 centipoise; and (C) thereafter, screen printing a third print media material onto an exposed surface of the second print media material, the third print media material including at least: a polyurethane material, water, and a cross-linker material, wherein the third print media material has a viscosity within a range of 3500 to 10,000 centipoise.

Clause 285. The method according to Clause 284, wherein the step of screen printing the first print media material includes: (a) applying a first sub-layer of the first print media material; and (b) applying a second sub-layer of the first print media material over the first sub-layer of the first print media material.

Clause 286. The method according to Clause 285, wherein the step of screen printing the first print media material further includes exposing the first sub-layer of the first print media material to drying conditions before applying the second sub-layer of the first print media material.

Clause 287. The method according to Clause 284, wherein the step of screen printing the first print media material includes applying the first print media material in a first series of screen print application steps.

Clause 288. The method according to Clause 287, wherein the step of screen printing the first print media material further includes exposing the first print media material to drying conditions between at least two consecutive screen print application steps in the first series of screen print application steps.

Clause 289. The method according to Clause 287, wherein the step of screen printing the first print media material further includes exposing the first print media material to drying conditions after each screen print application step in the first series of screen print application steps.

Clause 290. The method according to any one of Clauses 284 to 289, wherein the step of screen printing the second print media material includes: (a) applying a first sub-layer of the second print media material; and (b) applying a second sub-layer of the second print media material over the first sub-layer of the second print media material.

Clause 291. The method according to Clause 290, wherein the step of screen printing the second print media material further includes exposing the first sub-layer of the second print media material to drying conditions before applying the second sub-layer of the second print media material.

Clause 292. The method according to any one of Clauses 284 to 289, wherein the step of screen printing the second print media material includes applying the second print media material in a second series of screen print application steps.

Clause 293. The method according to Clause 292, wherein the step of screen printing the second print media material further includes exposing the second print media material to drying conditions between at least two consecutive screen print application steps in the second series of screen print application steps.

Clause 294. The method according to Clause 292, wherein the step of screen printing the second print media material further includes exposing the second print media material to drying conditions after each screen print application step in the second series of screen print application steps.

Clause 295. The method according to any one of Clauses 284 to 294, wherein the step of screen printing the third print media material includes applying the third print media material in a third series of screen print application steps.

Clause 296. The method according to Clause 295, wherein the step of screen printing the third print media material further includes exposing the third print media material to drying conditions between at least two consecutive screen print application steps in the third series of screen print application steps.

Clause 297. The method according to Clause 295, wherein the step of screen printing the third print media material further includes exposing the third print media material to drying conditions after each screen print application step in the third series of screen print application steps.

Clause 298. The method according to any one of Clauses 284 to 297, wherein the first print media material further includes a first pigment.

Clause 299. The method according to any one of Clauses 284 to 298, wherein the second print media material further includes a second pigment.

Clause 300. The method according to any one of Clauses 284 to 299, wherein the third print media material further includes a third pigment.

Clause 301. The method according to any one of Clauses 284 to 299, wherein the third print media material is transparent.

Clause 302. The method according to any one of Clauses 284 to 301, wherein the first print media material further includes a debubbling agent.

Clause 303. The method according to any one of Clauses 284 to 302, wherein the second print media material further includes a debubbling agent.

Clause 304. The method according to any one of Clauses 284 to 303, wherein the third print media material further includes a debubbling agent.

Clause 305. The method according to any one of Clauses 284 to 304, wherein the substrate includes a member selected from the group of: a textile; a polyurethane component; a polyvinylchloride component; a synthetic leather component; a woven textile component; a knitted textile component; or a non-woven textile component.

Clause 306. The method according to any one of Clauses 284 to 305, wherein the substrate comprises a footwear upper base component.

Clause 307. The method according to any one of Clauses 284 to 306, further comprising at least one of: (A) exposing the first print media material to vacuum pressure to remove at least some gas from the first print media material prior to the step of screen printing the first print media material; or (B) exposing the second print media material to vacuum pressure to remove at least some gas from the second print media material prior to the step of screen printing the second print media material; or (C) exposing the third print media material to vacuum pressure to remove at least some gas from the third print media material prior to the step of screen printing the third print media material.

Clause 308. The method according to any one of Clauses 284 to 307 forming a first printed structure on a first portion of the substrate; and the method according to any one of Clauses 1 to 59 or 71 to 106 forming a second printed structure on a second portion of the substrate.

Clause 309. A component formed by the method according to any one of Clauses 284 to 308.

Clause 310. A wearable component (e.g., an article of apparel, a component for an article of apparel, an article of footwear, or a component for an article of footwear) formed by the method according to any one of Clauses 284 to 308.

Clause 311. A footwear upper formed by the method according to any one of Clauses 284 to 308.

Clause 312. A method, comprising: (A) screen printing a first print media material onto a substrate, the first print media material including at least: a polyurethane material, water, a cross-linker material, and a rheological modifier, wherein the first print media material has a viscosity within a range of 40,000 to 80,000 centipoise; and (B) thereafter, screen printing a second print media material onto an exposed surface of the first print media material, the second print media material including at least: a polyurethane material, water, and a cross-linker material, wherein the second print media material has a viscosity within a range of 3500 to 10,000 centipoise.

Clause 313. The method according to Clause 312, wherein the step of screen printing the first print media material includes: (a) applying a first sub-layer of the first print media material; and (b) applying a second sub-layer of the first print media material over the first sub-layer of the first print media material.

Clause 314. The method according to Clause 313, wherein the step of screen printing the first print media material further includes exposing the first sub-layer of the first print media material to drying conditions before applying the second sub-layer of the first print media material.

Clause 315. The method according to Clause 312, wherein the step of screen printing the first print media material includes applying the first print media material in a first series of screen print application steps.

Clause 316. The method according to Clause 315, wherein the step of screen printing the first print media material further includes exposing the first print media material to drying conditions between at least two consecutive screen print application steps in the first series of screen print application steps.

Clause 317. The method according to Clause 315, wherein the step of screen printing the first print media material further includes exposing the first print media material to drying conditions after each screen print application step in the first series of screen print application steps.

Clause 318. The method according to any one of Clauses 312 to 317, wherein the step of screen printing the second print media material includes applying the second print media material in a second series of screen print application steps.

Clause 319. The method according to Clause 318, wherein the step of screen printing the second print media material further includes exposing the second print media material to drying conditions between at least two consecutive screen print application steps in the second series of screen print application steps.

Clause 320. The method according to Clause 318, wherein the step of screen printing the second print media material further includes exposing the second print media material to drying conditions after each screen print application step in the second series of screen print application steps.

Clause 321. The method according to any one of Clauses 312 to 320, wherein the first print media material further includes a first pigment.

Clause 322. The method according to any one of Clauses 312 to 321, wherein the second print media material further includes a second pigment.

Clause 323. The method according to any one of Clauses 312 to 322, wherein the second print media material is transparent.

Clause 324. The method according to any one of Clauses 312 to 323, wherein the first print media material further includes a debubbling agent.

Clause 325. The method according to any one of Clauses 312 to 324, wherein the second print media material further includes a debubbling agent.

Clause 326. The method according to any one of Clauses 312 to 325, wherein the substrate includes a member selected from the group of: a textile; a polyurethane component; a polyvinylchloride component; a synthetic leather component; a woven textile component; a knitted textile component; or a non-woven textile component.

Clause 327. The method according to any one of Clauses 312 to 326, wherein the substrate comprises a footwear upper base component.

Clause 328. The method according to any one of Clauses 312 to 327, further comprising at least one of: (A) exposing the first print media material to vacuum pressure to remove at least some gas from the first print media material prior to the step of screen printing the first print media material; or (B) exposing the second print media material to vacuum pressure to remove at least some gas from the second print media material prior to the step of screen printing the second print media material.

Clause 329. The method according to any one of Clauses 312 to 328 forming a first printed structure on a first portion of the substrate; and the method according to any one of Clauses 1 to 59 or 71 to 106 forming a second printed structure on a second portion of the substrate.

Clause 330. The method according to any one of Clauses 312 to 329, wherein prior to screen printing the first print media material onto the substrate, the method further comprises forming the substrate by screen printing a third print media material onto a base layer of the substrate, the third print media material including at least: a polyurethane material, water, a cross-linker material, and a rheological modifier, wherein the third print media material has a viscosity within a range of 85,000 to 500,000 centipoise, wherein the base layer of the substrate with the third print media material applied to it forms the substrate on which the first print media material is applied, and wherein at least a portion of the first print media material is applied to the third print media material.

Clause 331. The method according to Clause 330, wherein the step of screen printing the third print media material includes: (a) applying a first sub-layer of the third print media material; and (b) applying a second sub-layer of the third print media material over the first sub-layer of the third print media material.

Clause 332. The method according to Clause 331, wherein the step of screen printing the third print media material further includes exposing the first sub-layer of the third print media material to drying conditions before applying the second sub-layer of the third print media material.

Clause 333. The method according to Clause 330, wherein the step of screen printing the third print media material includes applying the third print media material in a third series of screen print application steps.

Clause 334. The method according to Clause 333, wherein the step of screen printing the third print media material further includes exposing the third print media material to drying conditions between at least two consecutive screen print application steps in the third series of screen print application steps.

Clause 335. The method according to Clause 333, wherein the step of screen printing the third print media material further includes exposing the third print media material to drying conditions after each screen print application step in the third series of screen print application steps.

Clause 336. The method according to any one of Clauses 330 to 335, wherein the third print media material further includes a pigment.

Clause 337. The method according to any one of Clauses 330 to 336, wherein the third print media material further includes a debubbling agent.

Clause 38. The method according to any one of Clauses 330 to 337, further comprising exposing the third print media material to vacuum pressure to remove at least some gas from the third print media material prior to the step of screen printing the third print media material.

Clause 339. A component formed by the method according to any one of Clauses 312 to 338.

Clause 340. A wearable component formed by the method according to any one of Clauses 312 to 338.

Clause 341. A footwear upper formed by the method according to any one of Clauses 312 to 338.

Clause 342. A method, comprising: (A) placing a substrate on a screen printing bed, the substrate including a base textile layer; and (B) screen printing a topcoat layer over a surface of the substrate, wherein the screen printing includes moving a mixture including at least a polyurethane material, water, a cross-linker material, and a rheological modifier through a screen to form the topcoat layer over at least a portion of the surface of the substrate.

Clause 343. The method according to Clause 342, wherein the substrate further includes a skin layer applied over at least a portion of a surface of the base textile layer, and wherein the topcoat layer covers at least a portion of the skin layer.

Clause 344. The method according to Clause 343, wherein the substrate further includes a graphics layer applied over at least a portion of a surface of the skin layer, and wherein the topcoat layer covers at least a portion of the graphics layer.

Clause 345. The method according to Clause 342, wherein the substrate further includes a graphics layer applied over at least a portion of a surface of the base textile layer, and wherein the topcoat layer covers at least a portion of the graphics layer.

Clause 346. The method according to Clause 344 or 345, wherein the mixture comprising the topcoat layer further includes a functional filler material.

Clause 347. The method according to Clause 346, wherein the functional filler material includes at least one of a matting agent or a material for controlling a coefficient of friction of the topcoat layer.

Clause 348. The method according to Clause 346 or 347, wherein the functional filler material includes a silica material.

Clause 349. The method according to any one of Clauses 344 to 348, wherein the topcoat layer increases a coefficient of friction of the surface of the substrate at a location of the graphics layer as compared to a coefficient of friction of the surface of the substrate at the location of the graphics layer before the topcoat layer is applied thereto.

Clause 350. The method according to any one of Clauses 342 to 349, further comprising: (A) loading material into a jetting device, the material comprising a print media mixture including at least: a polyurethane material, water, a cross-linker material, a rheological modifier, and an alcohol, wherein the print media mixture comprises a non-Newtonian fluid; (B) applying shear force to the print media mixture and ejecting a series of discrete volumes of the print media mixture from a nozzle of the jetting device as a series of separated print media material dots, wherein the shear force causes a reduction in viscosity of the print media mixture to facilitate movement of the print media material dots through the nozzle; and (C) placing a surface of the substrate with the topcoat layer formed thereon at a location to receive at least a portion of the series of separated print media material dots ejected from the nozzle such that at least some of the print media material dots become fixed with the topcoat layer.

Clause 351. The method according to any one of Clauses 342 to 350, wherein the topcoat layer is less than 0.25 mm thick.

Clause 352. A component formed by the method of any one of Clauses 342 to 351.

Clause 353. A composite component, comprising: (A) a base textile layer including a first surface and a second surface located opposite the first surface; (B) a graphics layer applied over the first surface of the base textile layer; and (C) a topcoat layer applied over a surface of the graphics layer, wherein the topcoat layer includes a polyurethane material and a rheological modifier.

Clause 354. The composite component according to Clause 353, further comprising a skin layer including at least a portion located between the first surface of the base textile layer and the graphics layer, the skin layer comprising at least one of a polyurethane material or a thermoplastic polyurethane material.

Clause 355. The composite component according to Clause 354, wherein the skin layer is less than 2 mm thick.

Clause 356. The composite component according to Clause 354 or 355, wherein the skin layer is applied over only a portion of the first surface of the base textile layer.

Clause 357. The composite component according to any one of Clauses 354 to 356, wherein the graphics layer is applied over only a portion of a surface of the skin layer.

Clause 358. The composite component according to any one of Clauses 354 to 357, wherein the topcoat layer extends to cover at least one of: (a) at least a portion of the skin layer not covered by the graphics layer and/or (b) at least a portion of the base textile layer not covered by the skin layer.

Clause 359. The composite component according to any one of Clauses 353 to 358, wherein the topcoat layer comprises a dried and/or cross-linked composition formed from a mixture including a polyurethane material, water, a cross-linker material, and a rheological modifier.

Clause 360. The composite component according to any one of Clauses 353 to 358, wherein the topcoat layer comprises a polyurethane component.

Clause 361. The composite component according to Clause 360, wherein the topcoat layer further comprises the cross-linker material.

Clause 362. The composite component according to Clause 360 or 361, wherein the topcoat layer further comprises the rheological modifier.

Clause 363. The composite component according to any one of Clauses 360 to 362, wherein the topcoat layer further comprises a pigment.

Clause 364. The composite component according to any one of Clauses 360 to 363, wherein the topcoat layer further comprises a debubbling agent.

Clause 365. The composite component according to any one of Clauses 353 to 364, wherein the topcoat layer further includes a functional filler for altering at least one of a glossiness or a coefficient of friction of the topcoat layer.

Clause 366. The composite component according to Clause 365, wherein the functional filler comprises a silica material.

Clause 367. The composite component according to any one of Clauses 353 to 366, further comprising one or more printed elements disposed on the topcoat layer, the one or more printed elements including: a polyurethane material and a rheological modifier.

Clause 368. The composite component according to Clause 367, wherein the one or more printed elements comprise a cross-linker material.

Clause 369. The composite component according to Clause 367 or 368, wherein the one or more printed elements further comprise a pigment.

Clause 370. The composite component according to any one of Clauses 367 to 369, wherein the one or more printed elements further comprise a debubbling agent.

Clause 371. The composite component according to any one of Clauses 367 to 370, wherein the one or more printed elements further comprise a functional filler.

Clause 372. The composite component according to any one of Clauses 353 to 366, further comprising one or more printed elements disposed on the topcoat layer, the one or more printed elements comprising dried and/or cross-linked structures formed from a print media material that includes at least: a polyurethane material, water, a cross-linker material, a rheological modifier, and an alcohol.

Clause 373. The composite component according to any one of Clauses 353 to 366, further comprising one or more printed elements disposed on the topcoat layer, the one or more printed elements comprising dried and/or cross-linked structures formed from a print media material that includes at least: (a) an aqueous polyurethane dispersion, (b) an isocyanate or carbodiimide cross-linker material, (c) an acrylic thickener, and (d) an aminoalkyl alcohol.

Clause 374. The composite component according to any one of Clauses 353 to 366, further comprising one or more printed elements formed on the topcoat layer, the one or more printed elements comprising dried and/or cross-linked structures formed from a print media material that includes at least: (a) 65% to 95% by weight of an aqueous polyether polyurethane dispersion, (b) 1.5% to 5.5% by weight of a carbodiimide cross-linker material, (c) 0.25 to 5% by weight of an acrylic thickener, and (d) 0.075% to 4.5% by weight of aminomethyl propanol.

Clause 375. The composite component according to any one of Clauses 372 to 374, wherein the print media material further includes a debubbling agent.

Clause 376. The composite component according to Clause 375, wherein the debubbling agent includes at least one of a mineral oil or a silicone oil.

Clause 377. The composite component according to any one of Clauses 353 to 376, wherein the base textile layer includes a knitted textile material.

Clause 378. The composite component according to any one of Clauses 353 to 377, further comprising a foam layer located at the second surface of the base textile layer.

Clause 379. The composite component according to any one of Clauses 353 to 378, wherein the topcoat layer is applied over only a portion of the graphics layer.

Clause 380. The composite component according to any one of Clauses 353 to 379, wherein the topcoat layer extends to cover at least a portion of the base textile layer not covered by the graphics layer.

Clause 381. The composite component according to any one of Clauses 353 to 380, wherein the base textile layer comprises an elastomeric and/or stretchable material.

Clause 382. The composite component according to any one of Clauses 353 to 381, wherein the topcoat layer is less than 0.25 mm thick.

Clause 383. The composite component according to any one of Clauses 353 to 382, wherein the composite component is configured as an upper for an article of footwear or a component for an upper for an article of footwear.

Clause 384. A method, comprising: (A) placing a substrate on a printing bed, the substrate including an elastomeric base textile layer; and (B) printing one or more printed elements onto at least a portion of a surface of the substrate, wherein the printing includes applying a mixture including at least: a polyurethane material, water, a cross-linker material, silica, and a rheological modifier to at least the portion of the surface of the substrate, wherein the one or more printed elements have a thickness of less than 25 micron, wherein the one or more printed elements increase a coefficient of friction of the substrate at locations of the one or more printed elements as compared to a coefficient of friction of the substrate before the one or more printed elements are present thereon, and wherein an elasticity and/or stretchability of the substrate with the one or more printed elements thereon is substantially the same as an elasticity and/or stretchability of the substrate before the one or more printed elements are present thereon.

Clause 385. The method according to Clause 384, wherein the polyurethane material in the mixture comprises an aqueous polyurethane dispersion, and/or wherein the cross-linker material comprises an isocyanate or carbodiimide material.

Clause 386. The method according to Clause 384, wherein the polyurethane material in the mixture comprises an aqueous polyether polyurethane dispersion, and/or wherein the cross-linker material comprises a carbodiimide material.

Clause 387. The method according to any one of Clauses 384 to 386, wherein the substrate further includes a skin layer disposed on at least a portion of a surface of the elastomeric base textile layer, and wherein the one or more printed elements cover at least a portion of the skin layer.

Clause 388. The method according to Clause 387, wherein the substrate further includes a graphics layer disposed on at least a portion of a surface of the skin layer, and wherein the one or more printed elements are disposed on at least a portion of the graphics layer.

Clause 389. The method according to any one of Clauses 384 to 388, wherein the substrate further includes a graphics layer disposed over at least a portion of a surface of the elastomeric base textile layer, and wherein the one or more printed elements are disposed on at least a portion of the graphics layer.

Clause 390. The method according to Clause 387 or 388, wherein the one or more printed elements increase the coefficient of friction of the substrate at a location of the graphics layer as compared to the coefficient of friction of the substrate at the location of the graphics layer before the one or more printed elements are disposed on the graphics layer.

Clause 391. The method according to any one of Clauses 384 to 390, wherein the printing includes screen printing.

Clause 392. The method according to any one of Clauses 384 to 391, wherein the one or more printed elements include a topcoat layer printed over at least the portion of the surface of the substrate.

Clause 393. A component formed by the method of any one of Clauses 384 to 392.

Clause 394. The component according to Clause 393, wherein the substrate comprises at least a portion of an article of apparel.

Clause 395. The component according to Clause 393, wherein the substrate comprises at least a portion of an upper for an article of footwear.

Clause 396. The component according to Clause 393, wherein the substrate comprises at least a portion of a collar element of an upper for an article of footwear and at least one of the one or more printed elements is present on the collar element.

Clause 397. The component according to Clause 393 or 396, wherein the substrate comprises at least a portion of a tongue element of an article of footwear and at least one of the one or more printed elements is present on the tongue element.

Clause 398. A component, comprising: (A) a substrate including an elastomeric base textile layer, the substrate including a first surface and a second surface located opposite the first surface; and (B) one or more printed elements affixed to at least a portion of the first surface, wherein the one or more printed elements are formed as dried and/or cross-linked material formed from a print media material that includes at least: (a) an aqueous polyurethane dispersion, (b) an isocyanate or carbodiimide cross-linker material, (c) a rheological modifier, and (d) silica, wherein the one or more printed elements have a thickness of less than 25 micron, wherein the one or more printed elements increase a coefficient of friction of the substrate at locations of the one or more printed elements as compared to a coefficient of friction of the substrate before the one or more printed elements are present thereon, and wherein an elasticity and/or stretchability of the substrate with the one or more printed elements thereon is substantially the same as an elasticity and/or stretchability of the substrate before the one or more printed elements are present thereon.

Clause 399. The component according to Clause 398, wherein the aqueous polyurethane dispersion in the print media material comprises an aqueous polyether polyurethane dispersion.

Clause 400. The component according to Clause 398 or 399, wherein the substrate further includes a graphics layer located between the elastomeric base textile layer and at least one of the one or more printed elements, wherein said at least one of the one or more printed elements is disposed on the graphics layer.

Clause 401. The component according to Clause 400, wherein the substrate further includes a skin layer, wherein at least a portion of the skin layer is located between the elastomeric base textile layer and the graphics layer.

Clause 402. The component according to Clause 401, wherein the skin layer comprises at least one of a polyurethane material or a thermoplastic polyurethane material.

Clause 403. The component according to Clause 401 or 402, wherein the skin layer is less than 2 mm thick.

Clause 404. The component according to any one of Clauses 401 to 403, wherein the one or more printed elements comprise a topcoat layer disposed on at least one of: (a) at least a portion of the skin layer not covered by the graphics layer and/or (b) at least a portion of the elastomeric base textile layer not covered by the skin layer.

Clause 405. The component according to any one of Clauses 400 to 404, wherein the one or more printed elements comprise a topcoat layer disposed on only a portion of the graphics layer.

Clause 406. The component according to any one of Clauses 400 to 404, wherein the one or more printed elements comprise a topcoat layer disposed on at least a portion of the substrate that is not covered by the graphics layer.

Clause 407. The component according to any one of Clauses 398 to 406, wherein the substrate comprises at least a portion of an article of apparel.

Clause 408. The component according to any one of Clauses 398 to 406, wherein the substrate comprises at least a portion of an upper for an article of footwear.

Clause 409. The component according to any one of Clauses 398 to 406, wherein the substrate comprises at least a portion of a collar element of an upper for an article of footwear and at least one of the one or more printed elements is present on at least some portion of the collar element.

Clause 410. The component according to any one of Clauses 398 to 406 or 409, wherein the substrate comprises at least a portion of a tongue element of an article of footwear and at least one of the one or more printed elements is present in at least some portion of the tongue element.

Clause 411. The component according to any one of Clauses 398 to 410, further comprising a foam layer located at the second surface of the substrate.

Clause 412. A component, comprising: (A) a substrate including an elastomeric base textile layer, the substrate including a first surface and a second surface located opposite the first surface; and (B) one or more printed elements affixed to at least a portion of the first surface, wherein the one or more printed elements include a polyurethane component, wherein the one or more printed elements have a thickness of less than 25 micron, wherein the one or more printed elements increase a coefficient of friction of the substrate at locations of the one or more printed elements as compared to a coefficient of friction of the substrate before the one or more printed elements are present thereon, and wherein an elasticity and/or stretchability of the substrate with the one or more printed elements thereon is substantially the same as an elasticity and/or stretchability of the substrate before the one or more printed elements are present thereon.

Clause 413. The component according to Clause 412, wherein at least a portion of the one or more printed elements further include an isocyanate or carbodiimide cross-linker material.

Clause 414. The component according to Clause 412 or 413, wherein the portion of the one or more printed elements further include a rheological modifier.

Clause 415. The component according to any one of Clauses 412 to 414, wherein the portion of the one or more printed elements further include a functional filler, such as a silica component.

Clause 416. The component according to Clause 412 or 415, wherein the substrate further includes a graphics layer located between the elastomeric base textile layer and at least one of the one or more printed elements, wherein said at least one of the one or more printed elements is disposed on the graphics layer.

Clause 417. The component according to Clause 416, wherein the substrate further includes a skin layer, wherein at least a portion of the skin layer is located between the elastomeric base textile layer and the graphics layer.

Clause 418. The component according to Clause 417, wherein the skin layer comprises at least one of a polyurethane material or a thermoplastic polyurethane material.

Clause 419. The component according to Clause 417 or 418, wherein the skin layer is less than 2 mm thick.

Clause 420. The component according to any one of Clauses 417 to 419, wherein the one or more printed elements comprise a topcoat layer disposed on at least one of: (a) at least a portion of the skin layer not covered by the graphics layer and/or (b) at least a portion of the elastomeric base textile layer not covered by the skin layer.

Clause 421. The component according to any one of Clauses 416 to 420, wherein the one or more printed elements comprise a topcoat layer disposed on only a portion of the graphics layer.

Clause 422. The component according to any one of Clauses 416 to 420, wherein the one or more printed elements comprise a topcoat layer disposed on at least a portion of the substrate that is not covered by the graphics layer.

Clause 423. The component according to any one of Clauses 412 to 422, wherein the substrate comprises at least a portion of an article of apparel.

Clause 424. The component according to any one of Clauses 412 to 422, wherein the substrate comprises at least a portion of an upper for an article of footwear.

Clause 425. The component according to any one of Clauses 412 to 422, wherein the substrate comprises at least a portion of a collar element of an upper for an article of footwear and at least one of the one or more printed elements is present on at least some portion of the collar element.

Clause 426. The component according to any one of Clauses 412 to 422 or 425, wherein the substrate comprises at least a portion of a tongue element of an article of footwear and at least one of the one or more printed elements is present in at least some portion of the tongue element.

Clause 427. The component according to any one of Clauses 412 to 426, further comprising a foam layer located at the second surface of the substrate.

Clause 428. Print media materials having a combination of ingredients as described herein for print media materials 120, 1104M, 1302A, 1320B, and 1320C (e.g., as shown in the Tables above and/or in the text relating to ranges of ingredients as described above).

Clause 429. A dried and/or cross-linked structure formed as a result of drying and/or cross linking print media materials as described herein to form printed element structures (e.g., printed elements 102, 202, 202B, 202C, 202D, 202E, 302, 602, 802, 902, 1104D, 1302, 1402).

Clause 430. The dried and/or cross-linked structure according to Clause 429 fixed to a substrate.

The present technology is disclosed above and in the accompanying drawings with reference to a variety of embodiments. The purpose served by the disclosure, however, is to provide examples of the various features and concepts related to the technology, not to limit its scope. One skilled in the relevant art will recognize that numerous variations and modifications may be made to the embodiments described above without departing from the scope of the present invention, as defined by the appended claims.

What is claimed is:

1. A method, comprising:
placing a substrate on a screen printing bed, the substrate including a base textile layer; and
screen printing a topcoat layer over a surface of the substrate, wherein the screen printing includes moving a mixture including at least a polyurethane material, water, a cross-linker material, and a rheological modifier through a screen to form the topcoat layer over at least a portion of the surface of the substrate.

2. The method according to claim 1, wherein the substrate further includes a skin layer applied over at least a portion of a surface of the base textile layer, and wherein the topcoat layer covers at least a portion of the skin layer.

3. The method according to claim 2, wherein the substrate further includes a graphics layer applied over at least a portion of a surface of the skin layer, and wherein the topcoat layer covers at least a portion of the graphics layer.

4. The method according to claim 1, wherein the substrate further includes a graphics layer applied over at least a portion of a surface of the base textile layer, and wherein the topcoat layer covers at least a portion of the graphics layer.

5. The method according to claim 3, wherein the mixture further comprises a functional filler material including at least one of a matting agent or a material for controlling a coefficient of friction of the topcoat layer.

6. The method according to claim 5, wherein the functional filler material includes a silica material.

7. The method according to claim 3, wherein the topcoat layer increases a coefficient of friction of the surface of the substrate at a location of the graphics layer as compared to a coefficient of friction of the surface of the substrate at the location of the graphics layer before the topcoat layer is applied thereto.

8. The method according to claim 1, further comprising:
loading material into a jetting device, the material comprising a print media mixture including at least: a polyurethane material, water, a cross-linker material, a rheological modifier, and an alcohol, wherein the print media mixture comprises a non-Newtonian fluid;
applying shear force to the print media mixture and ejecting a series of discrete volumes of the print media mixture from a nozzle of the jetting device as a series of separated print media material dots, wherein the shear force causes a reduction in viscosity of the print media mixture to facilitate movement of the print media material dots through the nozzle; and
placing a surface of the substrate with the topcoat layer formed thereon at a location to receive at least a portion of the series of separated print media material dots ejected from the nozzle such that at least some of the print media material dots become fixed with the topcoat layer.

9. A component formed by the method of claim 1.

10. A composite component, comprising:
a base textile layer including a first surface and a second surface located opposite the first surface;
a graphics layer applied over the first surface of the base textile layer; and
a topcoat layer applied over a surface of the graphics layer, wherein the topcoat layer includes a polyurethane material and a rheological modifier.

11. The composite component according to claim 10, further comprising a skin layer including at least a portion located between the first surface of the base textile layer and the graphics layer, the skin layer comprising at least one of a polyurethane material or a thermoplastic polyurethane material.

12. The composite component according to claim 11, wherein the topcoat layer extends to cover at least one of: (a) at least a portion of the skin layer not covered by the graphics layer and/or (b) at least a portion of the base textile layer not covered by the skin layer.

13. The composite component according to claim 10, wherein the topcoat layer comprises a dried and/or cross-linked composition formed from a mixture including a polyurethane material, water, a cross-linker material, and a rheological modifier.

14. The composite component according to claim 10, wherein the topcoat layer further includes a functional filler for altering at least one of a glossiness or a coefficient of friction of the topcoat layer.

15. The composite component according to claim 14, wherein the functional filler comprises a silica material.

16. The composite component according to claim 10, further comprising one or more printed elements formed on the topcoat layer, the one or more printed elements including: a polyurethane material and a rheological modifier.

17. The composite component according to claim 10, further comprising one or more printed elements disposed on the topcoat layer, the one or more printed elements comprising dried and/or cross-linked structures formed from a print media material that includes at least: a polyurethane material, water, a cross-linker material, a rheological modifier, and an alcohol.

18. The composite component according to claim 10, further comprising one or more printed elements disposed on the topcoat layer, the one or more printed elements comprising dried and/or cross-linked structures formed from a print media material that includes at least: (a) an aqueous polyurethane dispersion, (b) an isocyanate or carbodiimide cross-linker material, (c) an acrylic thickener, and (d) an aminoalkyl alcohol.

19. The composite component according to claim 10, further comprising one or more printed elements disposed on the topcoat layer, the one or more printed elements comprising dried and/or cross-linked structures formed from a print media material that includes at least: (a) 65% to 95% by weight of an aqueous polyether polyurethane dispersion, (b) 1.5% to 5.5% by weight of a carbodiimide cross-linker material, (c) 0.25% to 5% by weight of an acrylic thickener, and (d) 0.075% to 4.5% by weight of aminomethyl propanol.

20. The composite component according to claim 17, wherein the print media material further includes a debubbling agent.

21. The composite component according to claim 20, wherein the debubbling agent includes at least one of a mineral oil or a silicone oil.

22. The composite component according to claim 10, wherein the base textile layer comprises an elastomeric and/or stretchable material.

23. The composite component according to claim 10, wherein the topcoat layer is less than 0.25 mm thick.

24. The composite component according to claim 10, wherein the composite component is configured as an upper for an article of footwear or a component for an upper for an article of footwear.
